(19) United States
(12) Patent Application Publication
(10) Pub. No.: US 2026/0268404 A1
(43) Pub. Date: Sep. 10, 2026

(54) REAL-TIME VALUATION AND RISK MANAGEMENT INTERFACE FOR COMMODITY-BASED OPERATIONS

(71) Applicant: AgriVaR, LLC, Brookings, SD (US)

(72) Inventors: Matthew S. Elliott, Brookings, SD (US); Lisa M. Elliott, Brookings, SD (US)

(21) Appl. No.: 19/559,805

(22) Filed: Mar. 6, 2026

Related U.S. Application Data
(60) Provisional application No. 63/768,683, filed on Mar. 7, 2025.
(60) Provisional application No. 63/775,748, filed on Mar. 21, 2025.
(60) Provisional application No. 63/823,397, filed on Jun. 13, 2025.
(60) Provisional application No. 63/854,052, filed on Jul. 30, 2025.

(51) Int. Cl. G06Q 40/04; G06N 20/00

(52) U.S. Cl. CPC G06Q 40/0421; G06N 20/00

(57) ABSTRACT

Systems and methods are provided for obtaining historical and real-time data inputs for generating one or more predictions, estimates, or recommendations for a commodity-based operation. Using machine learning models, estimates relating to asset yield prediction, at least one revenue, at least one profit, or at least one assessed risk associated with at least one parcel of land or at least one commodity may be estimated. Estimates may be further refined via user selections that update the determinations with up-to-date estimate and recommendations being provided via a dynamically updated dashboard. Through real-time monitoring, estimates and recommendations may be updated and provided to users without additional inputs.

### CROSS-REFERENCE TO RELATED APPLICATIONS

The present application claims priority to U.S. Provisional Application Ser. No. 63/768,683, filed Mar. 7, 2025, (Attorney Docket No. Agrivar P1001PR1) which is incorporated herein by reference in its entirety. The present application claims priority to U.S. Provisional Application Ser. No. 63/775,748, filed Mar. 21, 2025, (Attorney Docket No. Agrivar P1001PR2) which is incorporated herein by reference in its entirety. The present application claims priority to U.S. Provisional Application Ser. No. 63/823,397, filed Jun. 13, 2025, (Attorney Docket No. Agrivar P1001PR3) which is incorporated herein by reference in its entirety. The present application claims priority to U.S. Provisional Application Ser. No. 63/854,052, filed Jul. 30, 2025, (Attorney Docket No. Agrivar P1001PR4) which is incorporated herein by reference in its entirety.

### TECHNICAL FIELD

The present disclosure generally relates to commodity-based operations or enterprises and more specifically, to systems and methods for predicting and generating recommendations or estimates for the commodity-based operations, and displaying the recommendations or estimates generated on an interactive dashboard.

### BACKGROUND

Existing risk management and valuation systems for commodity-based operations encounter technical limitations in multi-source data processing, real-time valuation, and cross-domain integration. Operational monitoring data may arrive at different update frequencies and in different formats (e.g., periodic satellite imagery, intermittent equipment or ground sensor readings, and weather updates), while market data for derivative instruments may update at sub-second intervals during trading hours. This heterogeneity creates technical challenges in time alignment, normalization, missing-data handling, and stale-data detection, particularly when valuations and risk metrics are updated continuously.

Further, existing systems often output informational reports or static recommendations without maintaining consistent portfolio state across heterogeneous assets, such as physical production positions, derivative hedge positions, insurance coverage, and investment allocations. When valuations change due to updated monitoring data or market movements, maintaining internally consistent position quantities, hedge ratios, and risk decompositions (e.g., production risk, futures price risk, and basis risk) requires coordinated computation and data persistence across distributed computing components.

It is therefore desirable to provide a comprehensive technological solution that: (1) monitors real-time physical asset value to establish and update dynamic physical positions; (2) selects and updates derivative hedges and financial instruments based on target risk levels and capital efficiency; (3) generates liquidity from otherwise illiquid in-production assets through capital-efficient hedging and/or option premium generation; (4) allocates freed capital to one or more investment positions to improve capital utilization; (5) enables portfolio diversification across uncorrelated asset classes and alternative investment vehicles with differentiated return distributions and risk characteristics for optimized hedging and/or investment efficiency; and (6) dynamically rebalances the integrated portfolio as physical valuations, derivative Greeks, market conditions, and user-defined risk parameters change.

### SUMMARY

In some aspects, the techniques described herein relate to a method for real-time risk management and optimization, including: collecting historical data or real-time data from at least one data source, including at least one of historical field information, satellite imagery data, asset yield data, market price data, weather forecast data, enterprise data, or asset insurance data; training, by a data processing unit, at least one machine learning model to determine at least one asset yield prediction, at least one revenue, at least one profit, or at least one assessed risk associated with at least one parcel of land or at least one commodity using a first training data set that includes the historical data or the real-time data; receiving, from a user interface, one or more user selections corresponding to at least one commodity-based operation and a risk threshold for the at least one commodity-based operation; responsive to receiving the one or more user selections, selecting one or more trained machine learning models that were trained by the data processing unit; determining, through a recommendation engine, at least one of a predicted asset yield, a predicted risk metric, or a predicted expected revenue for the at least one commodity-based operation based at least in part on an analysis of the machine learning model, the at least one commodity-based operation, and the risk threshold; and causing display of at least one of the predicted asset yield, the risk metric, or the expected revenue for the at least one commodity-based operation.

In some aspects, the techniques described herein relate to a system of providing predictions, estimates, or recommendations for a commodity-based operation including: a data collection module, the data collection module configured to obtain or collect information from a plurality of data inputs, wherein the plurality of data inputs include at least one of field information, satellite imagery data, yield data, market price data, weather forecast data, enterprise data, or asset insurance data; a data processing unit, the data processing unit configured to analyze or process the information from the plurality of data inputs to determine correlations, patterns, or trends in the plurality of data inputs, wherein the data processing unit utilizes at least one machine learning algorithm to determine correlations, patterns, or trends associated with determining at least one asset yields, or risks associated with at least one parcel of land; a recommendation engine, the recommendation engine configured to determine at least one of a predicted asset yield, a predicted risk metric, or a predicted expected revenue for at least one commodity-based operation; and a user interface, the user interface configured to display the determined at least one of the predicted asset yield, the predicted risk metric, or the predicted expected revenue for at least one commodity-based operation.

In some aspects, the techniques described herein relate to a system for real-time asset management and optimization, including: a controller including at least one processor and at least one memory device storing computer-readable instructions, wherein the controller is implemented as a distributed computing system including a web server tier for handling user interface requests; an application server tier for executing application logic and recommendation algorithms; and a data storage tier including at least one relational database and at least one time-series database optimized for sensor data storage, wherein the at least one processor configured to execute the computer-readable instructions to: collect historical data or real-time data from at least one data source, including at least one of historical field information, satellite imagery data, yield data, market price data, weather forecast data, enterprise data, or asset insurance data; train at least one machine learning model to determine at least one asset yield prediction, at least one revenue, at least one profit, or at least one assessed risk associated with at least one parcel of land or at least one commodity using a first training data set that includes the historical data; receive, from a user interface, one or more user selections corresponding to at least one commodity-based operation and a risk threshold for the at least one commodity-based operation; responsive to receiving the one or more user selections, select one or more trained machine learning models; determine at least one of a predicted asset yield, a predicted risk metric, or a predicted expected revenue for the at least one commodity-based operation based at least in part on an analysis of the machine learning model, the at least one commodity-based operation, and the risk threshold; cause at least one of the predicted asset yield, the risk metric, or the expected revenue for the at least one commodity-based operation to be displayed.

It is to be understood that both the foregoing general description and the following detailed description are illustrative and explanatory only and are not necessarily restrictive of the invention as claimed. The accompanying drawings, which are incorporated in and constitute a part of the specification, illustrate embodiments of the invention and, together with the general description, serve to explain the principles of the invention.

### BRIEF DESCRIPTION OF DRAWINGS

The numerous advantages of the disclosure may be better understood by those skilled in the art by reference to the accompanying figures.

FIG. 1 is an illustrative system for receiving, processing, and generating recommendations from a plurality of data inputs, in accordance with some embodiments.

FIG. 2 is an illustrative system architecture, in accordance with some embodiments of the present disclosure.

FIG. 3 depicts a flow chart illustrating a first method of operation of the system, in accordance with some embodiments of the present disclosure.

FIG. 4 depicts a flow chart illustrating a second method of operation of the system, in accordance with some embodiments of the present disclosure.

FIG. 5A depicts a dashboard of an illustrative user interface in accordance with some embodiments of the present disclosure.

FIG. 5B depicts a generated account pane, which may be generated in response to the user interacting with account object 518 of an illustrative user interface in accordance with some embodiments of the present disclosure.

FIG. 5C depicts an illustrative embodiment of dashboard after a field selection interactive icon has been selected for displaying a field selection pane of an illustrative user interface in accordance with some embodiments of the present disclosure.

FIG. 5D depicts an illustrative embodiment of dashboard after a field performance interactive icon has been selected for displaying a field performance pane of an illustrative user interface in accordance with some embodiments of the present disclosure.

FIG. 5E depicts an illustrative embodiment of dashboard after a maps insights interactive icon has been selected for displaying a map insights tab of an illustrative user interface in accordance with some embodiments of the present disclosure.

FIG. 5F depicts an illustrative embodiment of a dashboard displaying a net revenue tab after a net revenue icon has been selected, resulting in a net revenue tab of an illustrative user interface in accordance with some embodiments of the present disclosure.

FIG. 5G depicts an illustrative embodiment of dashboard following selection of a historical insights interactive icon resulting in a historical insights tab depicts of an illustrative user interface in accordance with some embodiments of the present disclosure.

FIG. 5H depicts a first illustrative embodiment of dashboard displaying a risk management tab after a risk management icon has been selected, resulting in the risk management tab being displayed of an illustrative user interface in accordance with some embodiments of the present disclosure.

FIG. 5I depicts a second illustrative embodiment of dashboard displaying a risk management tab after a risk management icon has been selected, resulting in the risk management tab being displayed of an illustrative user interface in accordance with some embodiments of the present disclosure.

FIG. 5J depicts a third illustrative embodiment of dashboard displaying a risk management tab after a risk management icon has been selected, resulting in the risk management tab being displayed of an illustrative user interface in accordance with some embodiments of the present disclosure.

FIG. 5K depicts an illustrative embodiment of dashboard displaying a weather tab after a weather icon has been selected, resulting in the weather tab being displayed an illustrative user interface in accordance with some embodiments of the present disclosure.

FIG. 5L depicts an illustrative embodiment of dashboard displaying an automated real-time prescription processing after a prescriptions icon has been selected, resulting in the automated real-time prescription processing being displayed in an illustrative user interface in accordance with some embodiments of the present disclosure.

FIG. 5M depicts a yield goals pane and seeding rate and varieties pane of an illustrative user interface in accordance with some embodiments of the present disclosure.

FIG. 5N depicts an illustrative embodiment of dashboard displaying a markets tab after a markets icon has been selected, resulting in the markets tab being displayed in an illustrative user interface in accordance with some embodiments of the present disclosure.

FIG. 5O depicts a sharing permission page that may be generated and displayed on the dashboard of an illustrative user interface in accordance with some embodiments of the present disclosure.

FIG. 5P depicts a generated budget page of an illustrative user interface in accordance with some embodiments of the present disclosure.

FIG. 5Q is an illustrative example of a prescription page log of an illustrative user interface in accordance with some embodiments of the present disclosure.

FIG. 6 is a process flow chart illustrating a third method of operation of the system, in accordance with some embodiments of the present disclosure

FIG. 7 is a process flow chart illustrating a fourth method of operation of the system, in accordance with some embodiments of the present disclosure.

FIG. 8 a process flow chart illustrating a fifth method of operation of the system, in accordance with some embodiments of the present disclosure

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for obtaining raw data from a plurality of data inputs, processing the raw data to determine and correlate the data into patterns, trends, or other correlations and generate predicted revenues, yields, risks metrics (e.g., value-at-risk, or other risk quantification methodologies), recommendations, estimates, or predictions for a resource production operations. For example, the present disclosure may be utilized in an array of commodity-based enterprises or operations that are tied to parcels of land. For example, the present disclosure may be utilized with operations related to crops, livestock, and/or other traditional agricultural operations. For example, the present disclosure may be utilized with operations related to renewable energy generation (e.g., wind, solar, or other renewable energies) and land-based analytical processes. For example, the present disclosure may be utilized with tourism enterprises connected to land resources. For example, the present disclosure may be utilized with a variety of inputs entering the system (commodities or otherwise) that undergoes further processing the supply chain such as feed processing, bioproducts, or ethanol production. For example, the present disclosure may be utilized with resource extraction industries (e.g., resource extraction industries like mining or oil production). Accordingly, when examples are provided herein relating to specific industry or operation-types, the examples are intended to be illustrative only and may be substituted for other industry or operation types. Additionally, while illustrative examples are provided herein that refer to value-at-risk or other related terminology, the present disclosure is not limited to any one methodology for risk quantification, and instead, may encompass a range of risk quantification strategies, including, but not limited to, conditional value-at-risk, Monte Carlo simulation, stress testing, or other risk quantification strategies.

In embodiments, the systems and methods may further be individually tailored to specific users (or groups of users), adjusting the predicted revenues, yields, and/or risks based on user-provided information. Furthermore, the systems and methods described herein may generate one or more recommendations for a user's resource production operation based at least in part on historical data, user-inputted information, and risk thresholds.

As used herein, “real-time” refers to system processing and display updates that occur within a time window suitable for time-sensitive decision-making after new data is received by the data collection module 102. In embodiments, for event-driven inputs (e.g., market price updates), derived valuations and risk metrics are updated and made available for display within 30 seconds or less after receipt of a new data item. The system architecture utilizes distributed processing, caching mechanisms, and optimized database queries to achieve such response times even during peak usage periods or when processing large datasets spanning multiple parcels of land.

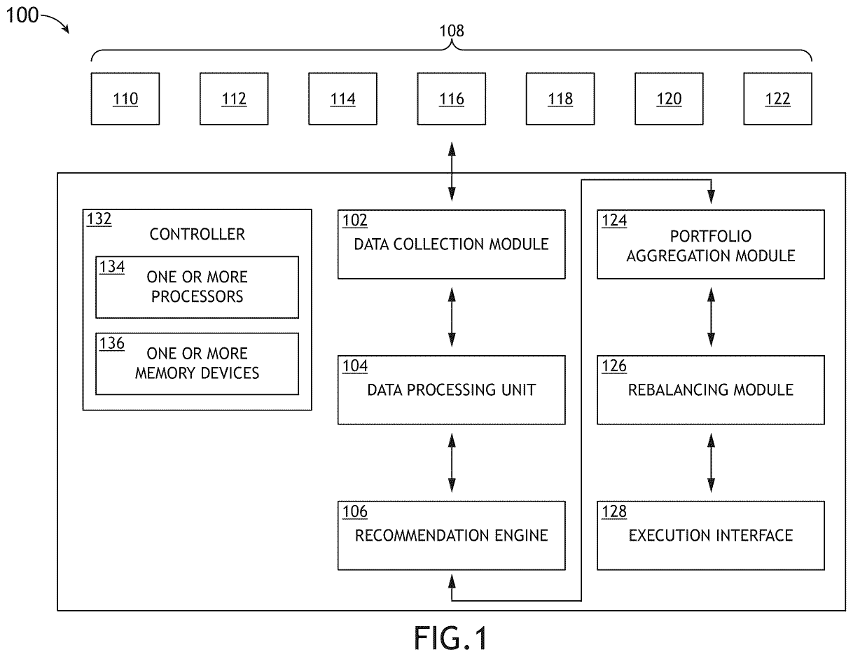

FIG. 1 depicts an illustrative system of obtaining data or information from one or more data inputs, analyzing the data from the inputs, and outputting recommendations for agricultural risk management and optimization, depicted generally by reference numeral 100. In embodiments, one or more data inputs may be obtained by system 100, allowing a database of information to be stored, tabulated, analyzed, and presented to one or more users. Broadly, the system 100 comprises a data collection module 102 configured for receiving or obtaining raw data or information, a data processing unit 104 configured for processing and analyzing the raw data or information collected by the data collection module 102, and a recommendation engine 106 configured for generating a prediction, estimate, and/or recommendation based at least in part on processed data after the collected data passes through the data processing unit 104. In embodiments, and as described in greater detail below, the prediction, estimate, and/or recommendation may be a generated output for optimizing a user's agricultural operation, such as optimizing yield or revenue while reducing or otherwise accounting for risks or losses. In embodiments, the system 100 may further incorporate or utilize one or more machine learning algorithms, which may be trained to monitor user actions or data inputs and determine trends or correlations or aid in generating a determination, recommendation, or estimate, and/or for automating specific processes, including for example, filling in missing data to provide a complete analytical picture for more informed decision making.

As depicted, the data collection module 102 may receive raw data or information from one or a plurality of data inputs 108. Data inputs 108 may be raw data, collected data, stored data, or any other data or information that may be obtained by the data collection module 102. In some embodiments, one or more of the data inputs 108 include proxy variables, instrumental variables, and/or derived variables computed from one or more raw or collected inputs (e.g., vegetation indices derived from satellite imagery, basis derived from local cash and futures prices, interest rate changes or policy shocks to enable causal inference in financial risk assessment, and/or imputed values for missing observations), and the system stores metadata identifying whether a value is observed, derived, imputed, or user-provided. As described herein, the data collection module 102 may periodically or continuously collect additional data inputs 108 at configurable intervals ranging from 1 minute to 24 hours, with typical monitoring occurring at 15-minute intervals for market data feeds, 1-hour intervals for weather updates, 6-hour intervals for satellite imagery processing, and 24-hour intervals for portfolio rebalancing analysis. In embodiments, the data processing unit 104 assigns timestamps to received data items, normalizes data formats, aligns heterogeneous inputs to a unified time-series representation (e.g., via time buckets), and flags stale, missing, or outlier inputs based on age thresholds, statistical deviation thresholds, and/or source reliability characteristics. In some embodiments, derived valuations and risk metrics are updated within a predetermined latency window after receipt of an updated data item, including within 30 seconds for event-driven market price updates and within 5 minutes for non-event-driven operational monitoring updates. This frequent updating ensures that a database of collected data inputs 108 is continuously refreshed, providing for more accurate predictions and recommendations from the recommendation engine 106. Accordingly, the data inputs 108 may comprise a combination of historical data and real-time data. In this regard, patterns, trends, or other correlations over an extended period may be determined through the collection and analysis of historical data. Furthermore, through the collection of real-time data, the determined correlations, patterns, or trends can be refined and contextualized in generating recommendations, predictions, or estimates for a user.

It should be understood that the examples provided herein that are related to the various data inputs are intended to be illustrative rather than limiting, unless explicitly stated as such. Accordingly, the various data inputs 108 may include any data source serving as a proxy or instrumental variable for stated examples or parameters, with the data sources representing the specific parameter regardless of collection methodology or specific provider. For example, the data inputs 108 may include temporal components including any combination of historical data, real-time data, streaming data, or forecast data. The data inputs 108 may include one or more data types selected from: field information, remote sensing data, yield data, market data, meteorological data, enterprise data, insurance data, or any other agricultural risk-relevant data. For example, the use of alternative data, proxy variables, instrumental variables, or functionally equivalent data that exhibits statistical correlation or predictive relationship with the enumerated data types shall be considered within the scope of this claim.

The field information 110 may be collected or obtained through searching and scrubbing through various online databases, or government data repositories. For example, field information 110 may be obtained from sources including, but not limited to: the USDA National Agricultural Statistics Service (NASS) Cropland Data Layer (CDL) for crop type identification and land use classification; the Bureau of Land Management (BLM) for legal land descriptions, survey data, and public land boundaries; and the USDA Natural Resources Conservation Service (NRCS) Soil Survey Geographic Database (SSURGO) for detailed soil composition, drainage classification, and agronomic soil property data, or functionally equivalent sources or successors thereto. In embodiments, the field information 110 may be obtained via APIs in addition to or in place of searching or scrubbing. In embodiments, the field information 110 may be obtained via user-provided inputs, including for example, a user manually drawing field boundaries or uploaded information that sets the boundaries of the user's field. In embodiments, after collecting the field information 110, the data processing unit 104 may process and assign boundaries, ownership, and locational information, such as the town, township, county, or state in which the land resides, etc.

In embodiments, the field information 110 can also include details regarding the physical and/or composition of one or more parcels of land. For example, the field information 110 may include details about the soil associated with different parcels of land, such as soil levels, soil composition (including soil types, soil nutrients, and soil drainage), and other relevant characteristics. Furthermore, the field information 110 can also include information associated with the relative position of parcels of land, such as elevation of the land above sea level, position relative to watersheds, or position relative to man-made structures such as roads, cities, factories, or plants. As described below, users may be able to provide manual entries to the data inputs 108, including the field information 110. As such, users may be able to manually update the field information 110 with additional details with selected granularity. For example, a user may be able to provide information related to a soil sample taken from the parcel of land.

In embodiments, data inputs 108 may comprise satellite imagery data 112, which can be obtained by the data collection module 102, allowing a database of information to be stored, tabulated, analyzed, and presented to a user. Satellite imagery data 112 may comprise information directed at captured images of one or more parcels of land. For example, satellite imagery data 112 may be obtained through searching and scrubbing through various online databases, government websites, or commercial and government satellite imagery providers. In embodiments, satellite imagery data 112 may be obtained from multispectral satellite sources including, but not limited to: Landsat 8 (L8), operated by the U.S. Geological Survey and NASA, providing multispectral imagery at 30-meter resolution; Sentinel-2 (S2), operated by the European Space Agency, providing multispectral imagery at 10-meter resolution in visible and near-infrared bands; and high-resolution commercial imagery sources providing sub-meter to 5-meter resolution data, or functionally equivalent sources or successors thereto. The use of multiple satellite sources at different spatial resolutions and revisit frequencies enables the system 100 to balance temporal frequency of monitoring with spatial precision for sub-field zone analytics.

In some embodiments, satellite imagery data 112 may include user-provided information, such as drone imagery, pictures, video, or text, that provides additional, manually entered information about one or more land parcels. In embodiments, the obtained satellite imagery data 112 may be utilized in various applications. For example, the captured satellite imagery data may be presented and utilized by an end user to tailor or narrow the agricultural operation to zones of interest (as described in greater detail below), allowing the user granular control over selecting a specific area of land for generating predictions or recommendations, or through tracking yields, revenue, and risks, among other uses. In embodiments, the satellite imagery data 112 may be analyzed by the data processing unit 104 and combined with one or more different data inputs 108. For example, the field information 110 may be combined with satellite imagery data 112 to provide overlays to the satellite imagery data 112, providing a user with both satellite imagery and land boundaries for a section of land.

In some embodiments, the satellite imagery data 112, alone or in combination with other data inputs 108, may be further used to determine macro-level trends, statistics, or metrics relating to yields, revenues, risks, etc. For example, the data processing unit 104 may analyze the satellite imagery data 112 to determine trends in types of crop or livestock utilized by similarly situated parcels of land to determine if certain types of livestock or crop are better suited to a particular type or location of land. Furthermore, the data processing unit 104 may analyze the satellite imagery data 112 in conjunction with one or more other data inputs 108, such as weather information, and determine the trends that weather patterns have on specific areas of land. Accordingly, the recommendation engine 106 may utilize these correlations, trends, or patterns when generating recommendations or predictions.

Furthermore, the satellite imagery data 112 may also be utilized by the system 100 in providing interactive agricultural zones for a user to manipulate or interact with in a user interface. For example, the satellite imagery data 112 may be processed using one or more geospatial processing modules to handle geometric transformation and resolve overlapping zones. When presented to the user, such as through dashboard 502, the user may also be provided with interactive zone editing tools for rendering geographic data and providing interactive polygon editing capabilities. This allows the user to draw, edit, and delete polygon zones directly on the map interface. In embodiments, multiple zone representations may be utilized, allowing users to load, edit, and save current zones or to immediately send zone data to machine-readable prescriptions, ensuring flexibility in zone management.

In some embodiments, the data inputs 108 further include yield data 114, which may be obtained by the data collection module 102, allowing a database of information to be stored, tabulated, analyzed, and presented to a user. Yield data 114 may comprise information directed at yield data of a plurality of different crops, livestock, or other agricultural commodities. The data collection module 102 may collect yield data 114 from a variety of different online resources, including but not limited to governmental databases (e.g., USDA National Agricultural Statistics Service (NASS), USDA Data Commons, Food and Agriculture Organization of the United Nations), state government reporting, county government reporting, among other online databases in which yield data is collected and available online. In further embodiments, the data collection module 102 may receive yield data 114 in the form of user-provided inputs and yield data collected from harvesting machines. In embodiments, the yield data 114 may be further obtained via one or more APIs, including through pairing or linking of the system 100 with agricultural equipment and field management platforms. For example, yield data 114 may be obtained from precision agriculture platforms including, but not limited to: Climate FieldView™ (The Climate Corporation), which aggregates field-level yield monitor data, planting data, and as-applied records; and the John Deere Operations Center™, which provides yield monitor telemetry, machine data, and agronomic field records via API integration, or functionally equivalent platforms or successors thereto. In embodiments, yield data collected from harvesting equipment via these platforms may include as-harvested yield maps, machine-recorded moisture readings, and geospatially referenced yield observations that are ingested, normalized, and stored by the data collection module 102 for use in model training and field-level analysis. Furthermore, the yield data 114 may comprise historical yield information and/or current or up-to-date yield information.

In embodiments, yield data 114, alone or in combination with other data inputs 108, may be utilized by the data processing unit 104 and/or the recommendation engine 106 for associating yields with specific parcels of land including, for example, parcels of land collected and included in the field information 110 and/or the satellite imagery data 112. For example, the data processing unit 104 may parse through the data inputs 108 and automatically associate the yield data 114 with particular parcels of land. Furthermore, the data processing unit 104 may utilize the yield data 114 in conjunction with other data inputs 108 to determine patterns, outliers, and trends. For example, the data processing unit 104 may utilize the yield data 114 for determining and developing correlations, trends, and/or patterns at a granular level, such as for a particular field or farm. Furthermore, the data processing unit 104 may utilize the yield data 114 for determining and developing trends and/or patterns at a small or large-scale level, such as determining trends at a field, county, state, region, or national level. As described in greater detail herein, these correlations, trends, and/or patterns may be utilized by recommendation engine 106 to generate a prediction or recommendation as to a type and/or amount of crop to plant on a particular field for an upcoming growing cycle.

In some embodiments, data inputs 108 may comprise market price data 116, which may be obtained by the data collection module 102, such that a database of information may be stored, tabulated, analyzed, and presented to a user. In embodiments, the market price data 116 may comprise historical information associated with the market prices of one or more agricultural commodities, including but not limited to livestock market prices, crop market prices (including for example, futures, cash prices, option prices, specialty contract prices, etc.), input prices (fertilizer, diesel, etc.), output prices (crop price, livestock price, commodity prices, etc.), the relationship between input prices to output prices, and other data related to commodities that have a market price reported and tracked. In embodiments, the data collection module 102 may be in communication with or otherwise configured to receive up-to-date or real-time information from one or more markets for receiving current market price data 116. For example, the data collection module 102 may obtain market price data 116 from sources including, but not limited to: the USDA National Agricultural Statistics Service (NASS) for reported cash and price survey data; the Chicago Mercantile Exchange (CME) for real-time and historical futures and options pricing data for agricultural commodities; and Barchart, or functionally equivalent market data aggregators, for consolidated cash price data from grain elevators and physical delivery locations, or successors thereto. In embodiments, the combination of exchange-traded futures and options data with local cash price data enables the system 100 to compute and continuously update basis values (i.e., the difference between local cash prices and relevant futures contract prices) for delivery locations relevant to a user's operation.

In embodiments, the collected market price data 116, alone or in combination with one or more other data inputs 108, may be utilized by the recommendation engine 106 in generating predictions, estimates, and/or recommendations. Accordingly, the market price data 116 may be analyzed by the data processing unit 104 to determine correlations, trends, or patterns in the market price of one or more commodities. Through the analysis by the data processing unit 104, granular or broad patterns of the market price for one or more commodities can be determined, which in turn can be utilized by the recommendation engine 106 in generating one or more recommendations, estimates, or predictions. For example, the data processing unit 104 can determine an average price of corn over a 5-year time period, which may be utilized by the recommendation engine 106. By way of another example, the data processing unit 104 can determine an average price of a plurality of commodities over some time, providing a general pattern or trend for agricultural commodities over a defined time period.

In embodiments, when real-time basis data (the difference between local cash prices and futures prices) is unavailable for specific delivery locations, the system 100 employs predictive algorithms to estimate basis values. The basis prediction models utilize features including: (1) historical basis patterns for the location and time of year; (2) transportation costs from the field to delivery points; (3) local supply and demand factors derived from regional production estimates; (4) storage availability and costs; and (5) nearby locations with available basis quotes for spatial interpolation. The system distinguishes between real-time market data and generated estimates through visual indicators in the user interface (e.g., distinct icons or color coding), ensuring users understand data provenance. Basis predictions are continuously updated as new market data becomes available, with automatic substitution of estimated values with real-time quotes when market reporting resumes.

In embodiments, the market price data 116 may include market data beyond agricultural commodities that are not traditionally associated with an agricultural operation. For example, the market price data 116 may also include data associated with institutional financial markets, such as the DOW Jones, S&P, or other markets. Accordingly, the data collection module 102 can collect these different types of market data that can then determine correlations or patterns related to a broad range of markets that can be used to offset or diversify risk and/or enhance returns for commodities in production. For example, the data processing unit 104 can compare the relative stability or volatility of agricultural commodities in production as compared to other types of commodities or general stocks, bonds, or other investment options. These determined correlations, patterns, and/or trends can be utilized by the recommendation engine 106 in generating optimized portfolios that reduce risk and enhance return for the commodity producer. The optimized portfolios are provided to the producer with expected estimates of return, risk reduction, and asset allocation recommendations.

Furthermore, in embodiments, the data processing unit 104 can further use a plurality of data inputs 108 when processing and analyzing correlations, trends, and/or patterns. For example, the data processing unit 104 may analyze the collected market price data 116 in combination with yield data 114 and make determinations on how different yields affect the market price of one or more commodities. By way of another example, the data processing unit 104 may analyze the collected market price data 116 in combination with yield data 114 and field information 110, to determine granular patterns at various geographic scopes. However, it should be understood that the data processing unit 104 may utilize any combination of the data inputs 108 in determining correlations, trends and/or patterns (e.g., correlations identified between different data sets). In some embodiments, data inputs 108 may comprise weather forecast data 118, which may be obtained by the data collection module 102, such that a database of information may be stored, tabulated, analyzed, and presented to a user. In embodiments, the weather forecast data 118 may be collected information related to the weather of a particular region. For example, the weather forecast data 118 may comprise historical data including historical rainfall, growing degree days (GDDs), hail events with severity measurements, or other metrics utilized in the recording of weather information. In embodiments, weather forecast data 118 may be obtained from sources including, but not limited to: the National Oceanic and Atmospheric Administration (NOAA) Multi-Radar/Multi-Sensor (MRMS) system, which provides high-resolution radar-derived precipitation estimates at approximately 1-kilometer resolution updated at 2-minute intervals; the NOAA Global Forecast System (GFS), which provides numerical weather prediction forecasts including precipitation, temperature, and wind parameters at global coverage; the NOAA National Centers for Environmental Information (NCEI), which provides historical climatological records, storm event databases, and long-term climate data; or functionally equivalent operational meteorological data services or successors thereto.

In embodiments, hail event data includes geographic coordinates, timestamps, hail stone size measurements (e.g., diameter in inches or centimeters), storm duration, and affected area calculations. The system may assign severity scores on a scale (e.g., 1-10) based on hail stone size and duration using a weighted scoring algorithm: severity score=(hail diameter in inches×2) +(storm duration in minutes÷10). For example, a 2-inch hailstone lasting 20 minutes receives a score of 2×2+20÷10=6. These severity scores are correlated with historical crop damage assessments and yield impact data to predict yield reductions for affected zones. For example, a severity score of 6 in corn at the V8 growth stage may correlate with an expected 15-20% yield reduction for the affected zone based on historical damage patterns. Hail event data may be overlaid on field maps at a spatial resolution of 10 square meters or finer to identify specific zones affected by hail damage, enabling zone-specific yield adjustments and targeted crop insurance claim support. Through the collection of historical weather forecast data 118, data processing unit 104 can determine patterns or trends of the weather. By also incorporating other data from the data inputs 108, the data processing unit 104 can also determine patterns or trends of how the weather is affected by other data inputs 108 and/or how the weather affects other data inputs 108. For example, the data processing unit 104 can analyze the weather forecast data 118 and field information 110 to localize weather patterns for a specific field or region. Furthermore, the data processing unit 104 can determine how weather patterns could affect crop yields and/or market prices.

In further embodiments, the weather forecast data 118 may be weather predictions for weather that has not yet occurred, but rather, is predicted to occur. In embodiments, the data processing unit 104 may compare historical data trends associated with the weather forecast data 118 with collected weather predictions, which may then be utilized by the recommendation engine 106 in generating estimates, predictions, or recommendations.

In embodiments, the weather forecast data 118 may include current weather information that includes information obtained from selected parcels of land, including for example, on-farm sensors, on-farm weather stations. In embodiments, weather forecast data 118 may also include information collected via APIs (e.g., NOAA).

In embodiments, data inputs 108 may comprise user-entered enterprise data 120, which may be obtained by the data collection module 102, such that a database of information may be stored, tabulated, analyzed, and presented to the user. In embodiments, user-entered enterprise data 120 may comprise user-provided information or information obtained by the data collection module 102 relating to one or more aspects of a user's agricultural, commodity, or other resource-based enterprise. For example, the user-entered enterprise data 120 may include information directed to the size of the agricultural enterprise, such as total usable acreage. For example, the enterprise data 120 may also include financial information associated with the agricultural operation, such as the operation's budget, operating costs, assets, and/or liabilities. For example, user-entered enterprise data 120 may also include benchmarks, goals (e.g., financial goals, environmental goals, contractual requirements, or other metric-based goals), milestones, or other indicators of viability for the agricultural operation. For example, the enterprise data 120 may include risk management inputs, including but not limited to marketing contracts, specialty contracts, exotic options, and/or risk management products such as through connection via APIs. For example, the system 100 may connect via ERP systems to obtain marketing contracts or hedging positions of farmers and/or the system 100 may obtain information via hedging or commodity brokers (e.g., StoneX® API). In embodiments, enterprise data 120 may be obtained via integration with agricultural enterprise resource planning (ERP) platforms including, but not limited to, AGRIS (Helena Agri-Enterprises/Trimble), which enables import of producer expense data, input pricing, grain marketing contracts, and grain ticket records. In embodiments, enterprise data 120 may further be obtained via integration with financial accounting platforms including, but not limited to, QuickBooks Online® (Intuit), enabling import of operational expense records, accounts payable, accounts receivable, and budget data associated with the agricultural operation, or functionally equivalent platforms or successors thereto. This automated financial data integration eliminates manual data entry and ensures that cost-of-production calculations, budget comparisons, and profitability projections in the system 100 reflect actual committed expenses and revenues. For example, the recommendation engine 106 may utilize the financial information included in user-entered enterprise data 120 in determining recommendations, estimates, or predictions. For example, if the recommendation engine 106 determines that the agricultural operation will not meet financial benchmarks for an upcoming growing cycle, a recommendation may be generated for the user to hedge the agricultural operation with one or more investment strategies. In embodiments, user-entered enterprise data 120 may be utilized in particularizing recommendations, estimates, or predictions, or a user's specific operation. For example, the recommendation engine 106 may base one or more recommendations, estimates, or predictions based in part on the total land acreage of a user's operation. For example, a user having an operation that includes 1,000 acres of row fields in an area having historically consistent yields, the recommendation engine 106 may determine that the user is unlikely to need to hedge their operation with riskier commodities. Furthermore, the user-entered enterprise data 120, alone or in combination with other data inputs 108, may further be utilized in tailoring recommendations, predictions, or estimates to a plurality of zones of the user's agricultural operation. For example, the system 100 may determine that certain zones of the user's agricultural operation may be better suited for a particular crop or seeding rate than other zones, and specifically tailored recommendations may be generated and displayed to the user on a zone-by-zone basis.

In some embodiments, data inputs 108 may comprise crop insurance data 122, which may be obtained by the data collection module 102, such that a database of information may be stored, tabulated, analyzed, and presented to a user. In embodiments, the crop insurance data 122 may be obtained via analysis or parsing of contracts, insurance documents, automated workflows, or other sources to populate forms with information that is included in insurance calculations. Accordingly, crop insurance data 122 may be obtained as part of an automated workflow. For example, through the analysis of insurance documents and/or contracts, the system 100 may measure probability of indemnity payments in real time and predict the expected value of the insurance documents and/or contracts. In embodiments, crop insurance data 122 may be obtained from sources including, but not limited to: the USDA Risk Management Agency (RMA), which publishes actuarial data, policy summary of business data, commodity/county coverage rates, and indemnity history accessible via the RMA public data portal or API; and user-uploaded crop insurance policy documents provided directly by the user's insurance provider or Approved Insurance Provider (AIP), which are processed by the system 100 using document parsing algorithms to extract policy-specific parameters including insured acreage, coverage levels, protection factors, and premium amounts, or functionally equivalent regulatory sources and document types. In embodiments, crop insurance data 122 may be user-provided information or information obtained by the data collection module 102 associated with insurance associated with an agricultural operation, such as insurance for crops, livestock, or other types of insurance. In embodiments, the crop insurance data 122 may be utilized by the recommendation engine 106 in generating reassessments of risk and recommendations, predictions, or estimates to enhance return relative to risk. For example, for a user that has a robust crop insurance policy for corn that constitutes a majority of that user's agricultural operations, the recommendation engine 106 may determine that the user no longer needs to hedge their agricultural operation because they have a high probability the insurance policy will cover further downside risk. Similarly, for a user that does not have a robust insurance policy and the recommendation engine 106 determines a high likelihood that favorable weather will negatively affect the upcoming year's price, the recommendation engine 106 may generate a recommendation that the user hedge their agricultural operation in a lower-risk investment strategy, such that the user can self-insure from price changes and stabilize revenue for the year.

In embodiments, the data processing unit 104 processes, analyzes, or otherwise reviews the data inputs 108 collected from the data collection module 102 to generate models that can be utilized by the recommendation engine 106. For example, when reviewing the data inputs 108, the data processing unit 104 may correlate trends between different data inputs 108, such as identifying how various conditions or factors associated with one data input 108 correlate with those of another data input 108. Furthermore, the data processing unit 104 can further associate correlations or causations associated with future events, such as a potential future yield, revenue, or risks. For example, the data processing unit 104 can associate correlations or causations between received inputs and determined output risks. In embodiments, the data processing unit 104 may generate recommendations or predictions through analysis of diversification by examining patterns and relationships across multiple inputs, thereby identifying correlations and patterns that may not be readily apparent. For example, data processing unit 104 may examine patterns and relationships between multiple crops, including specialty crops, quantifying diversification benefits by assessing yield correlations, price relationships, or the combined impact on risk and returns, providing a comprehensive view of how crop diversification influences an overall portfolio performance. For example, the data processing unit 104 may process the received inputs 108 and make determinations on how a parcel of land (e.g., field or sub-field) may be best utilized through diversification of more than one crop type.

In embodiments, the system 100 employs document parsing algorithms to extract structured information from uploaded files. For example, users may upload crop insurance policies, marketing contracts, soil test reports, or other agricultural documents in various formats (PDF, image files, scanned documents). For example, Optical character recognition (OCR) and document parsing algorithms enable automated ingestion of marketing contracts, hedging agreements, and strategic documentation directly into the system, eliminating manual data entry and ensuring accurate capture of contractual terms, pricing structures, and delivery obligations. In embodiments, document parsing algorithms identify key data fields (e.g., insured acreage, coverage levels, premium amounts, contract prices, delivery dates) through pattern matching, keyword detection, and context analysis. Extracted data is presented to users for verification before incorporation into system calculations, ensuring accuracy while minimizing manual data entry burden. In some embodiments, users may also upload voice recordings (e.g., field observations, meeting notes) which are converted to text via speech-to-text algorithms and processed similarly to text documents. This multi-modal data ingestion capability enables comprehensive information capture from diverse sources.

In embodiments, the data processing unit 104 may further utilize one or more machine learning algorithms as the data inputs 108 are analyzed and processed, providing for more accurate predictions or estimates for a number of determinations, such as crop yields, managed risks, and optimized input usage. The data processing unit 104 may utilize the machine learning algorithms to develop trained models, which may be associated with correlations or patterns in the data inputs 108. For example, as described above, the data inputs 108 may include historical data, and as such, the data processing unit 104 can correlate raw data associated with factors such as weather conditions, soil composition, geographic location, seeding rates, etc. with recorded crops yields, revenues, or other information associated with the results of an agricultural operations, which may be stored as one or more trained models. As described herein, the recommendation engine 106 may utilize one or more of the trained models to generate an estimate, prediction, or recommendation for a user for a user's agricultural operation. In embodiments, the data processing unit 104 may further be configured to predict risks and returns and assess risks associated with a user's current portfolio. As described herein, the data collection module 102 may be configured to periodically or continuously update the data inputs 108, such that the system 100 is continuously updated with refreshed or new data points. For example, the data collection module 102 may obtain new data or information from the one or more online resources identified above, through on-site sensors or equipment, and/or APIs, and/or via one or more users system 100 may provide updated or new information, such as actual or observed conditions such as yields. In this regard, the data processing unit 104 can update or improve the previously trained and stored models using the updated or new data inputs 108 and/or through actual or observed events. In further embodiments, new data models may be generated through analysis and processing via the data processing unit 104. Accordingly, the recommendation engine 106 can utilize accurate and reliable models that are continuously updated or replaced with up-to-date information.

In embodiments, the machine learning models may be trained using one or more machine learning techniques, including supervised learning, semi-supervised learning, unsupervised learning, reinforcement learning, and/or other techniques, with labeled and/or unlabeled datasets. For example, crop yield prediction models may utilize features including: (1) temporal satellite imagery data capturing vegetation indices (NDVI, EVI) at weekly intervals throughout the growing season; (2) soil composition metrics including organic matter content, pH levels, drainage classification, and nutrient availability; (3) weather parameters including cumulative growing degree days (GDDs), precipitation amounts and distribution, temperature extremes, and hail event occurrences; (4) management practice data including planting dates, seed varieties, seeding rates, and fertilizer applications; and (5) historical yield data for model validation. In embodiments, the models may employ one or more machine learning techniques including, but not limited to: artificial neural networks, including deep feedforward networks and convolutional neural networks for spatial feature extraction from satellite imagery; gradient boosting machines (e.g., XGBoost, LightGBM) for structured tabular data including soil, weather, and management inputs; and copula-based statistical models for modeling the joint dependence structure between yield, price, and basis risk components, enabling correlated multi-variable risk estimation that accounts for the known negative correlation between yield and commodity prices in agricultural markets. The models may employ ensemble methods combining multiple algorithms to improve prediction accuracy and risk estimation robustness. Model validation is performed using k-fold cross-validation techniques, with separate test sets comprising at least 20% of historical data to assess generalization performance. Model retraining occurs automatically when prediction errors exceed predetermined thresholds (e.g., yield predictions differing from actual yields by more than 15%) or when sufficient new data accumulates (e.g., completion of a growing season).

The system 100 continuously monitors model performance and automatically triggers retraining when specific conditions are met. Retraining triggers include: (1) prediction error thresholds being exceeded (e.g., yield predictions differing from actual observed yields by more than 15% for a given field or region); (2) accumulation of sufficient new data (e.g., completion of a growing season providing a full cycle of new training examples); (3) statistically significant changes in data distributions (e.g., detection of regime shifts in weather patterns or market dynamics using statistical tests such as the Kolmogorov-Smirnov test); (4) scheduled periodic retraining (e.g., annual model updates incorporating the most recent growing season data); or (5) user-initiated retraining requests following major operational changes. Upon triggering retraining, the system automatically partitions data into training and validation sets, executes model training algorithms, evaluates performance against holdout data, and deploys updated models only if performance metrics meet or exceed previous model performance, ensuring continuous model improvement without degradation.

In embodiments, the system 100 captures user adjustments to recommendations, predictions, or estimates along with optional user-provided explanatory notes. For example, when a user modifies a recommended seeding rate, yield goal, or hedge position, the system records: (1) the original recommendation value; (2) the user-adjusted value; (3) user-entered notes explaining the rationale for adjustment (e.g., “soil test showed higher nitrogen levels than historical average”); (4) user identity and timestamp; (5) relevant contextual data at time of adjustment (e.g., weather conditions, market prices, crop development stage). These recorded adjustments may be used to create a training and/or refinement dataset for model improvement. The data processing unit 104 analyzes correlations between user adjustments and subsequent actual outcomes (e.g., whether user-adjusted seeding rate produced better yields than system recommendation). When statistically significant patterns emerge (e.g., a specific user category such as agronomic advisors consistently makes yield adjustments that improve accuracy) the system incorporates these patterns into future model training, gradually adapting recommendations to incorporate domain expertise. This feedback loop enables continuous improvement without requiring manual model retraining by data scientists.

In embodiments, the recommendation engine 106 utilizes the trained and stored data models generated by the data processing unit 104 to generate automated estimates, predictions, or recommendations for a user's agricultural operation. For example, the recommendation engine 106 can generate automated recommendations for hedging and input adjustments based on a number of factors including for example, a user's risk threshold, benchmarks, and/or goals (e.g., financial, environmental, or the like) combined with analysis of the data models. In embodiments, the recommendation engine 106 generates recommendations, estimates, or predictions that are designed to optimize the user's agricultural operation. The optimization may be achieved through recommendations that maximize or boost the yield or revenue of the agricultural operation and/or by minimizing risks associated with the agricultural operation. For example, using advanced statistical models, the system 100 calculates various risk metrics including yield risk, price risk, input risk, output risk, input-output risk, and/or other identified or provided risks and the effectiveness of hedging, management strategies, crop insurance, risk mitigation strategies, crop diversification, operation diversification, and/or other mitigation strategies, allowing for precise risk reduction assessment.

In embodiments, the system 100 employs a structured risk decomposition framework to quantify financial risk in precise monetary values across multiple independent components. The risk decomposition data structure comprises: (1) a production risk component quantifying dollar-value exposure from yield variability, calculated using historical yield distributions and current crop development status; (2) a futures price risk component quantifying dollar-value exposure from commodity price fluctuations between current prices and expected harvest prices, calculated using historical price volatility and current market conditions; (3) a basis risk component quantifying dollar-value exposure from the difference between local cash prices and futures prices, calculated using historical basis patterns and current local supply/demand factors; (4) an input cost risk component quantifying dollar-value exposure from variable input costs such as fertilizer, seed, and fuel prices; and (5) a correlation matrix capturing interdependencies between risk components to avoid double-counting when components move together. The system calculates total portfolio risk not as a simple sum of components but using portfolio mathematics that account for correlations (e.g., negative correlation between yield risk and price risk in commodity markets). Each risk component is updated in real-time as underlying data changes, with component-specific mitigation strategies recommended by the recommendation engine 106. For example, production risk may be mitigated through crop insurance, futures price risk through derivatives, and basis risk through careful delivery timing, location selection, contract terms, or counterparty selection.

In embodiments, the recommendation engine 106 receives inputs from the user (or users) of the system 100, such as budgets, revenue, insurance information, crop types, land acreage, etc. The recommendation engine 106 may further review or analyze other user provided adjustments, such as a risk threshold, minimum revenue, seeding capabilities, or other adjustments to the inputs. For example, adjustments may also be provided by external or third-party users, such as agronomic advisors, marketing teams, farm managers, risk managers, etc. In embodiments, the user provided adjustments may be provided prior to any recommendations, estimates, or predictions are generated and displayed. In embodiments, the user provided adjustments may be provided after at least a first recommendation, estimate, or prediction has been generated and displayed.

In generating the recommendations, predictions, or estimates, the recommendation engine 106 may utilize any combination of the above-referenced factors or data points, such as market conditions, weather forecasts, or historical yield data, with one or more machine-trained models to generate the recommendations, predictions, or estimates.

In embodiments, the generated recommendation, prediction, or estimate may be provided to the user via a dashboard of a user interface, for example. In embodiments, the generated recommendation, prediction, or estimate may be provided automatically to a user without a user-provided instruction or input. For example, current market prices, weather forecasts, or other data points (with or without a generated recommendation, prediction, or estimate) may be automatically displayed to the user via the dashboard. In embodiments, the generated recommendation, prediction, or estimate may be provided in response to a user command or input. For example, a user may request a recommendation for hedging after application of insurance coverage, and the recommendation engine 106 can analyze the user request, locate relevant data inputs 108 and/or trained models, generate a prediction or recommendation, and display the prediction or recommendation to the user.

As described above, the data collection module 102 continuously collects or receives updated or new data inputs 108, and the data processing unit 104 updates the trained models accordingly based on these updated or new data inputs 108. Similar to the data processing unit 104, the recommendation engine 106 can be configured to automatically update previously determined and generated recommendations, predictions, or estimates. For example, if a new data input 108 is received that affects or changes a previously generated recommendation, prediction, or estimate, the recommendation engine 106 may automatically update the previous recommendation, prediction, or estimate based on the new data input 108. For example, if the recommendation engine 106 provides an initial estimate for a predicted yield of corn for a field (or sub-field zones at a spatial resolution of 10 square meters or finer) associated with the user based on historical weather forecast data 118 and subsequently received updated weather forecast data 118 indicates a drier than average year; the recommendation engine 106 can update the previous estimate with a revised estimate, indicating a lower than predicted yield of corn for the field (or sub-field zones). In this regard, the system 100 automatically provides updated recommendations, predictions, or estimates to the user upon a determination that a prior recommendation, prediction, or estimate has been changed upon receipt of updated data inputs 108. Accordingly, users of system 100 are provided with access to up-to-date and accurate information, enabling them to make more informed decisions related to their agricultural, or commodity-based operations.

In embodiments, the system 100 may be further adapted and configured to utilize the data inputs 108, the one or more trained models, the data collection module, 102, the data processing unit 104, and/or the recommendation engine 106 to create agricultural zones for optimizing one or more fields of one or more parcels of land. As described above, one or more data inputs 108 may be associated with parcels of land, including for example, field information 110 and satellite imagery data 112. For example, the data collection module can retrieve geographic polygon data and satellite imagery that are specific to a user-identified agricultural field. The data processing unit 104 can analyze the received data inputs 108 and generate geographic data frames that are enriched with additional topographic and soil data, including elevation, slope, soil type, among other attributes. The system 100 can utilize the previously described models that have been trained with historic yield data 114 and satellite imagery data 112 to predict crop yields at various quantile levels, optimizing for median and lower yield predictions. Furthermore, the system 100 can process this data to calculate variability metrics, such as standard deviations between yield predictions. In embodiments, these zones may be presented to the user, such as through a user interface as described below. In this manner, a user is presented with granular and adaptive analysis of specific zones of their fields or parcels of land, leading to optimization of land use and yield. The system 100 can then utilize cluster analysis techniques (e.g., KMeans), which can be used to classify geo-referenced data points into optimal management zones based on multi-dimensional scaling (e.g., PCA) of relevant agronomic features. By utilizing merging and refinement procedures (e.g., merge_zones), the system 100 can provide homogeneity and reduce sub-optimal zone sites. As described herein, the data collection module 102 can continuously update the data inputs 108, such that the zones may be automatically updated as the utilized data inputs 108 are updated or refreshed.

In embodiments, the system 100 may be further adapted and configured to utilize the data inputs 108, the one or more trained models, the data collection module, 102, the data processing unit 104, and/or the recommendation engine 106 to optimize investment portfolios and/or other investments opportunities that do not require trading, but investing through tailored risk management products by utilizing historical and real-time market data to form optimal trade and/or investment recommendations aimed at minimizing value-at-risk or maximizing the Sharpe ratio, for example. For example, the recommendations may be partially based on user-provided inputs, including for example, user goals (as described above), revenue enhancement, environmental vs. financial considerations, or other user-provided inputs. For example, the data inputs 108 can include historical and current financial data corresponding to a set of financial assets. For example, market data, including high-low-close-open (HLCO) figures for specified symbols, can be queried from a persistent data store, such as a DynamoDB database. The queried data can then be formatted into machine-readable tabular structures using methods including, but not limited to, Pandas DataFrames. For example, inputs including investments opportunities for private or otherwise non-trading assets may be utilized, wherein expected revenue and correlations may be ascertained versus a current portfolio. Historical risk assessment can be calculated utilizing variance and covariance matrices derived from past market performance or other investment opportunities, which involves estimating expected returns and risk metrics (e.g., volatility) using statistical measures such as Covariance Shrinkage methodologies. The system 100 can further be configured to retrieve user-specific historical portfolio returns, leveraging the queried data to calculate performance metrics across multiple trading periods. The system 100 further utilizes efficient frontier methodologies to determine optimal asset allocation for commodities in production or storage, which may involve configuring portfolio weights to achieve defined financial targets, such as minimizing volatility or maximizing expected return, as represented by the Sharpe ratio. The system 100 further generates recommendations for rebalancing current portfolio holdings by evaluating existing weights against calculated optimal weights, aiming to minimize value-at-risk and enhance expected returns, among other methods for reaching user-provided goals. The system 100 further integrates real-time data feeds to continuously update asset prices. This enables instantaneous recalibration of portfolio weights and performance projections as new data becomes available.

In embodiments, by processing each asset's real-time value, the system 100 can provide running estimates of potential daily value-at-risk, adaptable to position shifts within the optimized portfolio framework. Predicated on the analytical outcomes, the system 100 outputs actionable insights tailored to user-defined strategies and goals. System generated outputs such as pricing targets, risk measures, prospective yield, or other generated parameters that can be used in generating recommendations, estimates, and/or projections are calculated and stored for retrieval and evaluation when generating recommendations to align with the user-provided goals. For example, calculating value-at-risk is generally described in U.S. patent application Ser. No. 17/063,619 filed on Oct. 5, 2020, which is incorporated herein by reference in its entirety.

Furthermore, the system 100 can be configured or adapted to integrate predictive analytics, enabling the forecasting of value-to-risk, asset yields, or other metric-based goals based on real-time market data. Using one or more machine-trained algorithms that factor in historical trends and current economic indicators, the system 100 continuously updates yield predictions for each asset within the portfolio.

Furthermore, the system 100 can be configured or adapted to analyze a user's selected investment portfolio, including any hedged or unhedged positions, by computing yield-adjusted performance metrics. Hedging strategies are assessed for their effectiveness in mitigating risk against adverse price movements. The system 100 calculates the yield on hedged positions, providing a comprehensive view of expected portfolio performance in both hedged and unhedged scenarios, among other scenarios such as marketing strategies, insurance/risk management products, or other scenarios that may affect the commodity-based operation. Through the combination of real-time yield forecasts and current hedge effectiveness, the system 100 can be further configured to identify long futures positions that are underperforming or carry excessive risk relative to anticipated returns. For example, funds released from the sale of inefficient hedged or unhedged positions may be recommended for allocation towards a position in a diversified portfolio of uncorrelated assets, constructed to optimize the trade-off between risk and returns. The system 100 suggests an asset distribution that aligns with efficient frontier principles, while considering updated commodity yield predictions that are affected by weather, which changes the user's hedged or unhedged position. By reallocating capital into a diversified mix of assets, the system may aim to lower overall portfolio risk (as measured by metrics such as Value-at-Risk or other metrics) and enhance returns, thereby balancing short-term fluctuations with long-term growth potential.

In embodiments, once the portfolio adjustments are defined, the system 100 provides detailed execution strategies, including timing and scale of trades. Transaction execution can be automated through integrated trading platforms or managed manually based on the generated insights. The system 100 continuously monitors post-reallocation performance, ensuring alignment with projected outcomes and readiness to adapt further based on evolving market conditions and/or user-adjusted goals.

As described herein, embodiments of the present disclosure may be utilized in a diverse range of use cases and for example, may be utilized for diverse portfolio optimization. Accordingly, in embodiments, the system 100 may include a portfolio aggregation module 124. In embodiments, the portfolio aggregation module 124 may be configured for integrating a plurality of diverse portfolio assets into a unified portfolio representation. For example, the portfolio aggregation module 124 may aggregate dynamic physical positions of assets (e.g. crops, livestock, equipment, natural resources, or other physical assets), existing futures contracts, options positions including standard and exotic options, crop insurance coverage, and/or investment assets, or a combination thereof into a unified portfolio representation. For example, the unified portfolio representation may represent a user's (or a plurality of users or an enterprise) aggregated portfolio that includes a diverse range of different assets. Through aggregation, the entire unified portfolio representation may be tracked to determine an overall value, risk, or liabilities of the portfolio as well as how individual assets are performing.

In embodiments, the system 100 may further include a rebalancing module 126. In embodiments, and as described herein, the system 100 may be configured for continuously monitoring the data inputs 108. In embodiments, the rebalancing module 126 may be configured for continuously monitoring the unified portfolio representation. In embodiments, through the monitoring, the rebalancing module 126 is also configured to trigger rebalancing when risk thresholds are exceeded or optimization parameters change. Upon triggering of the rebalancing, the rebalancing module 126 is configured to generate execution instructions that may be sent to one or more trading platforms, providing instructions to update the unified portfolio representation (e.g., buying or selling assets).

In embodiments, maintaining the unified portfolio representation comprises maintaining a consistent portfolio state across (i) a physical production position derived from operational monitoring data, (ii) one or more derivative hedge positions, and (iii) one or more investment positions. In some embodiments, the system 100 stores a portfolio state record in a persistent data store and updates the portfolio state record using atomic transactions in response to execution reports received from external systems and in response to updated operational monitoring data and market price data. For example, when updated monitoring data changes an expected harvest quantity, the system 100 re-computes hedge ratios and generates updated order instructions while preventing double-counting of filled, partially filled, cancelled, or rejected orders by reconciling open orders and executed trades against the stored portfolio state. In some embodiments, each order instruction includes an order identifier (e.g., a correlation identifier and/or idempotency key) that is stored with the portfolio state record and used to correlate execution reports, suppress duplicate order transmissions, and suppress duplicate portfolio-state updates. In some embodiments, the system assigns one or more data availability indicators (e.g., observed, imputed, missing, stale, or outlier) to values in the unified time-series representation and computes a confidence score used to (i) adjust an order quantity and/or (ii) inhibit automated execution when confidence is below a threshold. In some embodiments, when the system detects stale, missing, or outlier inputs for required data sources, the system inhibits transmission of order instructions for automated execution until data integrity conditions are satisfied.

In embodiments, during dynamic rebalancing the system 100 continuously monitors the integrated portfolio and automatically triggers rebalancing when conditions change. For example, a situation that may trigger rebalancing includes physical position changes, e.g., as the crop develops, real-time monitoring may show changing yield expectations. For example, if satellite data indicates drought stress reducing expected yield by 10%, the system 100 recalculates the physical position value, adjusts hedge quantities accordingly, and/or rebalances investment allocations.

In embodiments, as market prices move and time passes, option delta values change. A put option purchased at 0.30 delta may move to 0.50 delta as prices decline. The system 100 continuously monitors these changes and rebalances hedge ratios to maintain target protection levels.

In embodiments, as investment market conditions change, the efficient frontier shifts. The system 100 automatically recalculates optimal investment allocations and generates rebalancing recommendations to maintain optimal risk-adjusted returns.

Accordingly, this continuous rebalancing ensures that the integrated portfolio (physical crop+derivatives+investments) remains optimized throughout the production cycle, not just at initial setup. In embodiments, the rebalancing may be performed pre-harvest. In embodiments, the rebalancing may be performed post-harvest. In embodiments, the rebalancing may be performed for future crops to be planted in the future, providing for predictive re-balancing for future growing cycles.

In embodiments, the system 100 may further include an execution interface 128 configured to implement recommendations across multiple trading platforms for futures, options, and investment assets. Accordingly, the system 100 may provide a holistic system capable of providing services for a diverse range of assets for portfolio optimization.

In embodiments, the system 100 may be further configured for determining or unlocking economic value from agricultural assets during one or more production cycles, when such assets are traditionally illiquid. For example, the processes associated with determining or unlocking economic value may be performed for generating liquidity from otherwise illiquid agricultural assets at various stages including pre-plant, during the growing season, at post-harvest storage, and/or future crop production, or a combination thereof, as it cycles through derivatives, financial instruments, insurance products, investments, or other risk transfer and liquidity mechanism or strategies. For example, the system 100 may achieve this through an integrated approach that combines real-time asset monitoring, e.g., via the data collection module 102, with capital-efficient risk management and liquidity generation through options strategies, and optimized deployment of freed capital. For example, traditional agricultural finance treats growing crops as illiquid assets with no accessible value until a harvest. A farmer who plants corn in May cannot access the value of the growing crop until harvest in October or November. During the growing period, the crop may have substantial economic value based on planted acreage and expected yield, but such value is effectively locked. In embodiments, the system 100 provides a solution to this problem through an integrated approach. For example, the system 100 may continuously monitor crop development through data inputs 108, including for example, satellite imagery data 112, weather forecast data 118, soil data from field information 110, and historical yield data 114. The data processing unit 104 analyzes this data to calculate a real-time economic value of the growing crop. For example, if satellite data shows the crop is developing at 120% of historical average, the system updates the expected harvest quantity accordingly, increasing the calculated asset value. This real-time valuation provides the foundation for risk-managed liquidity generation.

Continuing, once the real-time asset value is established, the system 100 determines optimal hedging strategies to protect against price risk while simultaneously identifying investment opportunities that maximize capital utilization. For example, the system 100 evaluates both futures-based and options-based hedging based on capital efficiency, not just risk reduction. For example, the system 100 may compute a first capital requirement for a futures-based hedge and a second capital requirement for an options-based hedge providing an equivalent risk protection level, and may select the options-based hedge when the computed difference indicates freed capital for alternative deployment. However, the system 100 can examine other strategies outside of futures and options, and these examples are provided to be illustrative, and not limiting. The system 100 further analyzes the freed capital to recommend strategic investments, such as forward contract positions on complementary commodities, diversification into uncorrelated agricultural assets, or liquidity reserves for opportunistic market entries, that align with the user's risk tolerance parameters and portfolio objectives. By integrating hedging efficiency with investment allocation logic, the system 100 enables users to maintain downside protection while capturing upside potential, thereby optimizing total portfolio performance rather than treating risk management and capital growth as separate functions. This unified approach leverages real-time market data and predictive analytics to continuously recalibrate both hedging positions and investment allocations as market conditions evolve.

The system 100 performs this analysis dynamically using market price data 116, calculating option Greeks (particularly delta) to ensure equivalence in risk protection. This capital efficiency analysis is performed by recommendation engine 106 and may be displayed to the user via dashboard 502 (as described below).

In embodiments, beyond selecting options for capital-efficient downside protection, the system 100 further generates liquidity through strategic options selling. Once a protective put option establishes a price floor (or futures position locks in a price), the system 100 may recommend selling call options against the protected position. For example, a farmer may have a hedged crop with protective puts establishing $4.00/bushel floor and a current market price is $4.50/bushel. Based on these inputs, the system 100 may recommend selling $5.00 call options, generating $0.30/bushel premium. For 100,000 bushels, this generates $30,000 in liquid capital. Accordingly, the farmer maintains upside to $5.00 while generating immediate cash flow. Alternatively, when capital needs are greater, the system 100 may recommend selling in-the-money calls that generate higher premiums by sacrificing upside participation. The recommendation engine 106 optimizes this tradeoff based on the user's risk threshold and capital requirements.

In embodiments, the system 100 is configured for optimized capital allocation. For example, the capital freed through capital efficiency and/or premium generation is then available for investment. The system 100 utilizes portfolio optimization techniques to allocate this freed capital across investment assets that maximize risk-adjusted returns. For example, and as described herein, the system 100 analyzes historical and real-time market data for various asset classes including equities, bonds, commodities, and other investments. The data processing unit 104 calculates efficient frontier portfolios using methods including mean-variance optimization, Sharpe ratio maximization, and value-at-risk minimization. The recommendation engine 106 then suggests specific investment allocations for the freed capital. For example, when freed capital is identified, the system 100 may allocate a first portion to equities, a second portion to fixed income instruments, and a third portion to commodities and/or other diversifying assets. This allocation generates returns on capital that would otherwise be locked and/or tied up as margin capital, while maintaining alignment with desired financial risk.

In some embodiments, the portfolio optimization is performed by a multi-agent system wherein specialized agents collaborate to achieve optimal outcomes. In other embodiments, the optimization is performed by a centralized algorithm. In yet other embodiments, a hybrid approach combines centralized coordination with distributed agent-based execution.

In embodiments, the system 100 may be implemented using various technologies including traditional software modules, microservices architectures, agent-based systems, distributed computing frameworks, or hybrid approaches. Agent-based implementations may employ rule-based agents, machine learning agents, reinforcement learning agents, large language model agents, or combinations thereof. The agents may operate autonomously or semi-autonomously, making decisions independently or in coordination with human operators. The level of autonomy may be configurable based on operator preferences, risk tolerance, regulatory requirements, or system confidence levels.

In embodiments, the system 100 may be integrated as part of computer-executable instructions carried out by one or more controllers 132. In embodiments, the one or more controller 132 include one or more processors 134 and one or more memory devices 136. Accordingly, the system 100 may be configured for operating on a single computing system or as part of a larger network of computing systems. For example, the processes carried out by the system 100 may be performed by the one or more processors 134 carrying out computer-readable instructions stored in the one or more memory devices 136.

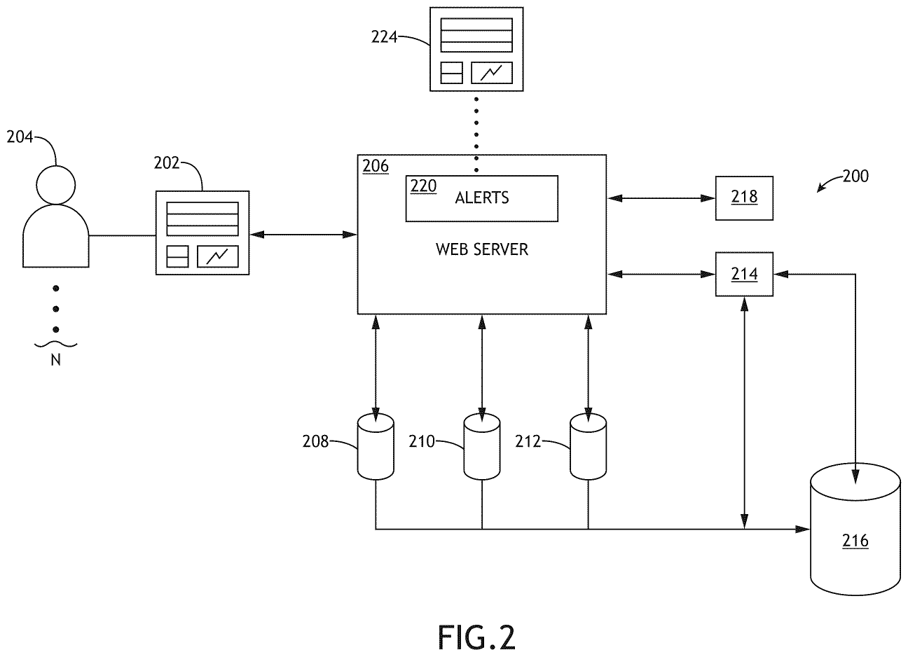

FIG. 2 depicts an illustrative system architecture 200 for some embodiments of the present disclosure. System architecture 200 may generally correspond to a back end for the system 100. That is, any of the data inputs 108 discussed above may be received, processed, analyzed, etc. by system architecture 200. In embodiments, the system architecture 200 may be configured for scalability, allowing for enterprise-level applications in addition to or in place of individual user applications. For example, the system 100 may be configured for use with a company or business having a plurality of users interacting with a shared client portal 202. In embodiments, the plurality of users interacting with the shared client portal 202 may establish personal dashboards (e.g., dashboard 502 as described below).

In embodiments, the system architecture 200 may be configured with a cloud-based scalable architecture structure, deployment cloud, mobile architecture, distributed models, or other computing system architectures, providing robust performance during peak usage periods. For example, during growing seasons, agricultural data processing requirements may be higher than at other times during the year and accordingly, the system architecture 200 may provide increased performance during these high usage periods.

System architecture 200 includes a client portal 202 which may be configured as the front-end of system architecture 200 via which one or more users 204 may interact with elements of the system architecture 200. User 204 (singular or plural) may represent a farmer or owner of an agricultural operation, for example. For example, the client portal 202 may be configured as an agronomic, marketing, or other client (e.g., B2B2C client) adviser managing multiple client accounts can seamlessly access individual client platforms through a dropdown menu integrated within the system interface, or alternatively navigate via a centralized admin panel that provides consolidated oversight across all client portfolios.

In embodiments, the user 204 may include any type of individual, or groups of individuals, that a producer or owner is engaged in business with, such as a farm manager, marketing advisor, agronomic advisor, or lender. Various user interfaces that may be displayed as part of client portal 202 are discussed further herein. Generally, however, the client portal 202 provides a mechanism for the user 204 to make selections, provide inputs, or otherwise interact with elements of the system architecture 200. In embodiments, the client portal 202 may be configured to automatically adjust user interfaces based on the devices accessing the client portal 202 (e.g., automatically adjusting specifications, orientation, margins, sizing, resolution, etc.) for running on desktop, tablet, or smartphone) thereby providing connectivity and integration to users of multiple client devices. In embodiments, a plurality of users accessing the client portal 202 from multiple devices may still be provided a synchronized user interface. For example, a first user accessing the client portal 202 via a smart phone while located on-site at a field may be provided with the same user interface as a second user accessing the client portal 202 from a desktop computer while located in an office.

Client portal 202 may be coupled to a web server 206. For example, the web server may comprise one or more servers and may be implemented as a platform-as-a-service model. Web server 206 may comprise or otherwise be associated with various components, including for example, databases, APIs, data visualization tools, and the like, which may be provided by, requisitioned from, or otherwise associated with web server 206. For example, the web server 206 may be configured as an application server tier for executing application logic and recommendation algorithms, as described herein. For example, the web server 206 (alone or in combination with the client portal 202) may be configured as a web server tier for handling user interface requests.

In some embodiments, one or more of the data processing unit 104, recommendation engine 106, and/or user-interface services are implemented as one or more software agents. For example, a first agent monitors incoming data feeds and detects triggers; a second agent selects and executes analytic pipelines to compute forecasts and risk metrics; a third agent generates human-readable explanations and/or machine-readable execution instructions; and a coordinating agent enforces user permissions and audit logging. In some embodiments, the agents communicate via message queues and share a common state store, enabling multi-agent and/or hybrid agent/human workflows.

By way of non-limiting example, an API of the web server 206 may provide for communication and exchange of information with external computing devices and/or systems. The API architecture supports RESTful endpoints with JSON data formatting, OAuth 2.0 authentication protocols for secure access, and webhook implementations for real-time event notifications. In embodiments, the system 100 integrates with multiple external platforms via APIs including: (1) agricultural equipment manufacturers (e.g., JOHN DEERE® Operations Center, CLIMATE FIELDVIEWTM) for boundary data, as-applied field data, and yield data; (2) ERP systems (e.g., AGRIS) for importing producer expenses, input purchases, and grain marketing contracts; (3) market data providers (e.g., Chicago Mercantile Exchange, local cash grain elevators) for real-time and historical pricing data; (4) weather data services for precipitation, temperature, and severe weather event notifications; (5) satellite imagery providers (e.g., Sentinel Hub, Planet Labs) for multi-spectral field imagery; (6) crop insurance providers for policy information and claims processing; and (7) financial institutions and brokers for trade execution and portfolio management. The system analytics can also transmit actionable information via APIs to external systems such as irrigation controllers, precision agriculture equipment, trading platforms, and risk management advisors, enabling automated workflow execution based on system recommendations.

For example, the web server 206 may be in communication with external equipment (e.g., John Deere®, Climate FieldView™), external sensors, external ERP Systems (e.g., AGRIS with and agricultural retailer system from which producer expenses, input prices, commodity prices, grain tickets, bookings, marketing contracts, contract offerings, and/or other operation data are imported to the system 100), and/or market data sources (e.g., Chicago Mercantile Exchange). In embodiments, the system 100, via the web server 206 for example, can interface via APIs with external systems such as underwriters, brokers, crop insurers, bankers, agronomists, etc. In embodiments, the data collection module 102, data processing unit 104, and/or the recommendation engine 106 may be implanted by the web server 206.

In embodiments, the web server 206 may be communicatively coupled to a first storage 208 configured to store one or more machine learning algorithms. As described above, the data processing unit 104 may analyze and process the received data inputs 108 in order to determine correlations, trends, and/or patterns in the data inputs 108 for use in generating recommendations, predictions, or estimates by the recommendation engine 106. In embodiments, the one or more machine learning algorithms may be stored in the first storage 208 in a manner to be accessible to the web server 206.

In embodiments, the web server 206 may be communicatively coupled to a second storage 210 configured to store one or more machine-trained models. As described above, the data processing unit 104 may analyze and process the received data inputs 108 in order to determine correlations, trends, or patterns in the data inputs 108 for use in generating recommendations, predictions, or estimates by the recommendation engine 106. In embodiments, one or more machine trained models generated by the data processing unit 104 may be stored in second storage 210 in a manner accessible to the web server 206. Furthermore, the one or more machine trained models may be associated with one or more risk strategies.

In embodiments, the web server 206 may be coupled to a third storage 212 configured to store information or data received from the user 204 via the client portal 202 or that is otherwise provided to the system 100. In embodiments, information may be provided via document uploads or direct system integrations. For example, the system 100 may integrate with ERP (Enterprise Resource Planning) systems used by agricultural retailers and cooperatives, such as AGRIS. Through these integrations, the system automatically imports producer expense data (e.g., seed purchases, fertilizer applications, chemical costs), input pricing information (e.g., current fertilizer prices, seed variety pricing), and grain marketing contracts (e.g., forward contracts, basis contracts, delivery obligations). Data synchronization occurs at configurable intervals (e.g., nightly batch updates or real-time via webhook notifications), with conflict resolution protocols that prioritize more recent data or flag discrepancies for user review. This automated data flow eliminates manual data entry, reduces errors, and ensures financial projections reflect actual committed expenses and revenues. For example, in embodiments, information may be provided via document uploads in which received documents are parsed to prepare or populate internal forms or documents utilized by the system 100 with information obtained via the documents. For example, a user 204 may upload pictures associated with their commodity-based operation, may upload soil sample information, may upload voice recordings, may upload handwritten notes, or other information associated with their commodity-based operation. In embodiments, the information or data received from the user 204 may include information related to a user portfolio containing one or more commodities. As described herein, the user 204 may hedge and/or manage commodities through the use of one or more portfolio selections, and information received associated with the portfolio selection may be stored in third storage 212.

In embodiments, the web server 206 and/or each of first storage 208, second storage 210, and third storage 212 may be in connection with a data analytics and trend module 214. In embodiments, the data analytics and trend module 214 may include at least one of the data processing unit 104 and/or the recommendation engine 106.

In embodiments, the system architecture 200 may further include a data warehouse 216. The data warehouse 216 may be a data storage tier for the long-term storage or archiving of information associated with system architecture, including for example, information associated with data inputs 108. For example, the data warehouse 216 may include a data storage tier including at least one relational database and at least one time-series database optimized for sensor data storage.

In embodiments, the system architecture 200 may further include portfolio services 218. As described below, the user 204 may make one or more portfolio selections via the client portal 202. In embodiments, the web server 206 and/or the data analytics and trend module 214 may be in communication with portfolio services 218, which may be online databases or servers associated with one or more financial markets, investments, non-traded financial products, non-traded risk products, and/or structured products. For example, the portfolio services 218 may include, but is not limited to: (a) exchange-traded funds (ETFs); (b) over-the-counter (OTC) derivatives; (c) structured notes and certificates; (d) index-linked securities; (e) catastrophe bonds; (f) weather derivatives; (g) yield or revenue swaps; (h) custom bilateral contracts; (i) parametric insurance products; (j) tailored crop insurance policies; (k) revenue protection insurance; (l) multi-peril agricultural insurance; (m) index-based insurance products; (n) hybrid financial-insurance instruments; and/or (o) portfolio insurance products.

In embodiments, the web server 206 and/or the data analytics and trend module 214 may retrieve information from the portfolio services 218 for displaying information via the client portal 202 and/or in processing the data for determining correlations, trends, patterns, or strategies. In some embodiments, the web server 206 may also be in communication with portfolio services 218 wherein instructions or data may be sent to portfolio services 218. For example, certain actions of the present disclosure may be automated, including for example, automatic buying or selling of commodities upon a certain benchmark (e.g., user-provided goal, revenue threshold, timing trigger, etc.) being met or a risk falling below a pre-determined threshold. Accordingly, upon certain conditions, the web server 206 may send instructions to portfolio services 218 to perform such an action associated with the user 204.

In embodiments, the web server 206 may be further configured for generating alerts 220 that may be communicated to the client portal 202 and/or to one or more external computing devices, APIs, or other external entities (collectively, external users 224). For example, the generated alerts 220 may be generated notifications informing the user 204 to buy/sell/portfolio execution triggers, with a frequency determined by action parameters (e.g., hitting performance thresholds, mitigating losses, or other action items that may be based on user-provided or system-generated goals). In embodiments, the alerts 220 that are generated may also be delivered to other recipients, including via phone/systems/API/text notifications (e.g., the external users 224).

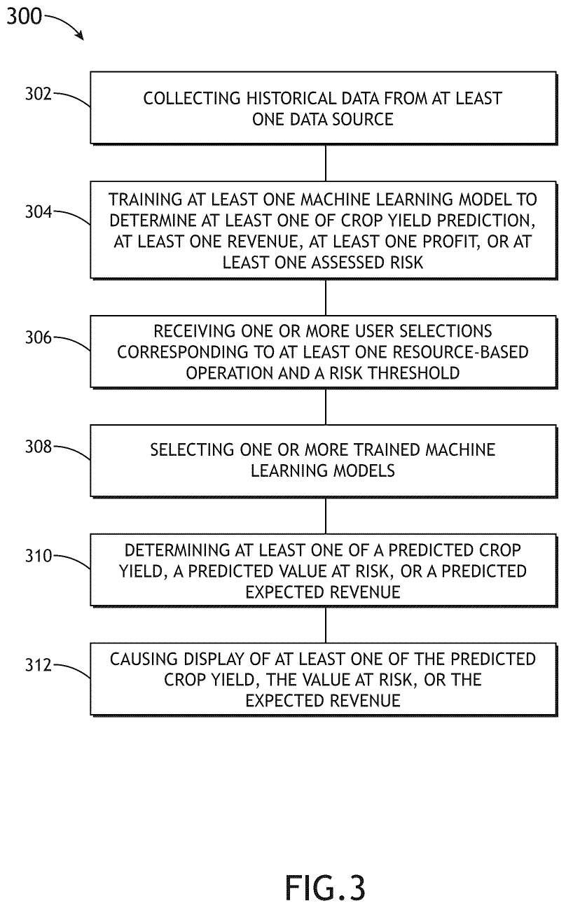

FIG. 3 depicts an illustrative method of analyzing data inputs 108 and generating a prediction, recommendation, estimate, or any combination thereof, generally referenced by reference numeral 300. For example, method 300 may be utilized in a variety of use case scenarios, including for example, agricultural operations, commodity operations, asset-based operations, or other resource-based operations as described above, investment portfolios, financial markets or exchanges, or other metric-based systems in which input data may be analyzed for estimate and/or correlate to outputs such as revenue, returns on investment, risk, or other metric-based outputs. In embodiments, method 300 may be performed via the one or more processors 134 executing computer readable instructions stored on the one or more memory devices 136.

In some embodiments, method 300 may be initiated by a system command or as part of an automated workflow for collecting data and training machine learning models. Accordingly, an initial step 302 may include collecting historical data and/or real-time data from at least one data source, including at least one of historical field information, satellite imagery data, yield data, market price data, weather forecast data, enterprise data, or insurance data, or any combination thereof.

Next, at step 304, training, by a data processing unit 104, at least one machine learning model to determine at least one of an asset yield prediction, at least one revenue, at least one profit, or at least one assessed risk associated with at least one parcel of land or at least one commodity using a first training data set that includes the historical data occurs. As described above, the data processing unit 104 may process and analyze the data inputs 108 for determining trends, patterns, and/or correlations at a granular level, such as for a specific field of a farm, to town or township level, county level, state level, region level or even national level covering a plurality of different farms or fields. In processing and analyzing the data inputs 108, the data processing unit 104 utilizes machine learning algorithms to predict asset yields and assess risks based on identified patterns and correlations identified in the data inputs 108. Step 304 may also include the storing of the at least one machine learning model in a database or other storage, wherein the at least one machine learning models are available for later training or utilization, including for example, updating the machine learning model with new data to improve accuracy and reliability or for use by the recommendation engine 106 in generating a prediction or recommendation.

At step 306, receiving from a user interface, one or more user selections corresponding to at least one commodity-based operation and a risk threshold for the at least one commodity-based operation occur. In embodiments, the at least one commodity-based operation may be associated with a parcel of land that a user is determining the viability of conducting farming, livestock raising, or other agricultural activities. For example, a user may have a 40-acre parcel of land and want to determine the viability of planning for different crops, such as corn or wheat, or compared to raising livestock, such as cattle or hogs. In embodiments, the at least one commodity-based operation may involve a single parcel of land with a single field, where the user utilizes the present disclosure to manage the entire parcel of land. In further embodiments, the at least one commodity-based operation may be a more complex inquiry, for example, a parcel of land with multiple fields or multiple parcels of land, with the user wanting to generate different predictions and/or recommendations for the different fields or parcels of land.

Furthermore, the one or more user selections may also include a user-selected risk threshold. In embodiments, the risk threshold may be a manually provided risk threshold or a selection of pre-determined risks. In embodiments, the user-selected risk threshold may be associated with the entirety of the agricultural operation, such as a whole farm, or alternatively, the user-selected risk threshold may be particularized, with a plurality of risk thresholds for a single agricultural operation. For example, a large-scale farm may encompass multiple fields and/or produce various commodities, including row crops and livestock. The user can select different risk thresholds for various fields of the farm and/or for different commodities. For example, the user may select a higher risk threshold for row crops in one field than for livestock in another field. In embodiments, the risk threshold may be associated with factors including but not limited to crop yield, crop yield percentage, revenue, net income, or any combination thereof.

At step 308, responsive to receiving one or more user selections, selecting one or more trained machine learning models that were trained by the data processing unit 104 occurs. In embodiments, one or more trained machine learning models may be selected from a database or storage storing a plurality of trained machine learning models. As described above, embodiments of the present disclosure provide for the training of machine learning models based on received data inputs 108 and for determining correlations, trends and/or patterns based on analysis of the data inputs by the data processing unit 104. After one or more user selections is received, one or more machine learning models may be selected. The one or more machine learning models that are selected may be based on an analysis of the received user selection. For example, the commodity-based operation of the user selection may comprise information including land type, location, crop type, etc. Analysis of the information included with the user selection can be utilized in selecting and retrieving at least one machine learning model that corresponds and/or best fits the agricultural operation included in the user selection.

At step 310, determining, through a recommendation engine 106, at least one of a predicted crop yield, a predicted risk metric (e.g., a predicted value at risk), or a predicted expected revenue for the at least one commodity-based operation based at least in part on an analysis of the machine learning model, the at least one agricultural operation, and the risk threshold occurs. For example, the at least one prediction, estimate, or recommendation may include, but is not limited to a predicted crop yield, a predicted risk metric (e.g., a predicted value at risk), or a predicted revenue for the commodity-based operation included in the user selection. In embodiments, the at least one prediction, estimate, or recommendation may be determined and generated by the recommendation engine 106. As described above, the recommendation engine 106 may generate a prediction, estimate, or recommendation based in part on an analysis of the machine learning model, the at least one commodity-based operation, and the risk threshold.

At step 312, causing display of at least one of the predicted crop yield, the risk metric (e.g., a predicted value at risk), or the expected revenue for the at least one commodity-based operation occurs. For example, a generated prediction, estimate, or recommendation may be displayed to a user via the display of a computing device, such as through a dashboard as described below. In embodiments, the generated prediction, estimate, or recommendation may be outputted as an interactive element, wherein the user may select the interactive element to perform one or more additional actions. For example, the interactive element may be configured to expand or generate additional information associated with the prediction, estimate, or recommendation. For example, the interactive element may be configured to provide the user an interface for providing adjustments or additional information. In embodiments, in response to receiving adjustments or additional information from the user, an updated prediction, estimate, or recommendation may be generated and displayed using the steps outlined above.

In embodiments, method 300 comprises optional and/or additional steps of automatically providing updated predictions, estimates, or recommendations to the user. As described above, the data collection module 102 may continually obtain updated information for the data inputs 108, with the data processing unit 104 processing the updated information for updating the machine learning models. Accordingly, embodiments of the present disclosure provide for generating and displaying updated predictions, estimates, recommendations to a user based on updated data inputs 108 and/or updated machine learning models responding to the receipt of updated data inputs 108. For example, after a user selection is received and after at least one prediction, estimate, or recommendation has been generated and provided to the user, the one of the collected data inputs 108 may be updated with information such as an increase in market price or a change in an anticipated yield that would alter the previously generated prediction, estimate, or recommendation (negatively or positively). Accordingly, in embodiments, the recommendation engine 106, upon determining that such a change has occurred, automatically sends an updated prediction, estimate, or recommendation to the user. In this regard, a user is not required to constantly fine tune or resubmit inquiries, selections, or requests, and rather, can automatically be provided with updated predictions, estimates, or recommendations.

In embodiments, method 300 includes optional and/or additional steps of processing the collected historical data or real-time data to generate one or more spatial risk assessments at a sub-field resolution of 10 square meters or finer, wherein said processing includes decomposing financial risk into at least three distinct components comprising production risk, futures price risk, and basis risk. In embodiments, method 300 includes an optional and/or additional step of quantifying financial risk in precise monetary values for each of the at least three distinct risk components, wherein said quantifying includes calculating dollar-value exposures for production risk, futures price risk, and basis risk separately to enable targeted risk mitigation strategies.

It will be appreciated that while the above-described process described in method 300 refers to a method of predicting asset yield, risk metrics (e.g., a predicted value at risk), or the expected revenue of the at least one commodity-based operation, the teachings of the method may be applied to other estimates, predictions, or recommendations, including for example, seeding rates, seeding locations, insurance, hedging, seed varietals, livestock grazing locations, among other actions that may be associated with an agricultural operation. Furthermore, as described herein, embodiments of the present disclosure are directed to parsing commodity-based operations into a plurality of zones. Accordingly, embodiments of method 300 may be utilized for individual zones of the plurality of zones.

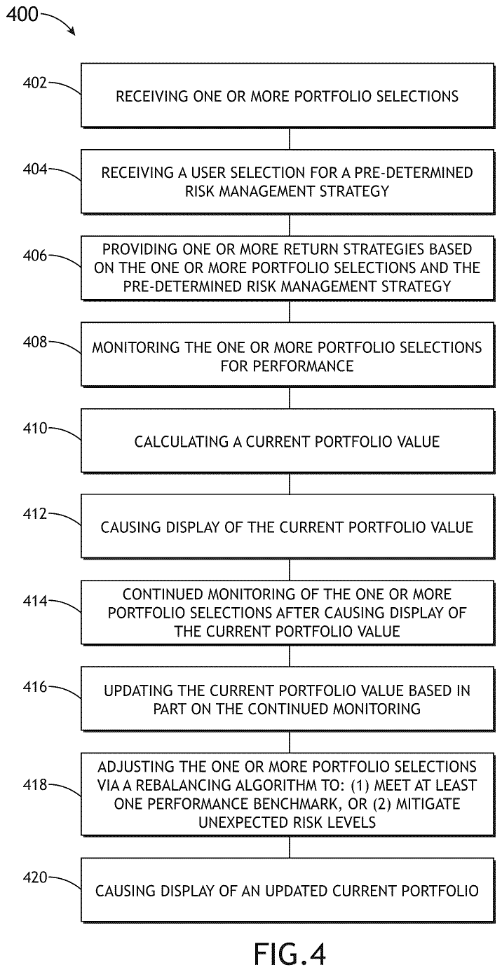

FIG. 4 illustrates a method for receiving user selections relating to dynamic portfolio strategies, generally referenced by reference numeral 400. In embodiments, method 400 may be performed via the one or more processors 134 executing computer readable instructions stored on the one or more memory devices 136.

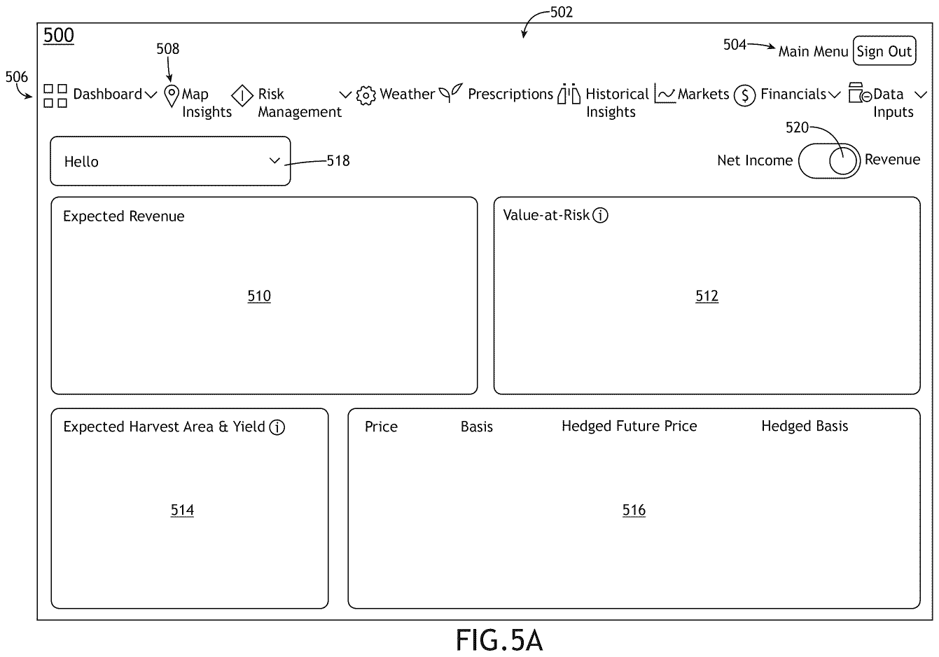

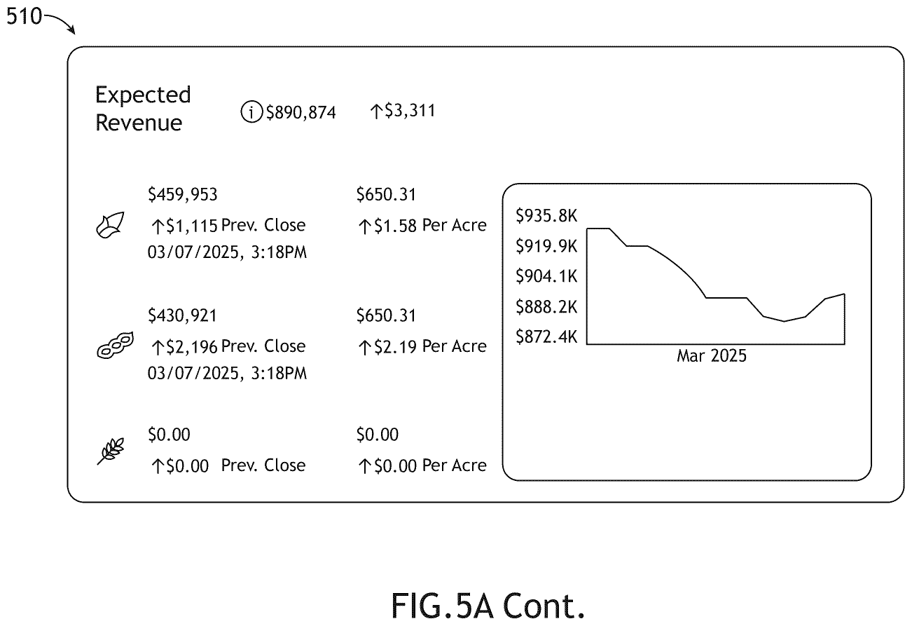

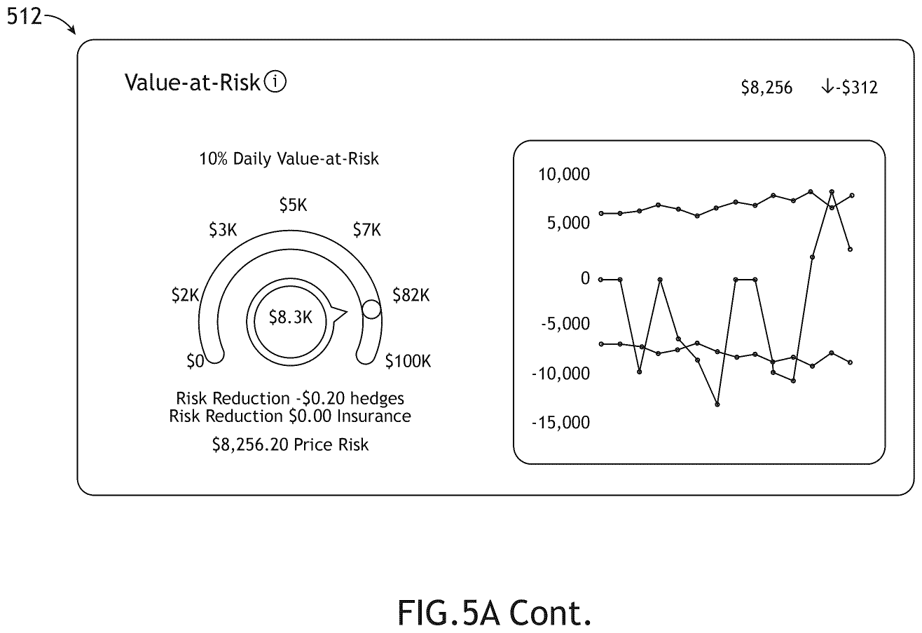

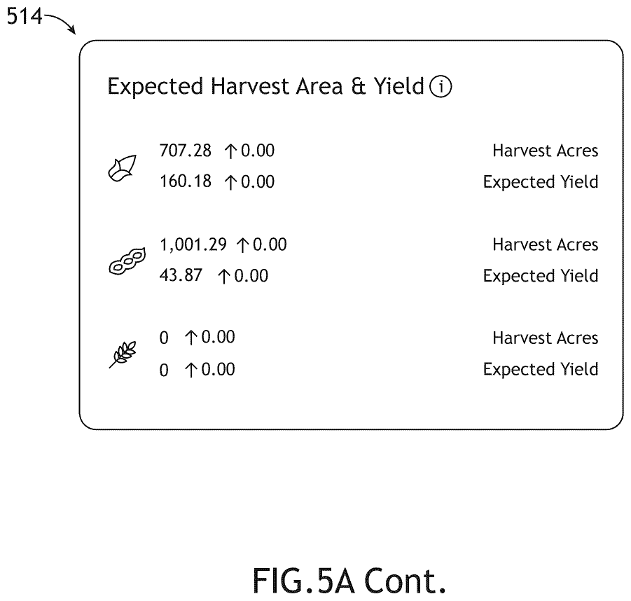

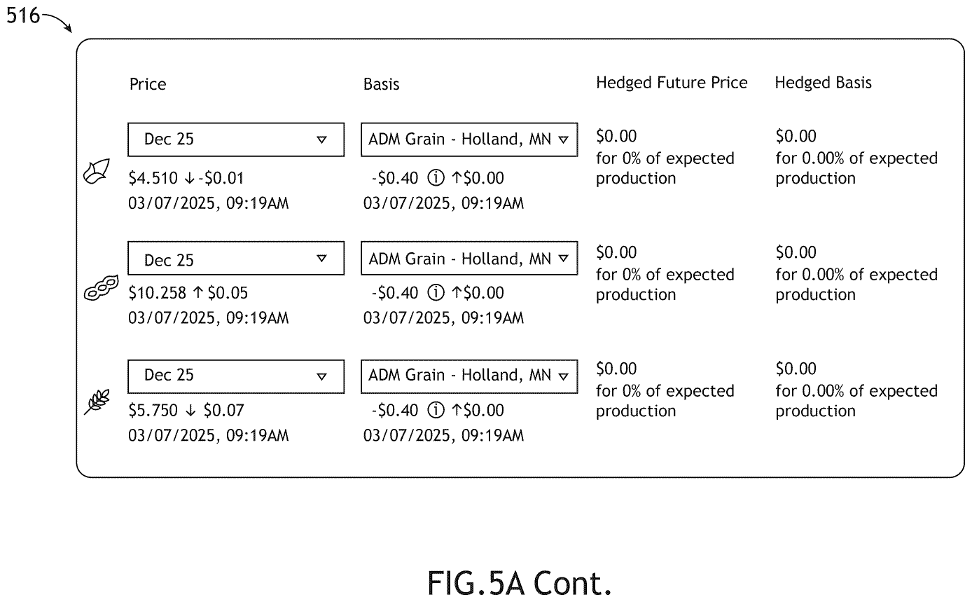

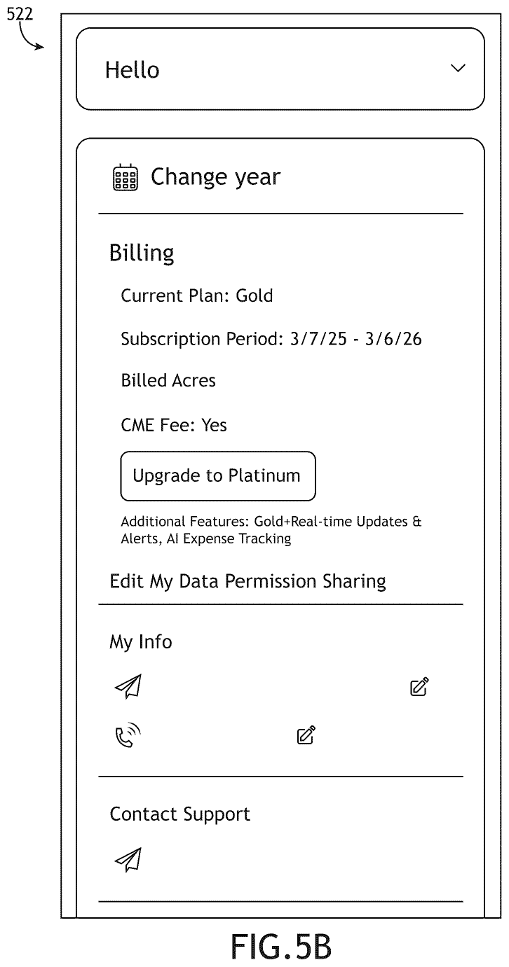

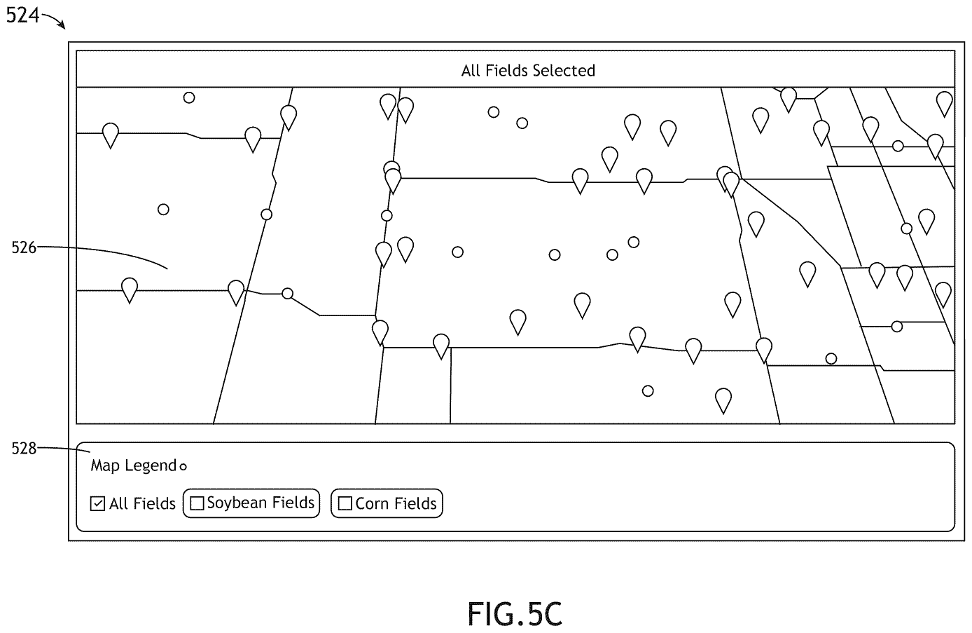

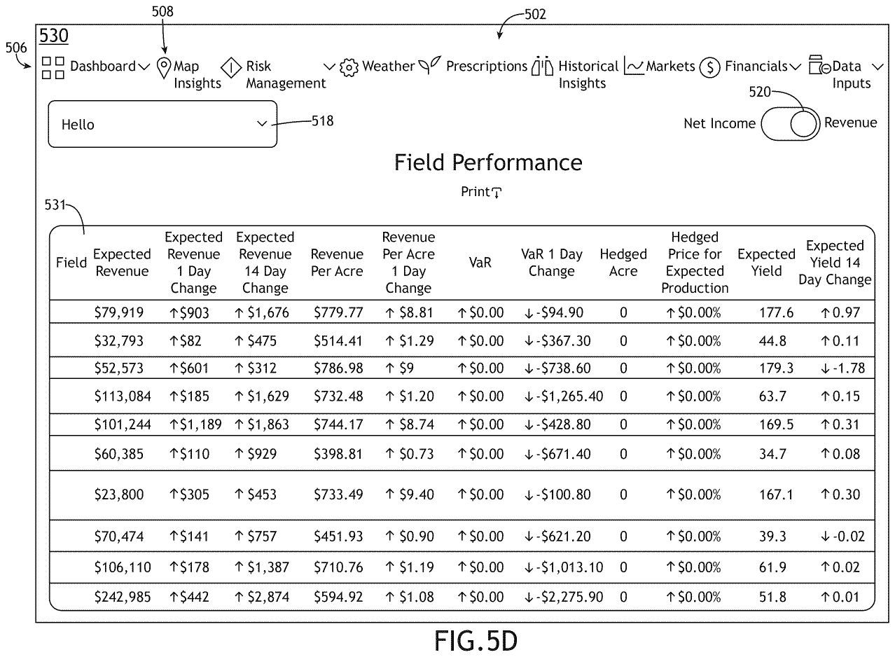

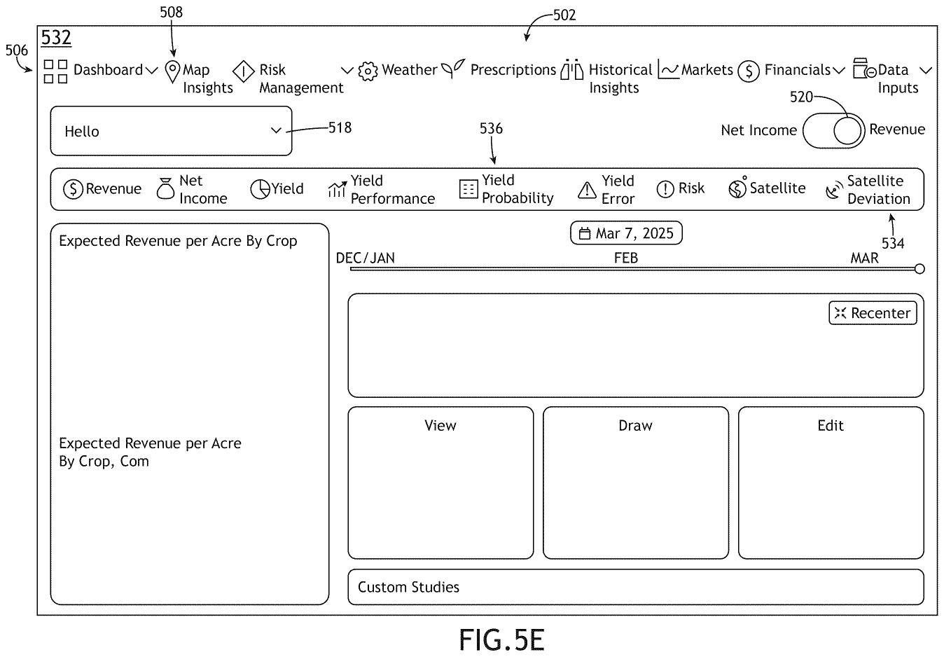

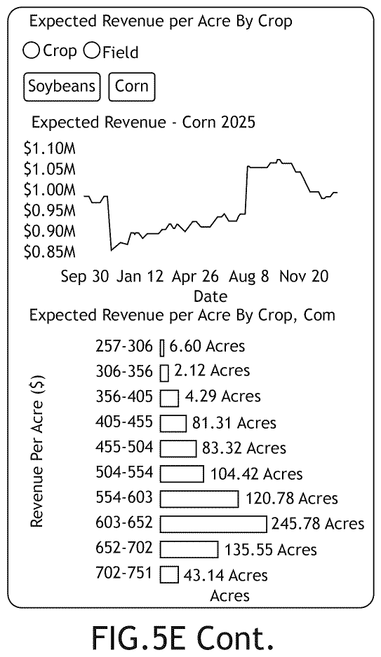

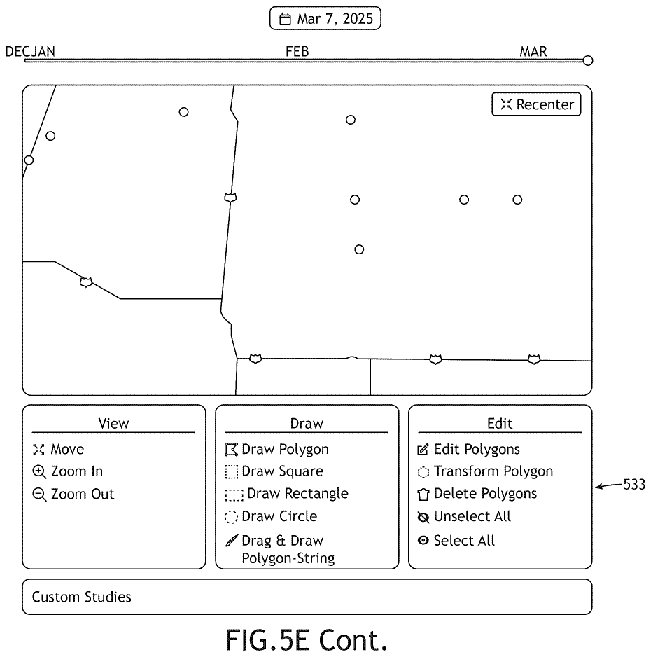

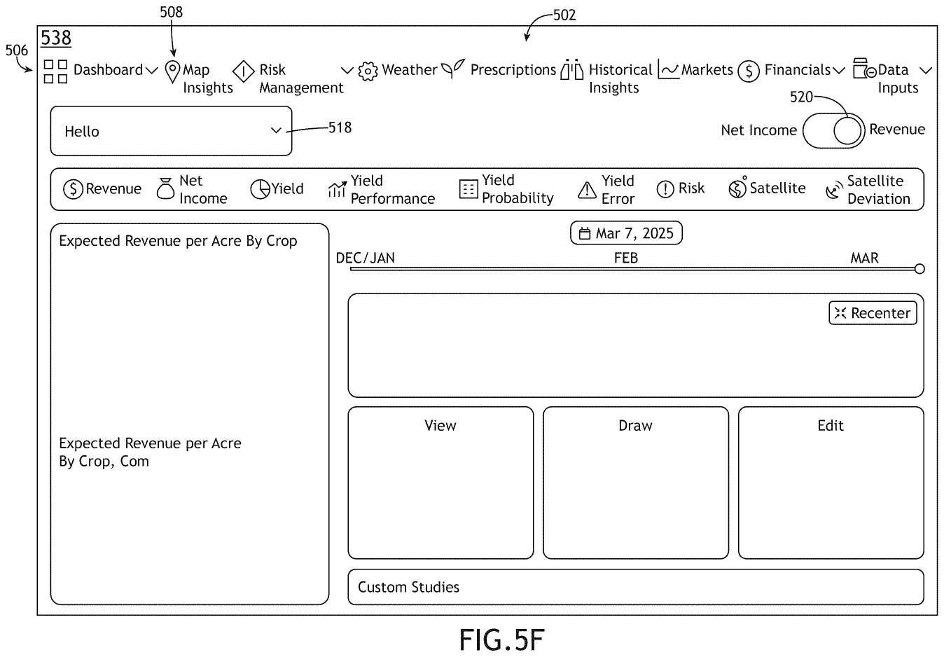

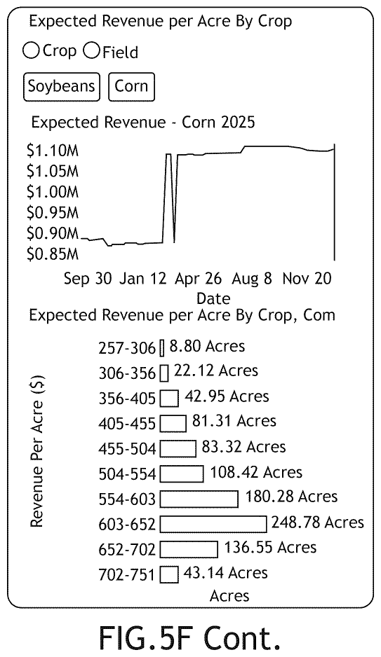

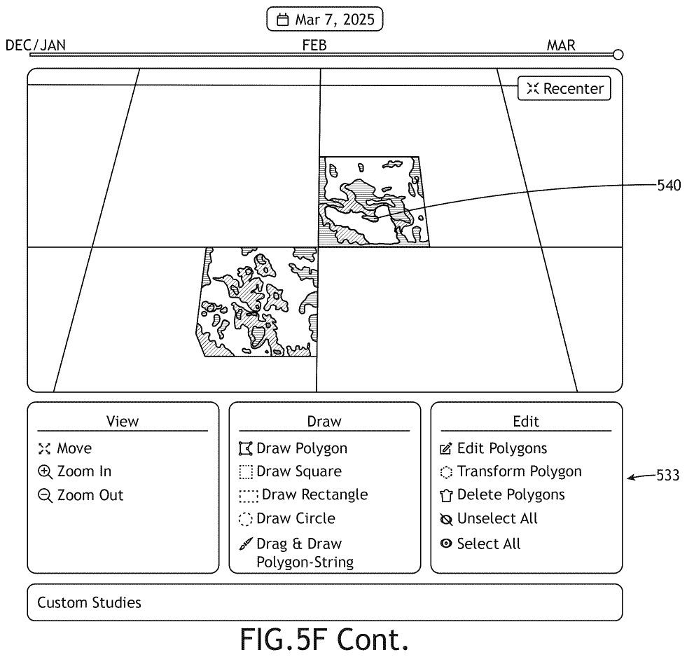

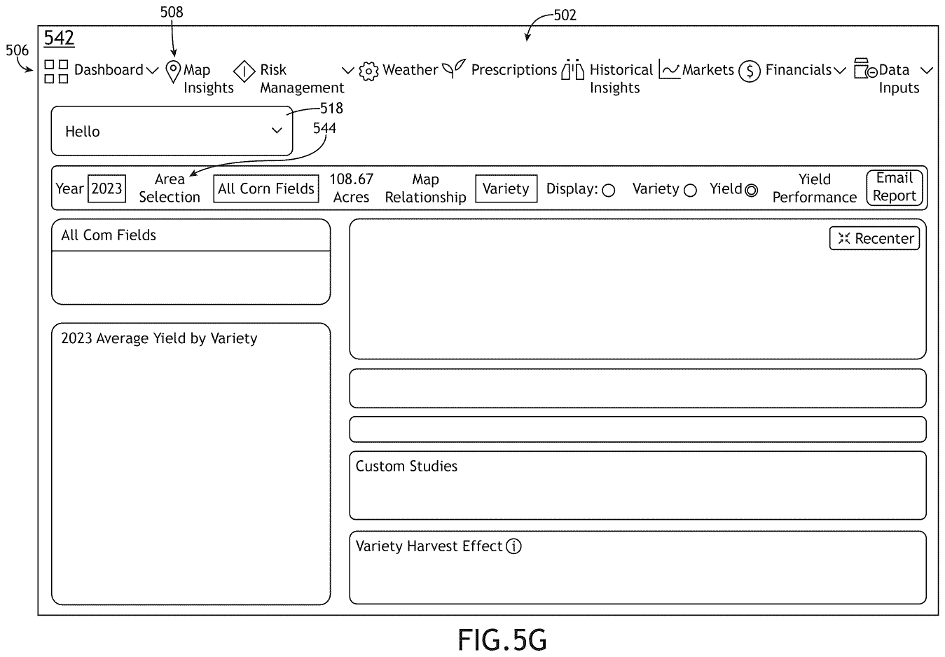

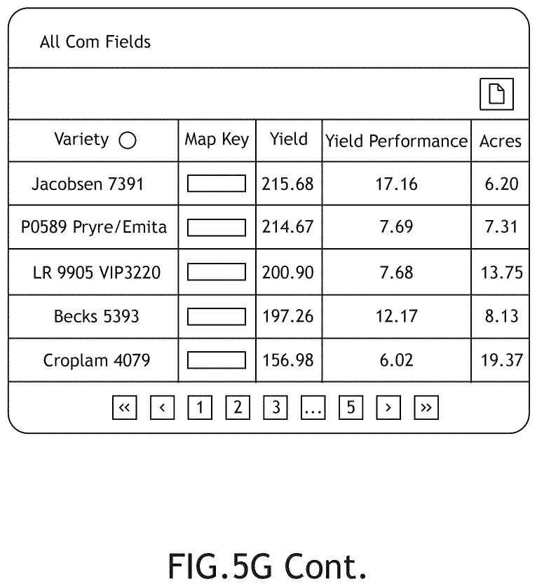

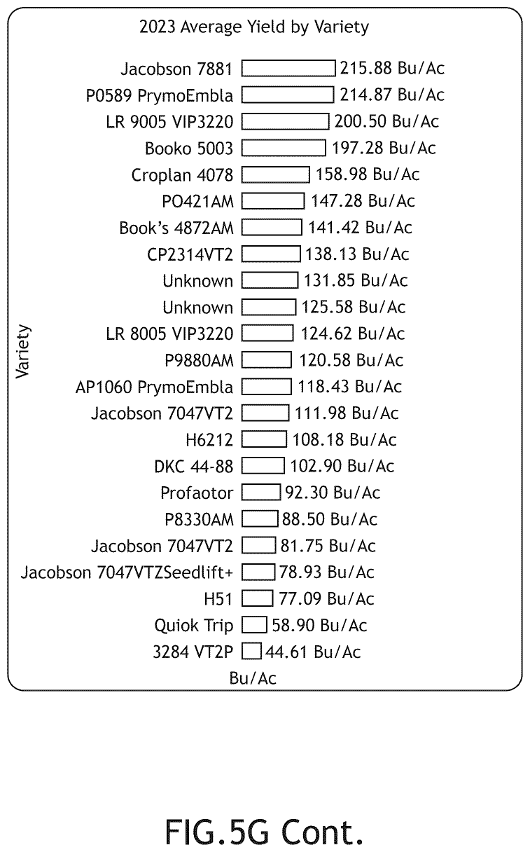

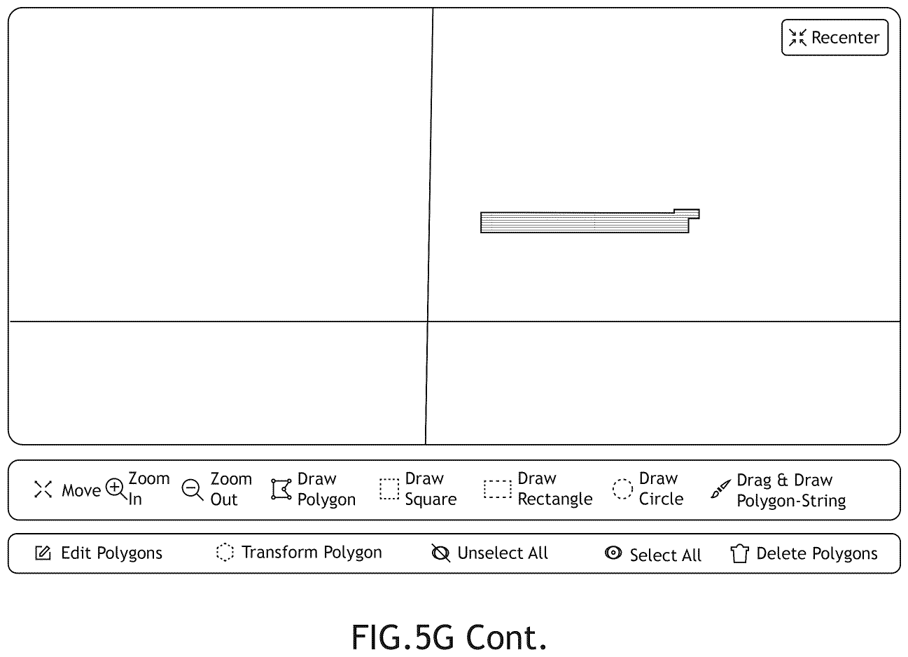

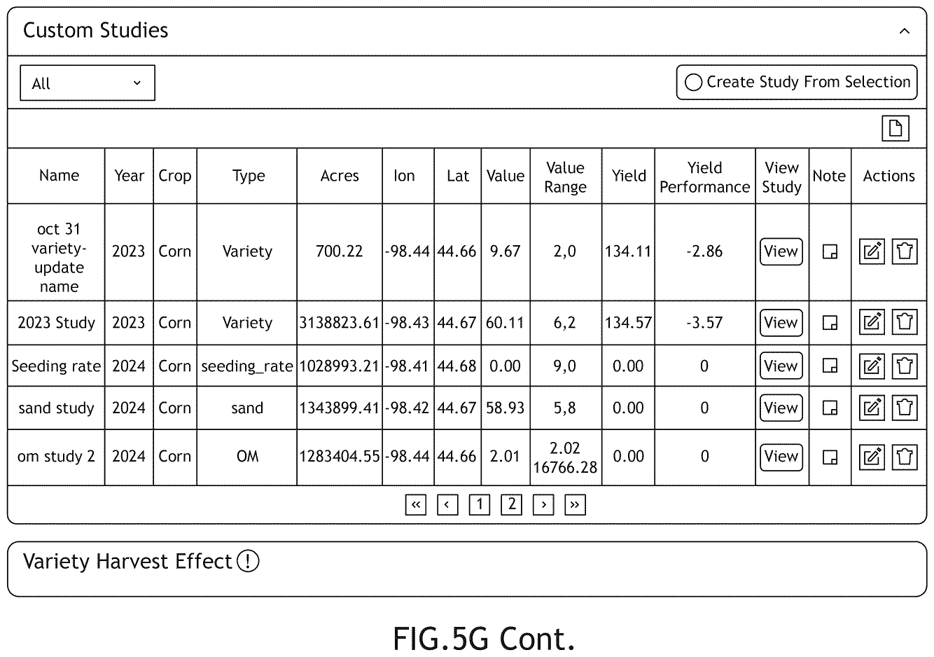

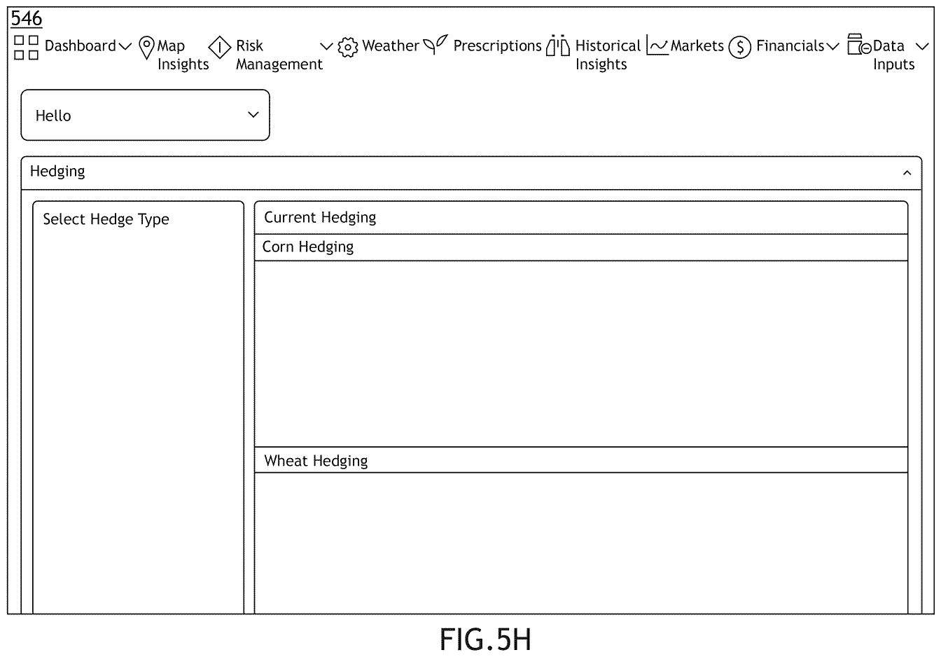

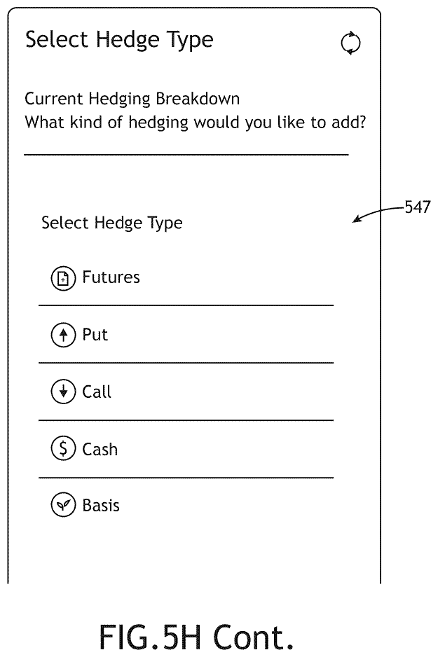

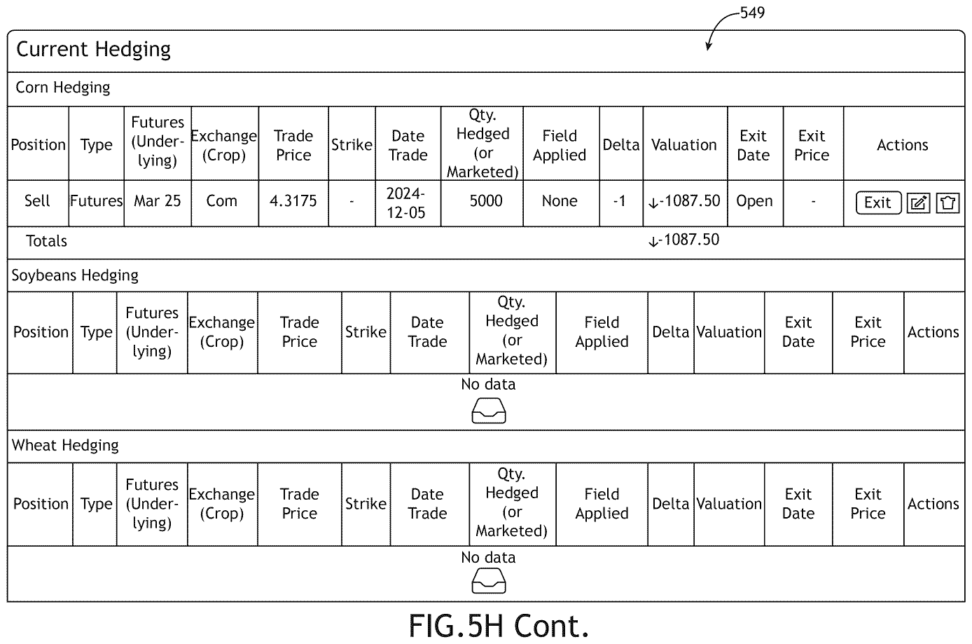

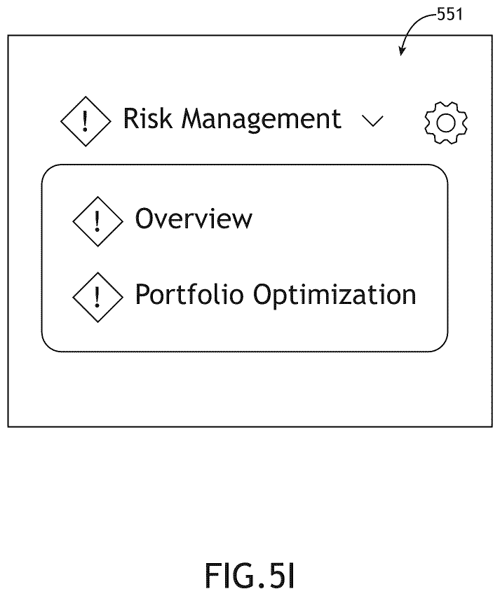

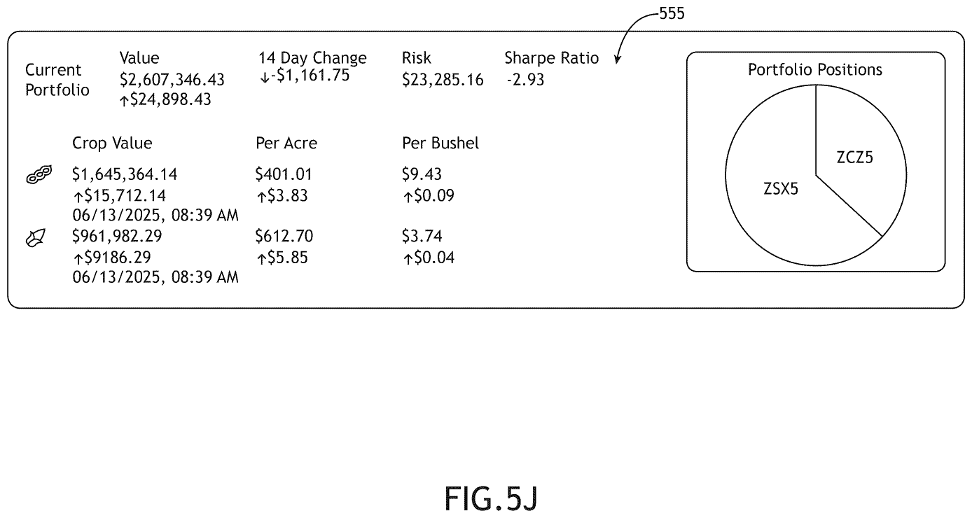

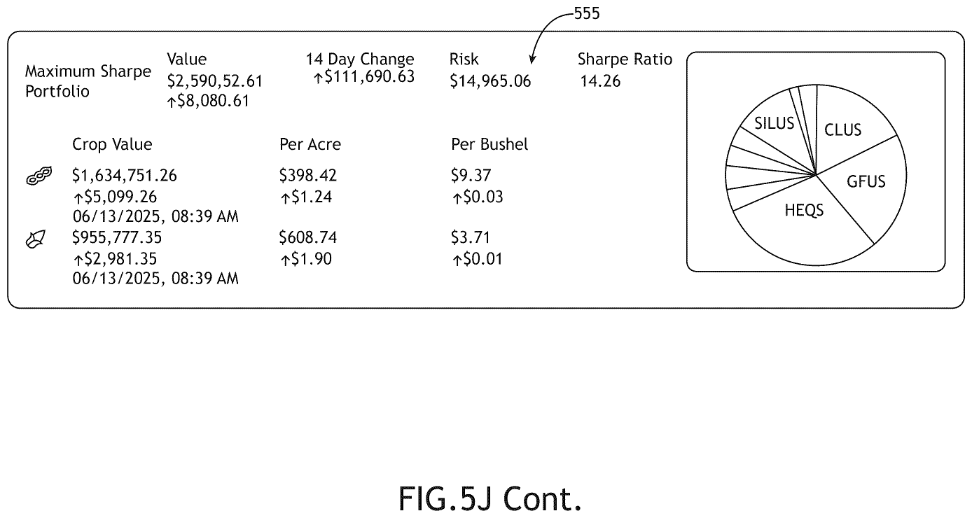

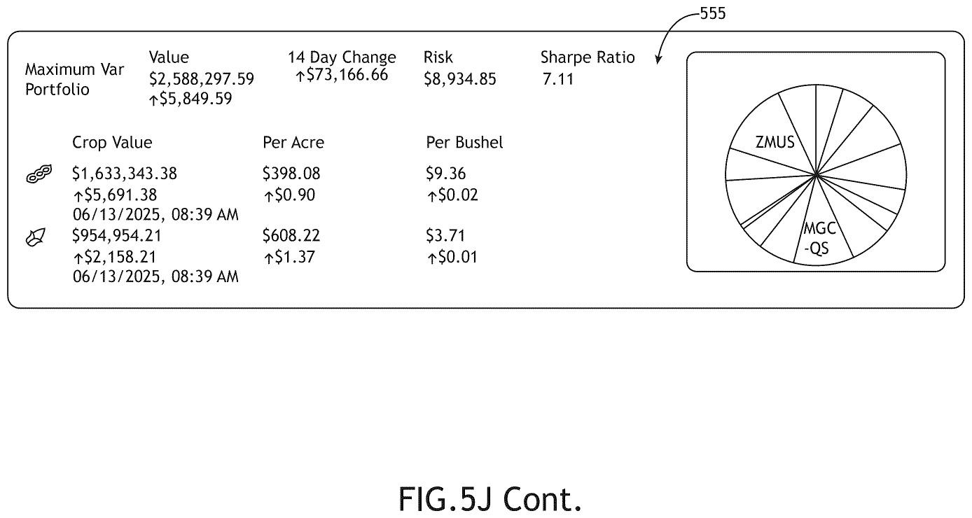

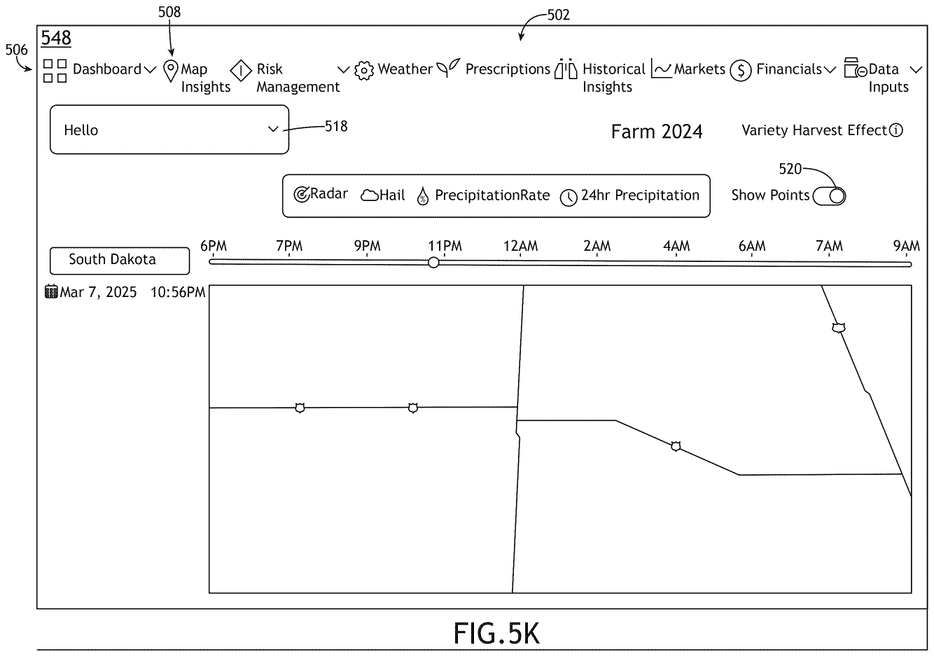

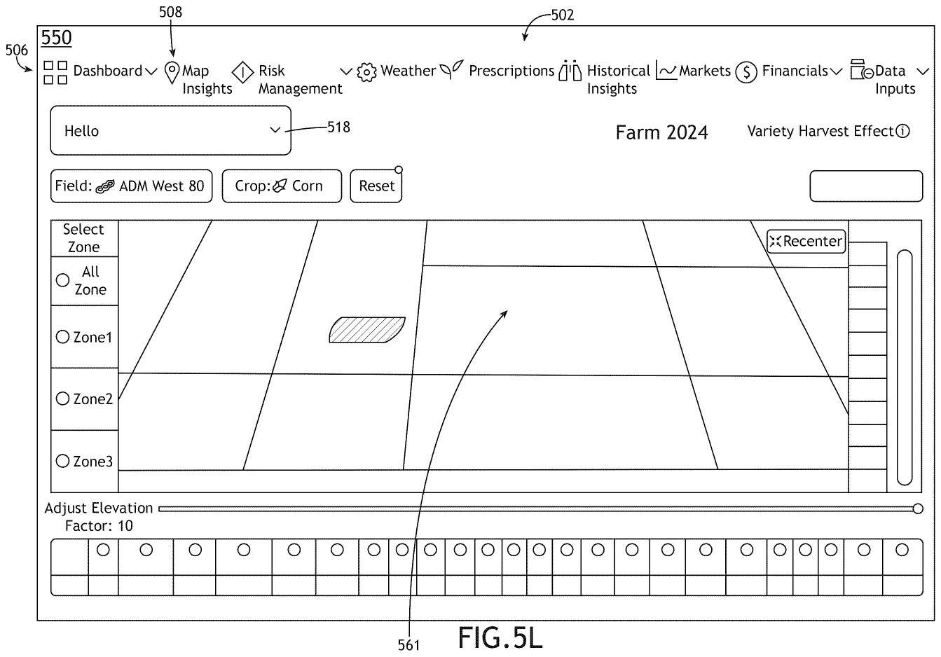

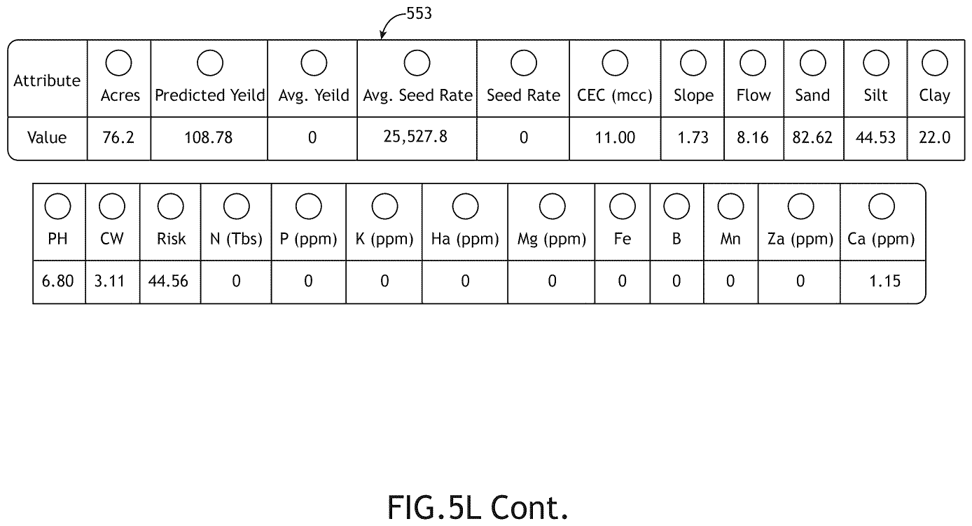

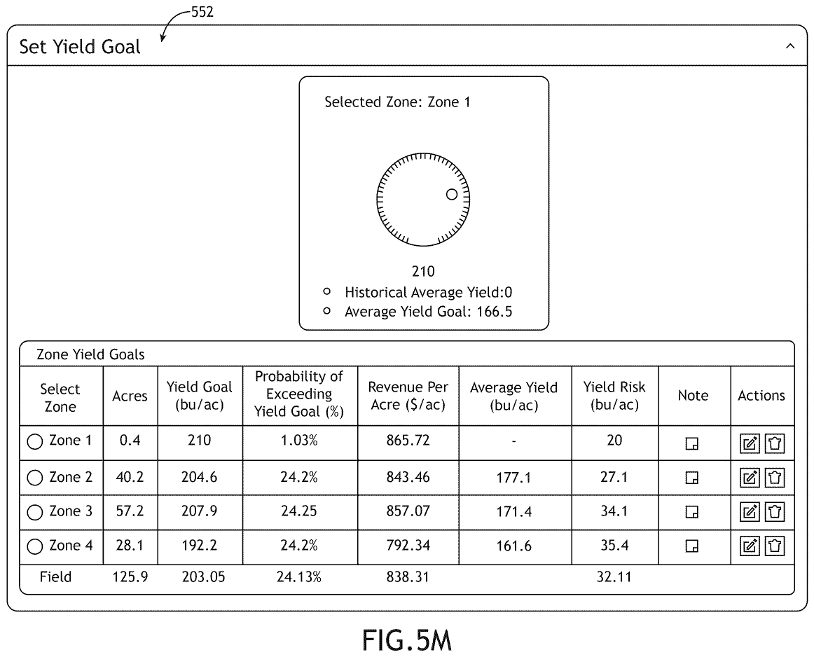

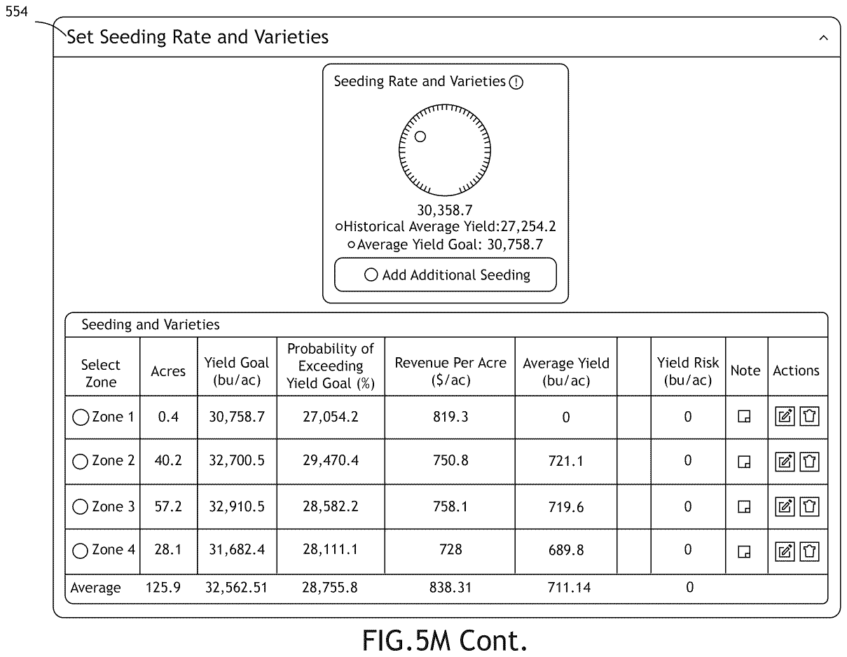

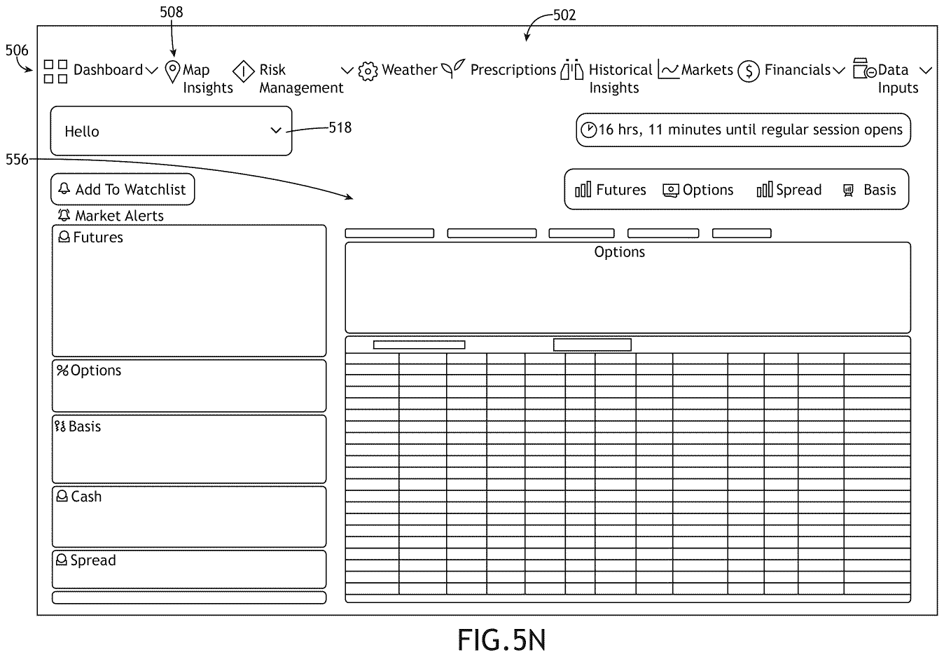

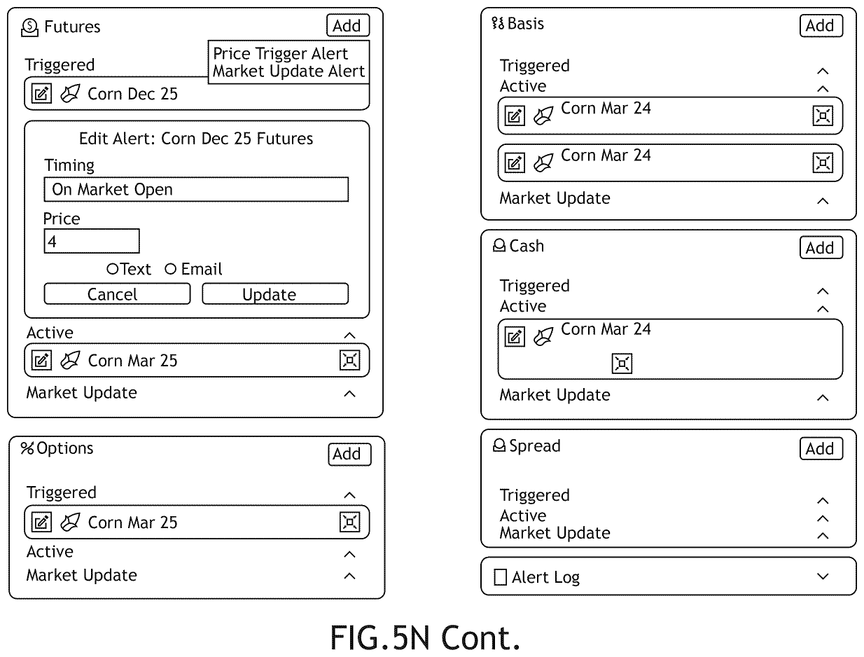

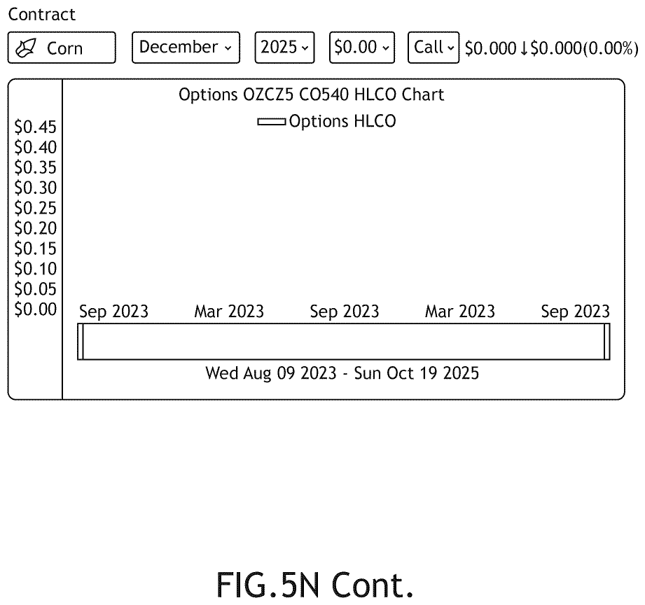

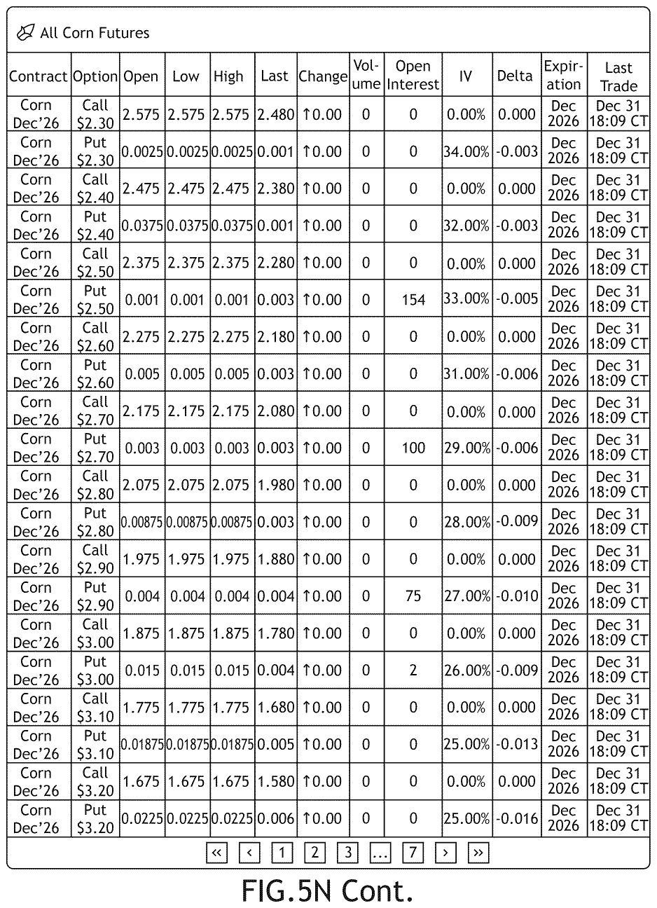

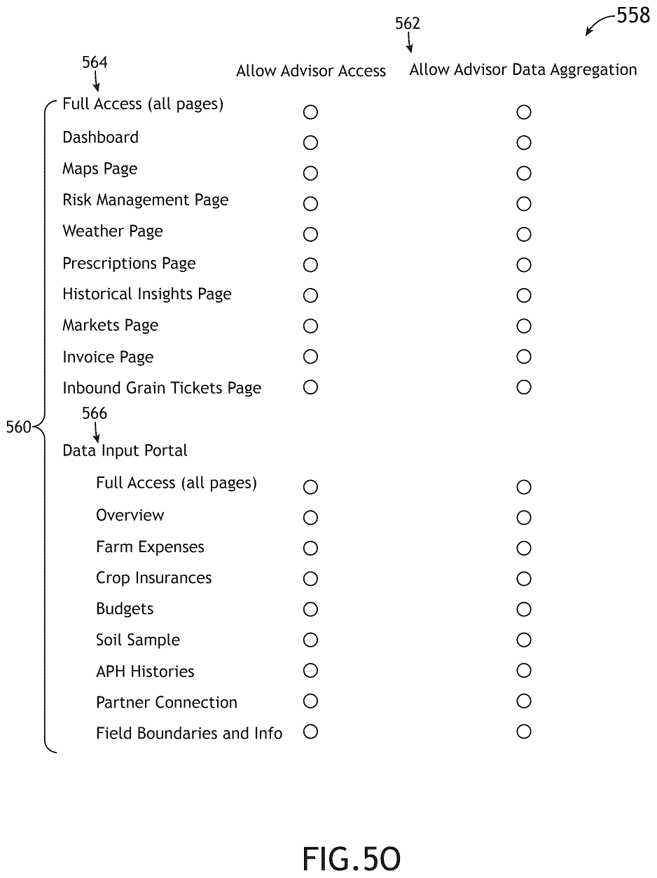

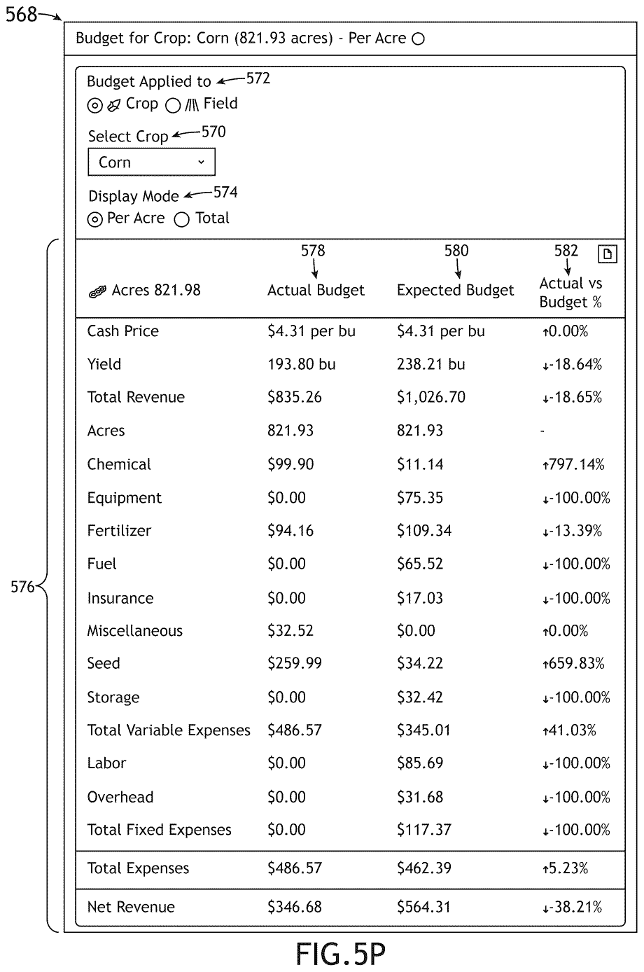

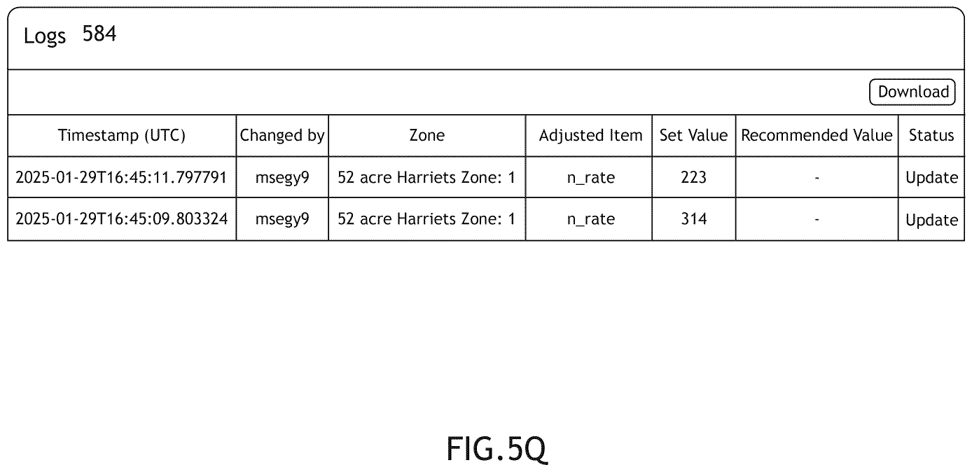

At a first step 402, receiving one or more portfolio selections from a user occurs. The one or more user selections may be entered through a dashboard for example, including the illustrative dashboard as referenced in FIGS. 5A-P. In embodiments, the one or more portfolio selections may be for commodities, such as corn or other futures commodities. In embodiments, the one or more portfolio selections may be for a single commodity. In embodiments, the one or more portfolio selections may comprise a plurality of commodities. The one or more portfolio selections can be analyzed by the recommendation engine 106 for generating a recommendation, prediction, or estimate. In embodiments, current portfolio values may be displayed as equivalent commodity prices.

In embodiments, step 402 may optionally or further include additional user selections or inputs. For example, at step 402 the user may provide performance benchmarks, such as a viable return on investment for the portfolio or other benchmarks (e.g., revenue-based goals, environmental goals, goals tied to fields or sub-fields, contractual requirements, or other metric based benchmarks) setting acceptable performance tolerances of the portfolio. For example, at step 402, the user may provide information associated with an agricultural operation, such as revenue, budgets, or profits.

At step 404, which in some embodiments may be conducted simultaneously or concurrently with step 402, receiving a user selection for a pre-determined risk management strategy occurs. In embodiments, a user can hedge commodities within the selected portfolios through a diversified range of instruments spanning low risk assets (e.g., treasury bonds) to higher return potential investments (e.g., equities, alternative assets, exchange-traded funds, or structured products). For example, the user selection for the pre-determined risk management strategy may be for a pre-determined risk management strategy determined by the recommendation engine 106. In embodiments, the user may select from a plurality of different risk management strategies in selecting a strategy aligned with the user's preferences. In embodiments, the user may select a single risk management strategy that covers the entire portfolio selection. In embodiments, the user may select a plurality of risk management strategies that cover portions of the portfolio selection.

In embodiments, recommendations for selecting a return strategy may be provided to the user. For example, as described above, the data processing unit 104 may analyze the data inputs 108 to determine correlations, trends and/or patterns, with the recommendation engine 106 generating estimates, predictions, or recommendations for one or more commodities based on the determined correlations, trends and/or patterns. As such, the recommendation engine 106 can further provide recommendations relating to risk management strategies. For example, if the recommendation engine 106 determines a high likelihood that a commodity like corn is anticipated to have a low yield resulting in a lower-than-average revenue for the year, the recommendation engine 106 may provide a recommendation to the user to hedge the commodity through a low-risk management strategy. By way of another example, if the recommendation engine 106 determines a high likelihood that a commodity like corn is anticipated to have a high yield resulting in a higher-than-average revenue for the year, the recommendation engine 106 may provide a recommendation to the user to hedge the commodity through a more high-risk management strategy with greater return potential.

For example, the user may select a low risk, low return risk management strategy for a selected portfolio. This strategy would involve conversion selling futures and purchasing treasury bonds.

By way of another example, the user may select a low risk, medium return strategy for a selected portfolio. This strategy would involve a more diversified portfolio including bonds, equities, metals, and/or other commodities based on real-time market data.

By way of another example, the user may select a medium risk, high potential return strategy for a selected portfolio. This strategy would involve a strategy of more equities and alternative, high-return assets.

At step 406, providing one or more return strategies based on the one or more portfolio selections and the pre-determined risk management strategy occurs. In embodiments, the monitoring may be performed by the data collection module 102 updating data inputs 108, including for example market price data 116. In embodiments, real-time market prices may be provided to the user via dashboard 502.

At step 408, monitoring the one or more portfolio selections for performance occurs. During step 408, monitoring of markets or other assets corresponding to the one or more portfolio selection occurs. In embodiments, step 408 is conducted continuously by system 100, such that up-to-date, real-time information is utilized by system 100. As described above, embodiments of system 100 may be communicatively coupled to market price data 116, which may include one or more markets. Accordingly, a real-time value of the one or more portfolio selections can be ascertained during step 408.

At step 410, calculating a current portfolio value occurs. In embodiments, the system 100 calculates a current portfolio value based on the commodities of the one or more user portfolios and the performance of the portfolio determined during monitoring, including for example, the current commodity price. In embodiments, the system 100 can further calculate the current portfolio value based on an expected commodity price range. As described above, the data processing unit 104 analyzes and processes the data inputs 108 to determine patterns and correlate trends. The expected commodity price range may be an expected value range of the commodities of the portfolio based on an analysis of one or more data inputs associated with the portfolio, including for example, data inputs 108 as described above.

At step 412, causing display of the current portfolio value occurs. In embodiments, the system 100 may cause the display of the current portfolio value in a window of a dynamic dashboard, including for example, the dashboard 502 as described below with reference to FIGS. 5A-P. In embodiments, step 412 may further display other determinations calculated by the system. For example, if the calculated current portfolio value is lower or higher than a previously determined and displayed predicted portfolio value, an explanation of why the calculated current portfolio value is different than the predicted portfolio value may be displayed to the user. Furthermore, the system 100 may also display additional or further calculated portfolio values associated with an unselected pre-determined risk management strategy. For example, the system 100 may display to the user what the calculated current portfolio value would have been if a different risk management strategy was selected. This in turn may provide the user with guidance in making subsequent selections.

At step 414, continued monitoring of the one or more portfolio selections after causing display of the current portfolio value occurs. For example, as the commodity prices change in response to market dynamics, the system 100 can update the calculated current portfolio value.

At step 416, updating the current portfolio value based in part on the continued monitoring occurs. For example, following the monitoring of the selected portfolio, the system 100 can periodically update the current portfolio value. In embodiments, the updated current portfolio value may be displayed in one or more generated panes of a dynamic dashboard, including for example, the dashboard 502 as described below with reference to FIGS. 5A-P. For example, in embodiments, the dashboard may display only the most recent calculated current portfolio value. In embodiments, the dashboard may optionally display a plurality of calculated current portfolio values, providing the user with a progression of the portfolio. In embodiments, additional information, such as graphs or charts, may also be determined, generated, and presented to the user via the dashboard. for example, graphs may be utilized to show the user trends of how the selected portfolio is performing over a period of time.

At step 418, adjusting the one or more portfolio selections via a rebalancing algorithm to: (1) meet at least one performance benchmark, or (2) mitigate unexpected risk levels that occur. For example, in embodiments, and as described above, the user may select certain performance benchmarks for the portfolio. Furthermore, the user may also grant certain permissions to the system, wherein the system 100 can automatically adjust the portfolio. Accordingly, when the system 100 determines that a performance benchmark has been met, or that an unexpected risk level has been reached, warnings or notifications may be generated and displayed to the user with a recommended action (e.g., buy or sell a commodity) in response to the determination. In embodiments, the warning or notification may be caused to be displayed on a display device, including for example, a display device associated with computing hardware a user is accessing the client portal 202. In embodiments, the warning or notification may be caused to be transmitted to an external computing device, e.g., via phone call, text, email, instant messaging, push, API, etc.) In further embodiments, the system 100 may automatically perform the recommended action without a user interaction. For example, the system 100 may automatically buy or sell stocks, commodities, or other aspects of the one or more portfolio selections. In embodiments, the user may set certain tolerances or threshold for the automatic actions taken by system 100. For example, a user may set a 10% threshold, where the system 100 can take automatic actions that affect 10% or less of the current portfolio value absent user authorization or approval. Furthermore, the system 100 may be configured to automatically adjust current portfolio values based on projected commodity prices at hedge contract expiration dates, wherein said projected commodity prices are calculated using at least one of: (1) statistical analysis of historical price distributions during similar calendar periods; (2) forward curve analysis from traded futures contracts; (3) econometric models incorporating supply and demand factors; and/or (4) ensemble predictions from multiple forecasting methodologies, enabling portfolio value projections that account for price uncertainty across different potential market scenarios and to adjust the current portfolio value to meet performance benchmarks or to mitigate unexpected risk levels.

At step 420, causing display of an updated current portfolio occurs. For example, the updated current portfolio value may replace the previously generated and displayed current portfolio value on dashboard 502. In embodiments, steps 418 and steps 416 may be performed simultaneously.

Turning now to FIGS. 5A-P, depictions of an illustrative user interface according to embodiments of the present disclosure is depicted, referred to generally with reference numeral 500. It should be understood that the depictions of the user interface 500 as depicted in FIGS. 5A-P are intended to be illustrative and not limiting. As generally illustrated in FIGS. 5A-P, embodiments of user interface 500 includes an interactive dashboard 502 comprising a plurality of windows or panes, adapted for displaying information to an end user, including for example, predictions, estimates, recommendations, real-time values, graphs, charts, among other information. Furthermore, the dashboard 502 further provides interactive elements, such as selectable icons, drop-down menus, navigation tools, or other input tools, allowing the user to generate additional panes, navigate to different tabs, or to enter information into the dashboard 502.

In embodiments, the dashboard 502 receives continuous updates, such as through WebSocket connections, ensuring the visualization of the latest farm revenue and yield data. For example, Webhooks are utilized for real-time updates, providing users with current agricultural economic indicators. Furthermore, Hooks such as useFarmRevenueData and useFarmYield pull financial and yield data dynamically, facilitating up-to-date calculations on financial metrics. As described herein, separate visual cards on one or more generated panes (ExpectedRevenueCard, ExpectedAreaAndYieldCard) can display expected revenue and area yield metrics. These components are presented with intuitive icons (CropIcon) and fluctuation indicators (Fluctuation) that highlight financial changes over time. For example, a ValueAtRiskCard component exhibits Value-at-Risk data using charts (VARChart, VAR14ChangeChart) for visualizing financial risk segmented into different financial risk categories, such as production financial risk, futures risk, basis risk, risk based on decomposition, and/or crop insurance/marketing mitigation. This feature allows users to assess potential financial losses and identify risk reduction strategies through hedges and insurance. Further, embedded interactive charts provide detailed insight into financial metrics, enabling users to explore specific areas of interest, derive risk mitigation measures, and observe the impact of financial decisions in real-time. Additionally, the dashboard 502 supplies tooltips and dynamic labels to guide user navigation, offering detailed explanations of financial terms and metrics, thus educating users on the implications of revenue and risk figures. For example, the system 100 may be configured for quantifying financial risk at field-level and sub-field resolution while enabling interactive risk analysis at a spatial resolution of 10 square meters or finer, providing granular insights for targeted agricultural risk management decisions.

Referring to FIG. 5A, the dashboard 502 comprises a set up object 504. In embodiments, the set-up object 504 may include options or selections allowing the user to log in to the user interface 500, change a user profile, or log out of the user interface 500. For example, the set-up object 504 may comprise an interactive icon, such as clickable button, which generates options for the user to log in, change the user profile, or log out of the user interface 500.

In embodiments, the dashboard 502 comprises a navigation bar 506. In embodiments, the navigation bar 506 comprises a plurality of selectable icons, buttons, or other interactive icons 508 for the user to interact with, providing navigation and/or other generative actions to occur. For example, as described herein, the present disclosure provides for the processing of data inputs 108 and generating recommendations, predictions, estimates, and/or identification of real-time information. In embodiments and described herein, the dashboard 502 may be configured to selectively display the generated recommendations, predictions, estimates, or real-time data. To aid in presenting this information to the user, the dashboard 502 may be configured to be organized into tabs of organized or categorized information, which can be selectively generated and displayed. For example, in the illustrative embodiment depicted in FIG. 5A, the navigation bar 506 may comprise a plurality of interactive icons 508 corresponding to the following categories for a selected time period, (e.g., current year, selected prior year), a future time period (corresponding to predictions), a selected time range (including a mixture of previous time periods and future predictions and/or selecting a time range to aggregating data over an extended time range, thereby enabling long-term trend analysis), month range, or other selected time period): dashboard, map insights, risk management, weather, precipitation, historical insights, markets, financials, data inputs. For example, a dashboard interactive icon 508 may be selected to navigate the user to a home page of the dashboard 502 and/or to generate additional windows corresponding to an initial or home setting. By way of another example, a markets interactive icon 508 may navigate the user to a page of the dashboard 502 and/or to generate additional windows or panes that displays real-time market data corresponding to one or more financial markets (e.g., DOW Jones, S&P, etc.) or real-time values of selected commodities (i.e., stocks, mutual funds, bonds, etc.). In embodiments, the navigation bar 506 may be customizable, with a user being able to select what interactive icons 508 are included in the navigation bar 506.

FIG. 5A further depicts an illustrative embodiment of dashboard 502 with the dashboard interactive icon 508 having been previously selected, either by automation or by a prior user selection. As depicted, the dashboard 502 may comprise a plurality of generated panes, graphics, or windows configured to display information, such as real-time valuations, predicted revenue streams, calculated value-at risk, etc. For example, in the illustrative embodiment, a homepage or default display of the dashboard may include a plurality of generated panes, including an expected revenue pane 510, a value at risk pane 512, and an expected harvest area & yield pane 514. As further depicted, the dashboard 502 may further comprise consistent or permanent graphics, icons, or generated display objects, which may persist on the dashboard 502 even when a user selects different icons to generate new panes or to move to different categories or pages. For example, the dashboard 502 may include an account object 518 and/or a revenue toggle 520. In embodiments, the account object 518 may be a selectable, interactive object displayed on the dashboard 502 that upon a user interaction, generates a pane or expanded display object that displays information associated with the user's profile or account. In embodiments, and as described here, certain users may be super users and/or administrators with increased privileges, and accordingly, the dashboard 502 may be configured with sharing features, allowing additional users to view the user's dashboard 502. In embodiments, the revenue toggle 520 may be an object configured to toggle information displayed to the user in the dashboard. For example, upon selection, the revenue toggle 520 can change from displaying a user's predicted or actual revenue to a user's predicted or actual net income.

As described above, one of the generated and displayed panes in the dashboard may be an expected revenue pane 510. The expected revenue pane 510 may be adapted and configured for displaying a total expected revenue associated with the user's agricultural operation, including all commodities associated with the agricultural operation or other income generators, such as passive income, using the methods of the present disclosure as described herein. In embodiments, the expected revenue pane 510 may display textual information, such as a current, real-time expected revenue. Further, the expected revenue pane 510 may comprise a breakdown of the expected revenue, such as expected revenue per commodity, (e.g., expected revenue for corn, soybeans, or wheat). Even further, the expected revenue pane 510 may further comprise graphical elements, such as arrows indicated net positive or net negative revenue, trends over a period of time, or graphs depicting the change in an expected revenue over a period of time (e.g., weekly, monthly, quarterly, annually, etc.)

In embodiments, the value-at-risk pane 512 may be configured to depict an expected value at risk that is determined using the methodology as described herein. In embodiments, the value-at-risk pane 512 may depict textual and/or graphical information providing the determined value-at-risk and/or additional information associated with the determined value-at-risk. For example, the value-at-risk pane 512 may include textual information, such as what the determined value-at-risk is using text, as described herein, the system 100 may be configured for quantifying financial risk in precise monetary values across multiple components (e.g., futures, basis, production variables by resource) thereby providing unique breakdown that enables producers to strategically manage risk through targeted mitigation strategies. Additionally, the pane 512 displays the financial risk in monetary terms that risk mitigation strategies have reduced financial risk (e.g., futures and options strategies, insurance coverage, alternative asset allocation, or other executed strategies), thereby enabling producers to evaluate mitigation effectiveness and remaining risk exposure for informed portfolio management decisions.

In embodiments, the expected harvest area & yield pane 514 may be configured to display the estimated or predicted harvest for commodities associated with an agricultural operation selected by a user and/or associated with a user's investment portfolio. As described above, the methodology of the present disclosure provides for the estimating or predicting of agricultural yields using the data inputs 108. The predicted or estimated agricultural yields may be displayed in the expected harvest area & yield pane 514. In embodiments, the estimated harvest area and yields may be separated out by agricultural commodities (e.g., corn, soybeans, wheat). Further, the estimated harvest area may be provided by expected harvest in acres and/or expected harvest by yield. In embodiments, additional information may be provided to the user, such as indicators providing an indication of an increase or decrease in expected harvest area and/or yield.

In embodiments, the price and hedge pane 516 may be configured to display the real-time price or valuation of one or more commodities, stocks, or other dynamically changing economic goods. As described above, the methodology of the present disclosure provides for the estimating or predicting of the price and/or basis for commodities using the data inputs 108. As further described above, the methodology of the present disclosure provides for determining recommended hedging and managing commodities based on the analysis of the data inputs 108. Through the price and hedge pane 516, the current real-time valuation baseline of selected commodities, stocks, or other financial indicators is displayed.

In embodiments, and as described above, a user may interact with different selectable objects to generate new panes and/or to navigate to other tabs or windows of the dashboard 502. FIG. 5B an illustrative user interface in accordance with some embodiments of the present disclosure depicts a generated account pane 522, which may be generated in response to the user interacting with account object 518. In embodiments, the account pane 522 provides a user with information about the user's account, such as billing information, subscription information, billed acres, fees, user information (contact information, location, etc.), customer support information, etc. In embodiments, the account pane 522 may further comprise interactive objects for the user to select, including for example, interactive buttons to update the user's subscription level, update the user's account information, or to contact support.

As described above, a user may select from interactive icons 508 from the navigation bar 506 for generating new panes for display and/or for switching between different tabs. FIG. 5C depicts an illustrative embodiment of dashboard 502 after a field selection interactive icon 508 has been selected for displaying a field selection pane 524. In embodiments, the field selection pane 524 provides an interface for the user to select one or more fields that in turn, can be used by the system 100 in determining predicted yields, revenues, etc., in accordance with the present disclosure. In embodiments, the field selection pane 524 comprises a map portion 526, which may be an interactive and labelled satellite map depicting a geographic area, with one or more fields labelled with details. As described above, the methodology of the present disclosure provides for obtaining geographical, satellite, and field information for areas of land included in the data inputs 108. The processed data inputs 108 may be displayed to the user in the map portion 526, with the user being able to view and select one or more parcels of land. As further depicted, details about the parcels of land may be overlain over the satellite map. Further, the details may be assorted by icons, providing an indication of the type of crop or livestock the parcel of land is associated with. In some embodiments, the map portion 526 may include optional or additional integration capabilities for physical asset tracking. For example, and described above, embodiments of the system 100 may provide for coupling with sensors, telematics, or other computing components of equipment or infrastructure (e.g., GPS tags for grain bin locations, telematics equipment, field infrastructure, resource assets including building, structures, and production/storage facilities, etc.). Accordingly, through integration with on-site assets, the map portion 526 provides real-time and/or comprehensive visibility of operational resources across an enterprise. As further depicted, the field selection pane 524 may provide additional interactive icons or objects in map legend 528, allowing the user to filter the information included in the map portion 526. For example, the user may select a filter to show only corn fields in the map portion 526.

As described above, a user may select from interactive icons 508 from the navigation bar 506 for generating new panes for display and/or for switching between different tabs. FIG. 5D depicts an illustrative embodiment of dashboard 502 after a field performance interactive icon 508 has been selected for displaying a field performance pane 530. In embodiments, the field performance pane 530 displays information to the user directed to expected revenue, yield, or other performance metrics directed to one or more fields, which may be provided to the user via a table 531. In embodiments, the one or more fields selected by the user for tracking or predicting metrics may be further divided into sub-divisions or sub-fields, providing for more detailed tracking and prediction using the methods of the present disclosure. For example, a single field may be separated into one or more sub-portions measured out by geographically (e.g., ¼ acre, ½ acre, etc.). By way of another example, a single field may be separated into one or more sub-portions by way of crop or livestock type (e.g., corn, wheat, soybeans, etc.). By way of another example, a single field may be separated into sub-portions by way of geographic and crop or livestock type. By way of another example, a single field may be separated into one or more sub-portions based on one or more advanced metrics (e.g., growing degree days (GDDs), location to a watershed, proximity to roads, etc.). As further depicted, for each field division, one or more categories of performance metrics may be associated for the field division and presented to the user via the table 531. For example, each field division may have a combination of the following categories: expected revenue; expected revenue 1 day change; expected revenue 14-day change; revenue per acre; revenue per acre 1 day change; value-at-risk; value-at-risk 1 day change; hedged price; hedged price for expected production; expected yield and/or expected yield 14-day change. Other categories or granular changes (e.g., modifying the number of days in the change of day categories) will be readily apparent to one of skill in the art upon reading this disclosure.

As described above, a user may select from interactive icons 508 from the navigation bar 506 for generating new panes for display and/or for switching between different tabs. FIG. 5E depicts an illustrative embodiment of dashboard 502 after a maps insights interactive icon 508 has been selected for displaying a map insights tab 532. In embodiments, the maps insights tab 532 (or other tabs that are opened or navigated to following selection of the applicable interactive icon 508) includes a secondary navigation bar 534 comprising a second plurality of interactive elements 536. In embodiments, each tab or window opened in this manner may also include different tabs or panes that may be opened or navigated to. For example, the map insights tab 532 may have a secondary navigation bar 534 with a second plurality of interactive elements 536 corresponding to revenue, net income, yield, yield performance, yield percentage, etc. In this regard, additional details or granularity may be provided to the user. For example, through the dashboard 502, users may select a plurality of custom field selections, (e.g., down to 10 square meters or finer), in which each field selection has associated risks, revenues, yields, etc. Accordingly, users are provided with accelerated real-time decision making, including for example, during high-productivity periods such as during a growing season, through rapid visualization of granular field (or sub-field) performance data. In embodiments, the map insights tab 532 may be configured to the generation of polygons or other geometric shapes that can be drawn directly on the map interface, instantly saving the defined study area, capturing the visual representation, and/or calculating real-time analytics specific to the selected boundary. The system 100 continuously updates the calculations as new data becomes available, providing dynamic analytics within the user-defined area.

For example, in FIG. 5E, a revenue tab is selected from the second plurality of interactive elements 536 resulting in panes being generated and displayed corresponding to an expected revenue per acre by crop; expected revenue per acre by crop, corn, a satellite map, and map tools. Similar to the concepts described above, information in these panes may be presented to the user via text, graphics, map visualizations, and/or charts. The map tools 533 may provide a user with additional tools for manipulating or navigating the provided map. For example, interactive map visualization may include over activated data points, enabling instant field analytics access through intuitive spatial interaction without additional navigational steps.

FIG. 5F depicts an illustrative embodiment of displaying a net revenue tab 538 after a net revenue icon has been selected, resulting in a net revenue tab 538 being displayed. In embodiments, some panes or displayed objects may persist through a tab change, such as a pane corresponding to an expected net income in a graph form. However, some panes or displayed objects may be updated or generated and displayed in response to a tab change. For example, the illustrative embodiment depicted in FIG. 5F depicts a map pane 540 depicting expected net revenue of two fields. As described above, the present disclosure provides for methods of obtaining and processing a plurality of data inputs 108 and correlating or determining correlations, trends, or patterns between different data inputs 108. In the illustrative embodiment, parcels of land can be analyzed at a granular level through the data inputs 108, with expected yields, revenue, etc. being determined at different locations of the parcel of land (e.g., the determined zones as described above). For example, in the depicted embodiments, locations on the parcels of land corresponding to an expected net income resulting in a loss or lower than expected amount may be color coded in red. In this regard, a user is provided a visual representation of the income of different sections, zones, or even separate parcels of land. This concept may be applied to other categories, including but not limited to yields, yield performance, yield probability, yield error, risk, or satellite deviation, among other categories that will be readily apparent to one of skill in the art upon reading this disclosure. In embodiment, the map tools 533 as described above may also be provided to the user.

Turning now to FIG. 5G, an illustrative embodiment of dashboard 502 following selection of a historical insights interactive icon 508 resulting in a historical insights tab 542 has been generated or navigated to. In embodiments, the historical insights tab 542 is configured to provide a user with historical information and analysis for selected parcels of land. For example, and as depicted, the historical insights tab 542 may comprise a historical insights navigation bar 544, which provides a user with tools to filter the results that will be depicted on the dashboard 502. For example, the historical insights navigation bar 544 allows the user to select filters such as a timeframe (e.g., year, quarter, month, etc.) and area location (e.g., all fields of a specific crop type, specific fields, etc.). The historical insights navigation bar 544 may further provide tools allowing the user to select what information is displayed on a map generated on the dashboard 502 (e.g., yield, income, variety, etc.). In embodiments, information and/or analysis associated with the user selections from the historical insights navigation bar 544 may be presented to the user via various panes generated on dashboard 502 of the historical insights tab 542. For example, information may be presented to the user via text, charts, graphs, or maps. For example, bidirectional synchronization between tabular data and map visualizations (e.g., clicking on component in displayed data table automatically filters the corresponding map view), thereby enabling rapid spatial analysis without manual map manipulation. In embodiments, export functionality for data visualizations (e.g., enabling one-click download of tables, charts, and analytical outputs in multiple formats) provides for seamless integration with external reporting systems. For example, the historical insights tab 542 may be configured for providing sub-tabs or other generated objects corresponding particularized insights, such as seeding insights, application insights, or field study insights. Accordingly, through the historical insights tab 542, a user may be presented with historical information, trends, yield performances, and/or patterns associated with particular parcels of land, particular crops, crop varietals, etc. For example, yield performance may be a quantified deviation from model predictions while controlling for location-specific variables. Positive values indicate yields exceeding expectations; negative values indicate underperformance relative to predicted outcomes. Performance analysis by variety identifies which cultivars consistently outperform or underperform under comparable conditions. The system 100 may be configured to rank harvest impact factors—including soil characteristics, weather patterns, management practices, and varietal selection—by relative importance, displaying the positive or negative yield effect of each component in bushels per acre. This enables data-driven identification of optimization opportunities across agronomic inputs and operational decisions.

FIGS. 5H-J depict an illustrative embodiment of dashboard 502 displaying a risk management tab 546 after a risk management icon has been selected, resulting in the risk management tab 546 being displayed. As described herein, embodiments of the present disclosure are directed to providing recommendations or insights to a user for hedging and managing various operations (e.g., agricultural and commodity-based production) and financial positions investment portfolios, production portfolios, futures and options positions, cash positions, specialty contracts, exotic options, among other financial instruments). For example, the recommendations or insights directed at hedging may be presented to the user in the risk management tab 546. However, it should be understood that embodiments of the present disclosure may be provided to providing information on a variety of financial services, and as such, is not limited to hedging. In embodiments, the risk management tab 546 enables producers to make informed decisions by providing a detailed analysis of current and potential investment strategies to manage their risk efficiently. The data visually communicates current risks and optimizes returns through rigorous data analysis.

For example, as depicted in FIG. 5H, the risk management tab 546 includes filters 547 for a user to select a hedge type. As further depicted, the risk management tab 546 also includes categories of information presented in one or more charts 549 associated with the hedge type, and includes information such as position, type, futures, options, cash and basis contracts, exchange, valuation, and actions for the user to take. As described herein, through the API ERP system, document uploads, photo uploads, or other methods of information upload, the information associated by the system 100 may be populated in the generated tabs, panes, windows, and/or pages. Accordingly, the information displayed in the risk management tab 546 includes risk management information obtained by the system 100 using these, or other, methods of obtaining. As depicted in FIG. 5I, a user may select various icons 551 for displaying information associated with the user's risk management. For example, the user may select an overview icon or a portfolio optimization icon. Upon selection of the portfolio optimization icon, a portfolio optimization tab 555 or window may be opened or generated, as depicted in FIG. 5J. In embodiments, the portfolio optimization tab may be utilized by the system to display identified trends or metrics to the user in text and/or graphical manners.

In embodiments, the risk management tab 546 may be adapted and configured to focus on risk management for agricultural producers. As such, the risk management tab 546 may be directed to provide detailed analysis and visualization of investment portfolios that are specifically designed to optimize returns while managing risks.

For example, the risk management tab 546 may be adapted and configured to provide a portfolio overview. For example, the portfolio overview may display three main portfolio types: Current Portfolio, Maximum Sharpe Portfolio, and Minimum VaR Portfolio. Each portfolio type represents a different strategy for balancing risk and return, where the current portfolio reflects the current risk and performance, taking into account hedges, marketing, storage, and insurance. As such, the system may utilize metrics such as total investment value, 14-day change, risk, and the Sharpe Ratio to provide insights. These metrics indicate the amount invested, recent performance changes, risk levels, and risk-adjusted returns, which may then be displayed in the risk management tab 546.

For example, the risk management tab 546 may be adapted and configured to provide investment details. For example, for each portfolio, detailed information is provided about individual crop investments and changes in expected value per acre and per bushel. This includes investment value, daily change in value, daily risk, price per unit of production area, and other factors. Furthermore, data for each investment is visualized using pie charts that display the distribution of different crop investments.

For example, the risk management tab 546 may be adapted and configured to provide data integration. For example, the system may leverage one or more hooks to fetch portfolio data based on user-specific parameters of current predicted yield, area under production, hedges, insurance, etc. The system further processes data to calculate various investment metrics, such as current and potential changes in investment value, risk, and Sharpe ratios, based on the crop year of production. The calculated determinations may be displayed via the risk management tab 546.

For example, the risk management tab 546 may be adapted and configured to utilize and present dynamic visualization. For example, the system may utilize prompts to create dynamic and responsive pie charts that visually represent the distribution of investments across different crops. Furthermore, the system may tailor the color scheme of the charts to match the network partner's branding, enhancing readability and alignment with firms offering delivery contracts, product offerings, input prices (e.g., fertilizer, seed, etc.). An illustrative depiction of dynamic visualization is depicted in FIG. 5J.

For example, the risk management tab 546 may be adapted and configured to provide an intuitive user interface. For example, the system may use the risk management tab 546 to present data in an organized, card-based layout with straightforward headers and labels. In this regard, users may be able to quickly grasp complex portfolio optimization and how it can enhance returns to current investment in growing or stored commodities through visual aids and structured information presentation.

FIG. 5K depicts an illustrative embodiment of dashboard 502 displaying a weather tab 548 after a weather icon has been selected, resulting in the weather tab 548 being displayed. In embodiments, the weather tab 548 may include a satellite map incorporating weather radar information, precipitation rate, or other details directed to upcoming weather. In embodiments, a user may select a geographic region, such as a state for displaying in the satellite map. The satellite map may further include interactive tools allowing the user control over what information is displayed, such as the date or time for the weather forecast. While not depicted, the weather tab 548 may also display charts, graphs, or other generated data statistics, showing for example, actual precipitation as compared to predicted precipitation, historical averages, hail severity, hail events, among other data statistics that will be readily apparent to one of skill in the art upon reading this disclosure. For example, a selected field location may be overlain on the satellite map with a transparent layer, providing weather statistics at a micro-level, including for example, at a field-by-field or sub-field level basis.

FIG. 5L depicts an illustrative embodiment of dashboard 502 displaying a automated real-time prescription processing page 550 after a prescriptions icon has been selected, resulting in the automated real-time prescription processing page 550 being displayed. In embodiments, the automated real-time prescription processing page 550 may be configured to display information to the user directed to yield information for selected fields, including, for example, predicted yields. As depicted, the automated real-time prescription processing page 550 may comprise a map portion 561 including satellite imagery of a selected area with additional information overlain on the satellite map. For example, portions of the satellite map may be overlaid with data hover points (e.g., color graphics, texts, etc.,) corresponding to a predicted yield amount, as depicted. As described above, the present disclosure provides for methods of zone-specific optimization, wherein specific zones of a field or geographic area may be analyzed to determine optimal yield locations. Through automated real-time prescription processing page 550, a user may be presented with the zone-specific optimization of the selected parcel of land visually. As further depicted, automated real-time prescription processing page 550 may also comprise charts 553 or tables to display textual information, such as predicted outputs (e.g., yield, seed yield, or other predicted outputs), input information (e.g., seed, livestock, commodities, or the like), expected revenue, real-time expectations, among other information.

In embodiments, the automated real-time prescription processing page 550 may further be adapted for capturing user-provided notes or reasons for adjustments from a user, thereby providing an interface for the user to set goals (e.g. yield goals and/or set seeding rate and varieties) and/or to improve recommendations generated by the system 100. Accordingly, the system 100 can use the user-provided inputs as part of an informed recommendation process. For example, and as depicted in FIG. 5M via yield goals pane 552 and seeding rate and varieties pane 554. As depicted, panes may be generated corresponding to yield goals and/or seeding rates and varieties. In embodiments, a user may use yield goals pane 552 to set yield goals for the different zones associated with their agricultural operation. In embodiments, as the yield goals are adjusted by the user, or users, the tables presented on the dashboard 502 may be updated dynamically and in real time. In embodiments, the yield goals may also be obtained through current products and pricing by integrating ERP system retail partner inputs, or external data sources for real-time optimized profit potential. Furthermore, the yield goals pane 552 may also be configured to display additional details or information for the zones, such as a probability of exceeding yield goals, a predicted revenue per acre, and/or an average yield. In embodiments, the user may use seeding and varieties pane 554 to enter seeding information associated with each zone. The system 100 can then analyze the seeding information and generate predictions or estimates for the zones, such as seeding rate, historical average seeding rate, expected seed yield per seed planted, and/or cost.

In embodiments, the system 100 may generate interactive cards in addition to or in place of generated panes or tabs. For example, interactive cards may be generated and displayed on the dashboard 502 of the current tab or window the user is viewing. For example, while interacting with the yield goals pane 552 or seeding rate and varieties pane 554, an interactive card may be generated for the user to input information such as setting a yield goal, adding fertilizer (which can include, for example, nitrogen, phosphorus, or potassium) add chemical, add micronutrients (e.g., zinc, iron, etc.), product list, or logs. Accordingly, embodiments, of the dashboard 502 may be configured to provide tailored and interactive information and usability at a broad and granular level.

FIG. 5N depicts an illustrative embodiment of dashboard 502 displaying a markets tab 556 after a markets icon has been selected, resulting in the markets tab 556 being displayed. In embodiments, the markets tab 556 provides users with real-time information associated with the market price of one or more commodities. In embodiments, the markets tab 556 may also be configured to provide alerts to the user to buy/sell/portfolio execution triggers, with a frequency determined by action parameters. In embodiments, and as described herein the alerts that are generated may also be delivered to other recipients, including via phone/systems/API/text notifications.

In embodiments, the markets tab 556 can be configured to display charts, graphs, or tables, reflecting current market prices, trends, predicted prices, etc. corresponding to different commodities the user has selected for the system 100 to keep track of. In embodiments, the markets tab 556 may also be configured to allow the user to make one or more portfolio selections, allowing the user to buy or sell commodities thereby hedging their agricultural operation.

In embodiments, the system 100 may be configured for generating alerts that may be generated and displayed on the dashboard 502 (e.g., alerts 220). For example, alerts may be generated and displayed providing notice to users to take one or more actions, such as buying, selling, or portfolio execution triggers. Accordingly, alerts may include a degree of specificity tied to the cause of generation and as such, may be displayed in associated windows or panes of the dashboard 502. In embodiments, alerts may be more general in nature or otherwise not tied to a specific window, tab, or pane, and as such and may be provided through the dashboard 502 regardless of the navigational steps the user has taken.

In embodiments, the generated alerts may be provided to third-party or external locations. For example, a user may associate their phone number with an account linked to their dashboard, such that generate alerts may be communicated via SMS or text message to the user's phone. For example, alerts may be sent via APIs to external vendors, alerting the vendor of an imminent sale or purchase. In some embodiments alerts sent to third parties may be part of an automated workflow initiating for example, the purchase or sale of commodities, livestock, seed, investment options, etc.

In embodiments, the frequency of the generated alerts may be determined by action parameters, including determinations made on assessed valuations based on user-provided goals. For example, upon a determination that the purchasing price of seed is below a threshold value that increases the predicted profitability of a field (or sub-field) an alert may be generated. For example, the alerts may also be tied to determinations based on actionable items, including for example, alerts related to land conditions (e.g., dry conditions warranting the turning on of an irrigation system). Accordingly, the system 100 may be configured for actionable analytic integration with control systems for connected sub-systems, such as land-based systems (e.g., irrigation, combines, planters, drilling devices, etc.), trading platforms or financial institutions, third-party sellers (e.g., John Deere®, Climate FieldView™ systems) or other systems that may be connected to the system 100, such that alerts in the form of actionable items may be communicated to these connected sub-systems. For example, upon a determination that a field or sub-field is drier than expected, an actionable alert may be provided to an irrigation system associated with the field or sub-field to initiate watering of the field or sub-field. For example, upon a determination that seed prices are at a recommended buying price, an actionable alert may be forwarded to a producer and begin an automated process for the purchasing of seed. However, it should be understood that these examples are intended to be illustrative, rather than limiting, and the examples of automated or partially automated actionable alerts may encompass a variety of different actions.

In embodiments, the user interface 500 may be further configured for supporting different levels of account or accounts having tailored permissions or features. For example, the user interface 500 may be configured for supporting a primary or super user that may share access with one or more additional users, thereby enabling collaborative input, real-time alerts on analytics, and/or adjustments or recommendations or dial movements. In embodiments, actions taken by secondary or additional users may be logged and provided to the primary user in the primary user's dashboard 502. For example, logs associated with secondary user actions may be provided in one or more panes or boxes located at the bottom of the dashboard 502. In embodiments, primary users may provide universal or general rights to secondary users, such that secondary users may have access all modules, tabs, windows, or portions of the dashboard 502. In embodiments, primary users may provide selective or limited rights, including but not limited to limited access (e.g., access to only selected modules, tabs, windows, or portions of the dashboard 502), limited modification permissions (e.g., permission to only view or monitor but not take actions, permissions granted to only specific modules, tabs, windows, card levels within windows, and/or a combination thereof..

For example, FIG. 5O is a sharing permission page 558 that may be generated and displayed on the dashboard 502. In embodiments, users may utilize the sharing permission page 558 to assign permissions to selected advisors. For example, the sharing permission page 558 includes a listing 560 of different pages or tabs for which access may be granted. As further depicted, the sharing permissions page 558 includes columns of different access levels 562, such as “allow advisor access” and/or “allow advisor data aggregations.” As depicted a toggle or other selector may be used for each page or tab included in the listing, providing granular permission controls for the user.

In embodiments, the listing 560 may be sub-divided into different categories, such as dashboard access 564 and data input portal access 566. For example, the dashboard access 564 may be directed at specific pages or windows that are generated and displayed on the dashboard 502 (e.g., the risk management tab, the weather tab, etc.). In embodiments, the data input portal access 566 may be directed at what inputs the secondary users may upload or provide to the system 100 (e.g., farm expenses, budget, soil samples, etc.). In embodiments, the listing 560 may be sub-divided into card-level permissions for cards that may be generated and displayed in a larger window.

In embodiments, the dashboard 502 may be configured for generating pages, tabs, or windows configured for receiving data inputs from the user. For example, FIG. 5P is a generated budget page 568 that may be generated in response to a selection by the user of an interactive icon 508 associated with data inputs. For example, the generated budget page 568 may be configured for applying budgets to different assets and/or fields (including sub-fields). For example, the budget page 568 may have a crop selector 570, which may be configured as a drop-down menu for selecting a specific crop (e.g., corn, wheat, barley). Additionally, the budget page 568 includes a budget applicator 572, which allows the user to apply budgets based on the selected crop or by selected fields. As further depicted, the budget page 568 includes a display mode selector 574, allowing the user to select a per acre mode or a total mode.

In embodiments, the budget page 568 includes a budget visualization 576 which may be tailored by the user to provide visualizations of information associated with the budgeting of their operation. For example, the budget visualization 576 includes columns associated with an actual budget 578, the expected budget 580, and a comparison of the actual vs expected budget 582.

For example, the user may input different budgetary inputs associated with their operation that is covered by the budget that are automatically sorted and categorized. For example, the budget inputs may include factors such as total revenue, acres, chemicals equipment, and other cost inputs. Accordingly, the budget page 568 may provide the monetary values associated with the actual budget broken down by cost input, the expected budget broken down by estimate cost, and a visualization of the actual vs expected budget. For example, the actual vs expected budget 582 may include color coding to reflect how the actual budget compares to expected budget including for example, green to show positive actual vs expected budget comparison and red to show a negative actual vs expected budget comparison.

In embodiments, the budget page 568 may be configured to provide granular analysis (e.g., actual budget vs expected budget comparison for each cost input) as well as an overall analysis at a crop or field level (e.g., providing a total expense and total net revenue for the selected crop or field).

As described above, the user interface 500 may be accessible to a plurality of users, such as a primary or super user granting permission to secondary users. In embodiments, the user interface 500 may log user access, including both primary or super users and secondary users, providing a history of access, changes, modifications, edits, uploads, etc. made by the users. FIG. 5Q is an illustrative example of a prescription page log 584. For example, a prescription page log 584 may be generated and made available via the dashboard 502. The prescription page log 584 may be configured with providing information such as timestamps of changes, what user was responsible for the change, what zone was affected by the change, the amount or degree of the change, a set value of the change, a recommended value, and a status of the change. Accordingly, the prescription page log 584 may provide a history of changes made to various aspects of the user interface 500, providing a user with information and how to make adjustments to change any undesired changes or to revert changes previously made. Additionally, the system 100 may display post-season performance analysis comparing actual outcomes of user-adjustments against the model's original recommendations, enabling users to evaluate the impact of modifications made to the prescribed strategy.

In embodiments, the dashboard 502 may be configured to support visual emphasis of updated values (e.g., highlighting changed metrics) to improve user interpretation of time-varying valuations and risk metrics. In embodiments, the dashboard 502 may be configured to support animations and visualizations that provide dynamic risk transformations, illustrating how risk components—including price risks (futures/basis) and production risk—evolve over time and how resulting changes impact investment decisions and risk mitigation strategies (hedging, marketing, crop insurance, investment allocation, etc.). This functionality delivers enhanced understanding of how risk management manifest in operations, enabling users to observe patterns and relationships between market conditions, risk exposure, and strategic interventions by visualizing these temporal dynamics.

Accordingly, embodiments of the present disclosure relate to an interactive user interface 500 incorporating numerous user-friendly features. For example, the dashboard 502 of the user interface 500 may be configured for presenting a value-at-risk card comprising gross exposure metrics, component breakdown (yield risk, price risk including futures and basis, crop type segmentation), and mitigated risk values (marketing strategies, hedging positions, investments, insurance coverage) displayed in monetary terms. For example, the dashboard 502 of the user interface 500 may be configured for hedging visualization through displaying hedged futures price and hedged basis as a percentage of expected production volume, enabling real-time assessment of protection coverage.

For example, the dashboard 502 of the user interface 500 may be configured for presenting a universal crop year dropdown selector that dynamically filters all dashboard panes and data visualizations simultaneously across the interface.

For example, the dashboard 502 of the user interface 500 may be configured for presenting synchronized chart filtering through interactive chart components that bidirectionally filter corresponding map displays upon selection. For example, clicking expected revenue bins in map insights automatically filters geographic map data accordingly, while clicking chart elements in the historical insights panel simultaneously updates the map display to reflect the selected data visual subset, enabling coordinated multi-view analysis.

For example, the dashboard 502 of the user interface 500 may be configured for presenting dynamic slider/toggle controls. For example, an interactive slider mechanism that adjusts revenue and net income on dashboard page.

For example, the dashboard 502 of the user interface 500 may be configured for presenting granular map data hovering/clicking. For example, tooltip functionality provides detailed data at 10-square-meter resolution when hovering over map locations.

For example, the dashboard 502 of the user interface 500 may be configured for presenting custom study analytics. For example, polygon drawing tools that generate analytical overlays on map data within seconds for user-defined geographic boundaries, with instant image capture. For example, the system 100 may continuously update the calculations as new data becomes available, providing dynamic analytics within the user-defined area.

For example, the dashboard 502 of the user interface 500 may be configured for presenting temporal map sliders. For example, date-based slider controls for map insights (revenue, net income, yield metrics) with month-by-month coordination across visualizations.

For example, the dashboard 502 of the user interface 500 may be configured for presenting a prescription adjustment interface. For example, dial controls for prescription component adjustment with immediate synchronized updates to accompanying analytical tables and logs adjust for visual adjustment transparency.

For example, the dashboard 502 of the user interface 500 may be configured for presenting a flip card design pattern. For example, interactive card interface elements that reveal additional detail layers through flip animation interactions.

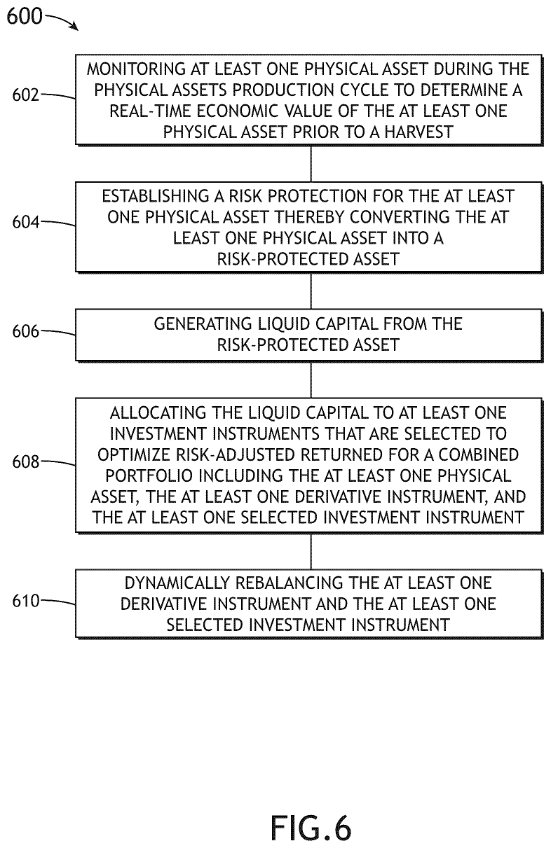

As described herein, embodiments of the present disclosure may be utilized in generating predictions, estimates, or recommendations for a variety of commodity-based operations, investment portfolios, and/or other asset-based enterprises or operations. For example, the present disclosure may be utilized as part of a method for generating liquid from illiquid assets (e.g., illiquid agricultural assets). FIG. 6 is a process flowchart depicting a method of use 600 for generating liquidity from illiquid agricultural assets. In embodiments, method 300 may be performed via the one or more processors 134 executing computer readable instructions stored on the one or more memory devices 136.

Step 602 includes monitoring at least one physical asset during the physical asset's production cycle to determine a real-time economic value of the at least one physical asset prior to a harvest. In embodiments, the at least one physical asset includes an economic value that is illiquid until completion of the harvest.

Step 604 includes establishing a risk protection for the at least one physical asset through at least one derivative instrument selected from at least one of futures contracts, options contracts, financial investment(s) or a combination thereof of both, thereby converting the at least one physical asset into a risk-protected asset. In embodiments, the risk protection includes selecting an options-based hedge by computing a delta-adjusted hedge equivalence between an options contract position and a futures contract position.

Step 606 includes generating liquid capital from the risk-protected asset by at least one of: selling options contracts against the risk-protected asset to generate premium income, deploy capital freed from reduced collateral requirements relative to unhedged positions, or utilizing margin efficiency from options-based hedging compared to futures-based hedging. In embodiments, identifying freed capital comprises computing a first collateral requirement associated with a futures-based hedge and computing a second collateral requirement associated with an options-based hedge providing the target risk protection level, and wherein generating liquid capital comprises selecting the options-based hedge based on a difference between the first collateral requirement and the second collateral requirement

Step 608 includes allocating the liquid capital to at least one investment instruments that is selected to optimize risk-adjusted returns for a combined portfolio including the at least one physical asset, the at least one derivative instrument, and the at least one selected investment instrument.

Step 610 includes dynamically rebalancing the at least one derivative instrument and the at least one selected investment instrument based on at least one of: a value of the at least one physical asset changes during production based on real-time monitoring data; market conditions affecting the at least one derivative instrument; or changed to one or more risk parameters of the combined portfolio. In embodiments, economic value is extracted from the at least one physical asset during the production cycle and the economic value is deployed to generate additional returns while maintaining target risk levels.

In embodiments, an optional or further step includes generating an order instruction for establishing the at least one derivative instrument and transmitting the order instruction to an external trading platform via an application programming interface.

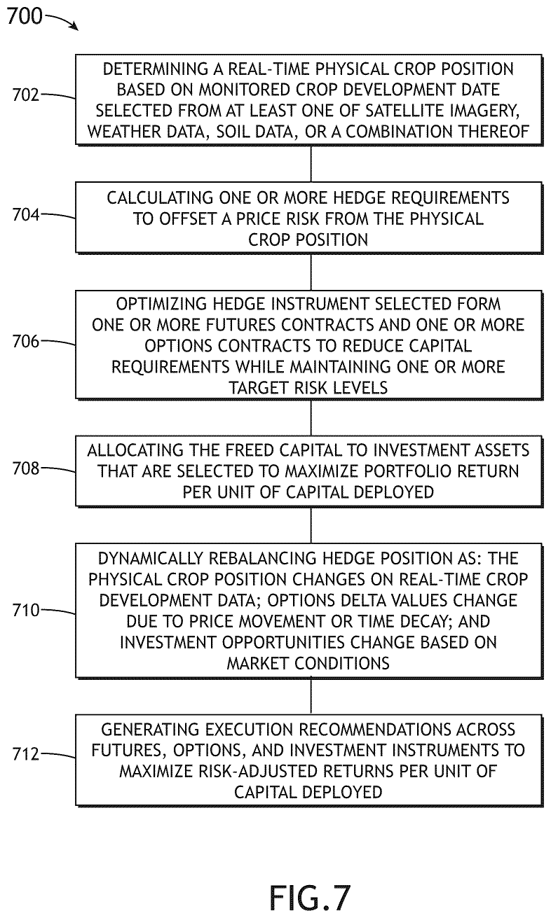

In embodiments, the present disclosure may be utilized in a method for capital-efficient agricultural portfolio optimization. For example, FIG. 7 is a process flow chart depicting a method 700 for capital-efficient agricultural portfolio optimization, in accordance with one or more embodiments of the present disclosure. In embodiments, method 300 may be performed via the one or more processors 134 executing computer readable instructions stored on the one or more memory devices 136.

Step 702 includes determining a real-time physical crop position based on monitored crop development date selected from at least one of satellite imagery, weather data, soil data, or a combination thereof.

Step 704 includes calculating one or more hedge requirements to offset a price risk from the physical crop position.

Step 706 includes optimizing hedge instrument selected from one or more futures contracts and one or more options contracts to reduce capital requirements while maintaining one or more target risk levels, wherein, option contracts are evaluated based on delta-adjusted hedge equivalence to futures positions; capital savings from reduced margin requirements are calculated by comparing options premium costs to futures margin requirements; and freed capital from capital-efficient hedging is identified for alternative allocation.

Step 708 includes allocating the freed capital to investment assets that are selected to maximize portfolio return per unit of capital deployed.

Step 710 includes dynamically rebalancing hedge position as: the physical crop position changes on real-time crop development data; options delta values change due to price movement or time decay; and investment opportunities change based on market conditions.

Step 712 includes generating execution recommendations across futures, options, and investment instruments to maximize risk-adjusted returns per unit of capital deployed.

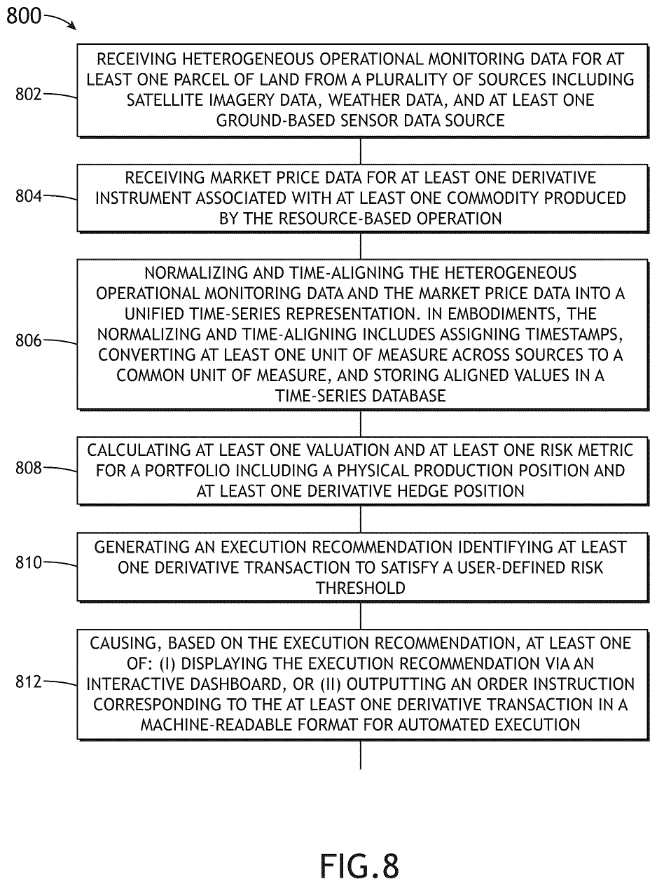

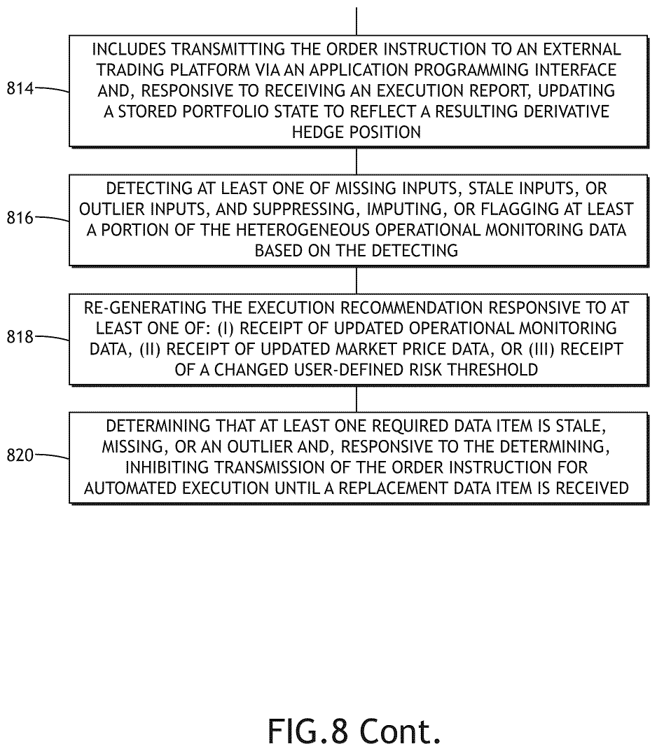

As described herein, embodiments of the present disclosure may be utilized in generating predictions, estimates, or recommendations for a variety of commodity-based operations, investment portfolios, and/or other asset-based enterprises or operations. For example, the present disclosure may be utilized as part of a method for real-time multi-source risk processing. FIG. 8 is a process flowchart depicting a method of use 800 for real-time multi-source risk processing. In embodiments, method 300 may be performed via the one or more processors 134 executing computer readable instructions stored on the one or more memory devices 136.

Step 802 includes receiving heterogeneous operational monitoring data for at least one parcel of land from a plurality of sources including satellite imagery data, weather data, and at least one ground-based sensor data source.

Step 804 includes receiving market price data for at least one derivative instrument associated with at least one commodity produced by the commodity-based operation.

Step 806 includes normalizing and time-aligning the heterogeneous operational monitoring data and the market price data into a unified time-series representation. In embodiments, the normalizing and time-aligning includes assigning timestamps, converting at least one unit of measure across sources to a common unit of measure, and storing aligned values in a time-series database.

Step 808 includes calculating at least one valuation and at least one risk metric for a portfolio including a physical production position and at least one derivative hedge position. In embodiments, calculating the at least one valuation and the at least one risk metric is performed within a predetermined latency window after receipt of a new market price update. In embodiments, calculating the physical production position comprises estimating an expected harvest quantity based on the heterogeneous operational monitoring data, and wherein calculating the at least one valuation comprises applying at least one current market price to the expected harvest quantity. In embodiments, the at least one risk metric comprises a risk decomposition including at least a production risk component, a futures price risk component, and a basis risk component

Step 810 includes generating an execution recommendation identifying at least one derivative transaction to satisfy a user-defined risk threshold. In embodiments, the generating the execution recommendation comprises computing at least one options Greek and determining an order quantity based on a delta-adjusted hedge equivalence relative to a target risk protection level.

Step 812 includes causing, based on the execution recommendation, at least one of: (i) displaying the execution recommendation via an interactive dashboard, or (ii) outputting an order instruction corresponding to the at least one derivative transaction in a machine-readable format for automated execution.

In embodiments, an optional or further step 814 includes transmitting the order instruction to an external trading platform via an application programming interface and, responsive to receiving an execution report, updating a stored portfolio state to reflect a resulting derivative hedge position.

In embodiments, an optional or further step 816 includes detecting at least one of missing inputs, stale inputs, or outlier inputs, and suppressing, imputing, or flagging at least a portion of the heterogeneous operational monitoring data based on the detecting.

In embodiments, an optional or further step 818 includes re-generating the execution recommendation responsive to at least one of: (i) receipt of updated operational monitoring data, (ii) receipt of updated market price data, or (iii) receipt of a changed user-defined risk threshold.

In embodiments, an optional or further step 820 includes determining that at least one required data item is stale, missing, or an outlier and, responsive to the determining, inhibiting transmission of the order instruction for automated execution until a replacement data item is received.

In embodiments, the order instruction includes an order identifier, and wherein updating the stored portfolio state comprises correlating the execution report to the order identifier and suppressing duplicate portfolio-state updates based on the order identifier. inhibiting transmission comprises computing a confidence score based at least in part on one or more data availability indicators associated with the unified time-series representation and permitting transmission when the confidence score satisfies a threshold. In embodiments, normalizing and time-aligning comprises generating, for each time bucket of the unified time-series representation, at least one data availability indicator representing whether a required operational monitoring value was observed, imputed, or missing

The described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A method for real-time risk management and optimization, comprising:
collecting historical data or real-time data from at least one data source, including at least one of historical field information, satellite imagery data, asset yield data, market price data, weather forecast data, enterprise data, or asset insurance data;
training, by a data processing unit, at least one machine learning model to determine at least one asset yield prediction, at least one revenue, at least one profit, or at least one assessed risk associated with at least one parcel of land or at least one commodity using a first training data set that includes the historical data or the real-time data;
receiving, from a user interface, one or more user selections corresponding to at least one commodity-based operation and a risk threshold for the at least one commodity-based operation;
responsive to receiving the one or more user selections, selecting one or more trained machine learning models that were trained by the data processing unit;
determining, through a recommendation engine, at least one of a predicted asset yield, a predicted risk metric, or a predicted expected revenue for the at least one commodity-based operation based at least in part on an analysis of the machine learning model, the at least one commodity-based operation, and the risk threshold; and
causing display of at least one of the predicted asset yield, the risk metric,
or the expected revenue for the at least one commodity-based operation.

2. The method of claims 1, further comprising:
updating the historical data at configurable intervals ranging from 1 minute to 24 hours depending on data type; and
updating the at least one machine learning model to an updated machine learning model using updated historical data.

3. The method of claim 2, further comprising:
determining, through the recommendation engine, at least one of an updated predicted asset yield, an updated predicted value at risk, or an updated predicted expected revenue for the at least one commodity-based operation based in part on the updated machine learning model, the at least one commodity-based operation, and the risk threshold.

4. The method of claim 3, further comprising:
causing display of at least one of the updated predicted asset yield, the updated predicted value at risk, or the updated predicted expected revenue for the at least one commodity-based operation in real time in response to receipt of the updated historical data.

5. The method of claim 1, further comprising:
processing the collected historical data or real-time data to generate one or more spatial risk assessments at a sub-field resolution of 10 square meters or finer, wherein said processing includes decomposing financial risk into at least three distinct components comprising production risk, futures price risk, and basis risk.

6. The method of claim 5, further comprising:
quantifying financial risk in precise monetary values for each of the at least three distinct risk components, wherein said quantifying includes calculating dollar-value exposures for production risk, futures price risk, and basis risk separately to enable targeted risk mitigation strategies.

7. The method of claim 1, wherein the risk threshold is applied to an entirety of the commodity-based operation.

8. The method of claim 1, wherein the risk threshold includes a first risk threshold associated with a first portion of the commodity-based operation and a second risk threshold associated with a second portion of the commodity-based operation.

9. The method of claim 1, wherein the commodity-based operation includes at least one parcel of land, the parcel of land being parsed into one or more zones.

10. The method of claim 9, further comprising:
determining, through the data processing unit, at least one of a predicted asset yield, a predicted value at risk, or a predicted expected revenue for each of the one or more zones of the at least one commodity-based operation.

11. The method of claim 1, further comprising:
receiving one or more user inputs, wherein the one or more user inputs provide an adjustment to the at least one of the at least one predicted asset yield, the predicted risk metric, or the predicted expected revenue; and
responsive to receiving the one or more user inputs, generating and causing display of at least one of an updated predicted asset yield, an updated predicted risk metric, or an updated predicted expected revenue for the at least one commodity-based operation based in part on the one or more user inputs.

12. A system of providing predictions, estimates, or recommendations for a commodity-based operation comprising:
a data collection module, the data collection module configured to obtain or collect information from a plurality of data inputs,
wherein the plurality of data inputs include at least one of field information, satellite imagery data, yield data, market price data, weather forecast data, enterprise data, or asset insurance data;
a data processing unit, the data processing unit configured to analyze or process the information from the plurality of data inputs to determine correlations, patterns, or trends in the plurality of data inputs,
wherein the data processing unit utilizes at least one machine learning algorithm to determine correlations, patterns, or trends associated with determining at least one crop yields, or risks associated with at least one parcel of land;
a recommendation engine, the recommendation engine configured to determine at least one of a predicted asset yield, a predicted risk metric, or a predicted expected revenue for at least one commodity-based operation; and
a user interface, the user interface configured to display the determined at least one of the predicted asset yield, the predicted risk metric, or the predicted expected revenue for at least one commodity-based operation.

13. The system of claim 12, wherein the user interface comprises an interactive dashboard.

14. The system of claim 13, wherein the interactive dashboard is configured to generate and display a plurality of panes.

15. The system of claim 14, wherein at least one pane of the plurality of panes is configured to display at least one of the determined at least one of the predicted crop yield, the predicted risk metric, or the predicted expected revenue for the at least one commodity-based operation.

16. The system of claim 15, wherein the data collection module is configured to update the information from the plurality of data inputs at pre-determined intervals, and wherein the recommendation engine is configured to update the at least one predicted asset yield, predicted risk metric, or predicted expected revenue.

17. The system of claim 16, further comprising:
causing display of an updated at least one predicted asset yield, predicted risk metric, or predicted expected revenue in at least one pane of the plurality of panes.

18. The system of claim 17, wherein the interactive dashboard includes a plurality of navigable tabs.

19. The system of claim 12, further comprising:
a portfolio aggregation module configured for integrating a plurality of diverse portfolio assets into a unified portfolio representation; and
a rebalancing module configured for continuously monitoring the unified portfolio representation and triggering rebalancing when one or more risk thresholds are exceeded or optimization parameters change.

20. A system for real-time asset management and optimization, comprising:
a controller including at least one processor and at least one memory device storing computer-readable instructions,
wherein the controller is implemented as a distributed computing system comprising a web server tier for handling user interface requests;
an application server tier for executing application logic and recommendation algorithms; and
a data storage tier including at least one relational database and at least one time-series database optimized for sensor data storage,
wherein the at least one processor configured to execute the computer-readable instructions to:
collect historical data or real-time data from at least one data source, including at least one of historical field information, satellite imagery data, yield data, market price data, weather forecast data, enterprise data, or asset insurance data;
train at least one machine learning model to determine at least one asset yield prediction, at least one revenue, at least one profit, or at least one assessed risk associated with at least one parcel of land or at least one commodity using a first training data set that includes the historical data;
receive, from a user interface, one or more user selections corresponding to at least one commodity-based operation and a risk threshold for the at least one commodity-based operation;
responsive to receiving the one or more user selections, select one or more trained machine learning models;
determine at least one of a predicted asset yield, a predicted risk metric, or a predicted expected revenue for the at least one commodity-based operation based at least in part on an analysis of the machine learning model, the at least one commodity-based operation, and the risk threshold;
cause at least one of the predicted asset yield, the risk metric, or the expected revenue for the at least one commodity-based operation to be displayed.
